(19) United States
(12) Patent Application Publication
(10) Pub. No.: US 2022/0032338 A1
(43) Pub. Date: Feb. 3, 2022

(54) Fabrication of Crosslinked and Reactive Nanoporous Polymer Coatings Using Spray-Based Methods

(71) Applicant: Wisconsin Alumni Research Foundation, Madison, WI (US)

(72) Inventors: David M. LYNN, Middleton, WI (US); Harshit AGARWAL, Madison, WI (US)

(21) Appl. No.: 17/390,559

(22) Filed: Jul. 30, 2021

Related U.S. Application Data
(60) Provisional application No. 63/059,015, filed on Jul. 30, 2020.

(51) Int. Cl. B05D 1/02; B05D 7/00; B05D 3/10; C09D 137/00; C09D 179/02; C09D 7/63; C09D 7/40; B05D 5/00

(52) U.S. Cl. CPC B05D 1/02; B05D 7/5485; B05D 3/105; C09D 137/00; C09D 179/02; B05D 2401/10; C09D 7/67; B05D 3/108; B05D 5/00; B05D 2518/00; B05D 2401/21; C09D 7/63

(57) ABSTRACT

This invention discloses spray-based methods for generating polymer-based coatings with a range of morphologies, chemical reactivities, and physical stabilities useful for a broad range of applications, such as for the fabrication of non-wetting and slippery surfaces. Certain embodiments of this invention provide coatings with nanoscale morphologies, physical stabilities, and chemical reactivities that are similar to or improved compared to analogous coatings and materials made using conventional dip coating or flow-based methods. These spray-based methods can also be used to fabricate coatings with substantially similar functional properties, but with improved consistency, efficiency, additional functionality, and reproducibility. In an aspect of the invention, two or more chemically reactive polymer solutions are sprayed onto a substrate to form a crosslinked polymer coating on the substrate. The polymer solutions may be applied to the substrate sequentially or simultaneously.

### CROSS-REFERENCE TO RELATED APPLICATIONS

This application claims priority from U.S. Provisional Patent Application No. 63/059,015, filed Jul. 30, 2021, which is incorporated by reference herein to the extent that there is no inconsistency with the present disclosure.

### STATEMENT REGARDING FEDERALLY SPONSORED RESEARCH OR DEVELOPMENT

This invention was made with government support under DMR1720415 awarded by the National Science Foundation. The government has certain rights in the invention.

### BACKGROUND OF THE INVENTION

The present invention discloses spray-based methods for generating polymer-based coatings with a range of morphologies, chemical reactivities, and physical stabilities useful for a broad range of applications, including but not limited to the fabrication of non-wetting and slippery surfaces. Certain embodiments of this invention provide coatings with nanoscale morphologies, physical stabilities, and chemical reactivities that are similar to or improved compared to analogous coatings and materials made using conventional dip coating or flow-based methods (including but not limited to U.S. Pat. Nos. 8,071,210, 10,487,217, 10,557,042, and 10,557,044), and further allow such coatings and materials to be produced with additional properties and improved levels of consistency, efficiency, cost, scalability and reproducibility.

Coatings that impart new properties or behaviors to surfaces, such as resistance to fouling, changes in wetting behavior, or responsiveness to stimuli, are useful in a broad range of applied contexts. Chemically reactive coatings and reactive coating processes are particularly versatile in this regard because they permit chemical functionalization or patterning of surface features and, thus, tailoring of interfacial properties after fabrication, and can provide routes to crosslinking and promote aspects of structure formation in ways that can lead to desirable physical properties and enhance stability in harsh environments. Many methods have been developed for this purpose, including both gas-phase (e.g., chemical vapor deposition) and solution-phase approaches (e.g., dip-coating, spin-coating, and spray-coating) that can be readily integrated into commercial and industrial processes.

Many such methods involve iterative, layer-by-layer (LbL) assembly of polymer layers resulting in the gradual build-up of crosslinked and chemically reactive coatings that may be nanoporous and can be functionalized to exhibit, among other things, extreme wetting (or non-wetting) properties, or to serve as surfaces having enhanced physical and functional properties.

These approaches are extraordinarily versatile and can be used to fabricate composite or multicomponent coatings using a broad range of polymer-based building blocks and either non-covalent interactions or bond-forming reactions that occur between them (see Schönhoff et al., Curr. Opin. Colloid Interface Sci., 2003, 8: 86-95; Borges et al., Chem. Rev. 2014, 114: 8883-8942; Kharlampieva et al., Adv. Mater. 2009, 21: 3053-3065; Yuan et al., Adv. Colloid Interface Sci. 2020, 282: 102200; Hammond et al., Curr. Opin. Colloid Interface Sci. 1999, 4: 430-442; Broderick et al., in Functional Polymers by Post-Polymerization Modification: Concepts, Practical Guidelines, and Applications, Theato and Klok Eds., Wiley-VCH: 2012; pp 371-406; Quinn et al., Chem. Soc. Rev. 2007, 36: 707-718; Bergbreiter et al., Soft Matter 2009, 5: 23-28; Rydzek et al., Soft Matter 2012, 8: 9738-9755; and An et al., Chem. Soc. Rev. 2018, 47: 5061-5098).

Layer-by-layer processes also allow structural features (e.g., film thickness and porosity) and compositional complexity to be varied by manipulation of many different process parameters, including the structure and properties of the constituent polymers and the number of assembly cycles (Borges et al., Chem. Rev. 2014, 114: 8883-8942; Hammond et al., Curr. Opin. Colloid Interface Sci. 1999, 4: 430-442; Xiao et al., Chem. Soc. Rev. 2016, 45: 3088-3121; and Zhang et al., Chem. Commun. 2007: 1395-1405).

Such coatings include, but are not limited to, slippery liquid-infused porous surfaces (SLIPS), which are a class of bio-inspired soft matter that exhibit unique and robust antifouling behavior. These materials are formed by infusing viscous oils into porous surfaces, yielding interfaces that allow other fluids to slide off (e.g., with sliding angles as low as 2°). This slippery behavior arises from an ability to host and maintain thin films of oil at their surfaces, placing a premium on chemical compatibility between the porous surface and the oil and revealing design criteria that can be exploited to manipulate the behaviors of contacting fluids (e.g., to tune sliding angles and velocities or create responsive surfaces that allow control over these and other interfacial behaviors). Surfaces and coatings that exhibit these characteristics have enabled the design of new anti-icing surfaces, slippery containers for the dispensing of commercial liquids and gels, and new liquid-infused interfaces that are resistant to biofouling in complex aqueous, biological, and marine environments.

Aizenberg and co-workers reported the first examples of SLIPS by infusing perfluorinated liquids into nanofibrous Teflon membranes (Wong et al., Nature, 2011, 477: 443-447). Since that report, many different approaches have been used to design substrates, coat surfaces, and functionalize interfaces with combinations of porosity, roughness, and surface chemistry that lead to slippery surfaces when infused with different liquid phases. Additional development of SLIPS and similar materials have attempted to extend the formation of such materials from planar surfaces to more complex objects.

Several previous fabrication methods of such materials and coatings typically require the iterative exposure of substrates to at least two chemically reactive polymers either by submersion (e.g., dip coating) or using flow-based methods. However, such methods typically require the substrate to be fully submersed in containers containing the different polymer solutions. As a result, these methods are often expensive, time consuming, and inefficient. The efficient fabrication of such materials and coatings on complex and/or large surfaces therefore remains a challenge.

### SUMMARY OF THE INVENTION

The present invention discloses spray-based methods for generating polymer coatings and materials having similar and improved nanoscale morphologies, physical stabilities, and chemical reactivities as coatings and materials made using dip coating or flow-based methods. These spray-based methods can be used to fabricate coatings with substantially similar functional properties as past methods, but further address the issues of consistency, efficiency, additional functionality, and reproducibility associated with those methods. The present invention also provides spray-based procedures to fabricate polymer coatings with a range of structural features and morphologies. For example, coatings with microscale roughness/porosity, micro- and nanoscale roughness/porosity, and smooth (absence of any substantial micro- and nanoscale roughness/porosity) coatings can be fabricated. The present methods also provide avenues for control and manufacturing scalability that would be difficult to achieve using previously disclosed methods.

In an aspect of the present invention, two or more chemically reactive polymer solutions, suspensions, or emulsions are sprayed onto a substrate to form a crosslinked polymer coating on the substrate. Preferably, the resulting polymer coatings have a nanoscale or microscale porosity, although non-porous polymer coatings may also be formed. In an embodiment, the polymer solutions, suspensions, or emulsions are sprayed onto the substrate sequentially and iteratively. Alternatively, at least a portion of the polymer solutions are sprayed onto the substrate simultaneously. Spray methods suitable for use with the present invention are described in Schlenoff et al., 2000, Langmuir, 16(26), 9968-9969; Izquierdo et al., 2005, Langmuir, 21(16), 7558-7567; Richardson et al., 2015, Science, 348(6233), aaa2491; Porcel et al., 2005, Langmuir, 21(2), 800-802, and Lefort et al., 2010, Angewandte Chemie International Edition, 49(52), 10110-10113.

In an embodiment, the present invention provides a method for fabricating a polymer coating on a substrate, the method comprising the steps of: a) spraying a substrate with a first solution, suspension, or emulsion comprising a first polymer, wherein at least a portion of individual monomer units of the first polymer are substituted with a first functional group, and wherein the first polymer is deposited on at least a portion of the substrate; and b) spraying the substrate with a second solution, suspension, or emulsion comprising a second polymer, wherein at least a portion of individual monomer units of the second polymer are substituted with a second functional group, wherein the second polymer chemically reacts with the first polymer, thereby forming a polymer coating on the substrate. Preferably, a portion of the first and second functional groups are unreacted after the second polymer chemically reacts with the first polymer. The polymer coating formed on the substrate may be non-porous or porous.

In an embodiment, the present invention provides a method for fabricating a porous polymer coating on a substrate, where the polymer coating comprises two or more layers, the method comprising the steps of: a) spraying the surface of the substrate with a first solution, suspension, or emulsion comprising a first polymer, wherein at least a portion of individual monomer units of the first polymer are substituted with a first functional group, wherein a porous layer of the first polymer is deposited on at least a portion of the substrate surface; and b) spraying the substrate with a second solution, suspension, or emulsion comprising a second polymer, wherein at least a portion of individual monomer units of the second polymer are substituted with a second functional group, and wherein the second polymer reacts with the first polymer layer and a porous layer of the second polymer is deposited on at least a portion of the first polymer layer, thereby forming a porous coating on the substrate having at least two polymer layers on the substrate. Again, preferably a portion of the first and second functional groups are unreacted after the second polymer chemically reacts with the first polymer. In an embodiment, the polymer coating is microporous or nanoporous.

In the present invention, the polymer solutions may be sprayed onto the substrate sequentially in a layer-by-layer assembly process, or the polymer solutions, suspensions, or emulsions may be sprayed at the same time.

Accordingly, in an embodiment the first and second solution, suspension, or emulsion are sprayed simultaneously onto the substrate. In a further embodiment, the method comprises continuously spraying both the first and second solution, suspension, or emulsion through one or more apertures (such as a one or more spray nozzles), while moving the substrate, the one or more apertures, or both, during the spraying process. For example, the one or more apertures may be stationary and the substrate is moved relative to the one or more apertures so that a new portion of the substrate is continuously being sprayed. Alternatively, the substrate is stationary and the one or more apertures are moved relative to the substrate. The substrate and the one or more apertures may be moved relative to one another in a linear direction or according to a pre-designed pattern. In a further embodiment, the substrate is a sheet or film of flexible material, and the method comprises laterally moving the substrate relative to the one or more apertures using one or more spools or rollers.

Alternatively, the first and second solution, suspension, or emulsion are sprayed sequentially. Optionally, steps a) and b) in the above embodiments are repeated one or more times until the polymer coating reaches the desired thickness or desired number of layers, where each cycle deposits a new layer on the substrate. In specific embodiments, the polymer coating comprises more than one layer. In a further embodiment, steps a) and b) are repeated 2 or more times, 5 or more times, 10 or more times, 20 or more times, 30 or more times, 50 or more times, or 100 or more times.

In an embodiment, polymer coatings are fabricated by a continuous process where one or more substrates are continuously passed through a series of simultaneous or alternating sprays to deposit polymer films. Optionally, the one or more substrates are then passed through one or more additional sprays to functionalize or react a portion of the unreacted functional groups of the polymers. The fabricated coatings can be porous or non-porous depending on the process parameters.

In an embodiment, at least 1%, at least 2%, at least 5%, at least 10%, at least 15%, at least 20%, at least 30%, at least 40%, at least 50%, at least 60%, at least 70%, at least 80%, or at least 90% of the portion of the individual monomer units in the first polymer, the second polymer, or both, are substituted with a specific functional group. In a further embodiment, at least 5%, at least 10%, at least 20%, at least 30%, at least 40%, at least 50%, at least 60%, at least 70%, at least 80%, or at least 90% of the functional groups remain unreacted after step b). “Functionalized polymer” refers to a polymer in which at least a portion of the individual monomer units are substituted with a specific functional group.

A further embodiment optionally comprises a rinsing step involving spraying or washing the substrate with a rinse solvent or solution each time step a) is performed and/or each time step b) is performed. The rinse solvent or solution can be any solvent or solution able to remove excess amounts of the first or second polymer solutions that also does not degrade the polymer coating or interfere with the chemical reactivity between the first and second polymers. Suitable rinse solvents or solutions include, but are not limited to: acetone, methanol, ethanol, ethyl acetate, chloroform, acetonitrile, water, tetrahydrofuran (THF), dimethylformamide (DMF), dichloroethane (DCE), dichloromethane (DCM), dimethyl sulfoxide (DMSO), and combinations thereof.

Preferably, the unreacted functional groups of the first and/or second polymer from step b) are reacted to impart additional chemical or structural properties to the polymer coating, including, but not limited to, increased hydrophilicity, increased hydrophobicity, and generating a desired porosity or surface roughness. For example, an embodiment of the invention comprises hydrolyzing side chains in the first or second polymer. In an embodiment, a multifunctional small molecule and/or functionalized nanoparticle is added, wherein the multifunctional small molecule and/or functionalized nanoparticle is able to form crosslinks with the first polymer, second polymer, or both. In an embodiment, the second polymer solution is replaced with a solution that comprises a multifunctional small molecule or a functionalized nanoparticle that reacts with the first polymer to form crosslinks.

In an embodiment, the present invention provides a method for fabricating a polymer coating on a substrate, said method comprising the steps of: a) spraying the surface of the substrate with a first solution, suspension, or emulsion comprising a first polymer and a second solution, suspension, or emulsion comprising a multifunctional small molecule or functionalized nanoparticle, wherein the multifunctional small molecule or functionalized nanoparticle is able to form crosslinks with the first polymer. The multifunctional small molecule or functionalized nanoparticle reacts with the first polymer thereby forming a polymer coating on the substrate. In an embodiment, the first polymer is PVDMA.

In embodiments utilizing a multifunctional small molecule, the multifunctional small molecule includes, but is not limited to, a difunctional small molecule, such as ethylene diamine, butylene diamine, hexamethylene diamine, cystamine, 2,2″-(ethylenedioxy)bis(ethylamine), and combinations thereof.

The first solution and second solution, suspension, or emulsion can comprise any solvents, including aqueous and organic solvents, that are chemically compatible with the reactive polymers used to make the polymer coating. Additionally, the solvents should be suitable as a carrier for the polymers when sprayed. For example, if the solvent is too volatile, the solvent may evaporate before contacting the surface of the substrate resulting in uneven or incomplete deposition of the polymer. Solvents used with the first and second polymer may be the same or different from one another. In an embodiment, the present methods utilize a first and second solution.

In an embodiment, the first and second solution, suspension, or emulsion comprise acetone, methanol, ethanol, ethyl acetate, chloroform, acetonitrile, water, tetrahydrofuran (THF), dimethylformamide (DMF), dichloroethane (DCE), dichloromethane (DCM), dimethyl sulfoxide (DMSO), water, or combinations thereof.

Preferably, the first solution, suspension, or emulsion comprises acetone, ethyl acetate, chloroform, acetonitrile, tetrahydrofuran (THF), dimethylformamide (DMF), dichloroethane (DCE), dichloromethane (DCM), dimethyl sulfoxide (DMSO), water, or combinations thereof. Preferably, the second solution, suspension, or emulsion comprises acetone, methanol, ethanol, chloroform, water, dimethylformamide (DMF), dichloroethane (DCE), dichloromethane (DCM), dimethyl sulfoxide (DMSO), water, or combinations thereof.

In an embodiment, the polymer solutions (or suspensions or emulsions) are administered to the substrate using an array of spray nozzles. The nozzle array contains one or more spray nozzles and allows for the delivery of a single polymer solution (or suspension or emulsion) from each nozzle. The spray nozzles can be controlled to administer the polymer solutions, suspensions, or emulsions in a controlled sequence or simultaneously. In an alternate embodiment, two or more polymer solutions, suspensions, or emulsions may be mixed together and administered to the substrate through a single nozzle.

In an embodiment, each pass of the nozzle array over the substrate generates a single layer (or two layers if two spray nozzles are used sequentially) of the polymer coating with multiple passes generating additional layers. As a result, the film growth profile for the present invention may be similar to films and coatings generated using dip coating-based techniques (i.e., linear relationship in thickness and number of layers). Key parameters for controlling film properties include, but are not limited to, polymer solution concentration, spray rate, deposition time, and spray angle. In contrast to dip coating-based techniques, the spray-based methods of the present invention do not require rinse steps be performed, but can accommodate rinsing steps if desired.

Because the substrate does not have to be immersed in a polymer solution, lower amounts of the starting materials are necessary and the whole process can be performed in less time. Additionally, the polymer coatings can be repeatedly produced with more consistent properties, and new avenues for controlling the physical and functional properties of the films are available, which are not possible with the prior dip coating methods. For example, the shape and area of the coating deposited on the substrate can be more accurately controlled by adjusting the movement of the spray nozzle array and the exit apertures of the spray nozzles. Finally, the spray-based methods provide improved scalability and ease of use during manufacturing, thereby lowering certain barriers to commercial adoption.

This approach is straightforward to implement and can be used to fabricate physically and chemically durable porous polymer coatings on objects of arbitrary shape, size, and topography. For example, the polymer coatings can be deposited on substrates that are planar, non-planar, curved, hollow, irregularly shaped, hard or soft, as well as on objects that are flexible, reconfigurable, or able to be transferred to other surfaces without loss of the desired characteristics. In certain embodiments, the substrate is a container, a tube that is designed to come into contact with biological fluids, or the surface of a medical device, where the components of the polymer coating are selected so that liquids, gels, or biological matter have reduced adhesion to the substrate.

The substrate can be any material able to support the formation of the polymer coating, including but not limited to glass, metals, and plastics. The substrate can include curved and irregularly shaped three dimensional surfaces, as well as completely solid surfaces and mesh surfaces (e.g., having a porosity between 100 μm and 250 μm). For example, the substrate can be the interior of a container for a liquid or gel where it is undesirable for the contents of the container to stick or adhere to the surface. The first polymer, second polymer, and other materials are therefore selected so that the liquid or gel has reduced adhesion to the container. Alternatively, the substrate can be a display of a sensor where the degree or extent to which a liquid adheres to the substrate indicates the presence of a substance in the liquid.

The polymer coatings made by the present methods are able to have selectable properties, such as porosity, surface roughness, and chemical reactivity. For example, in some embodiments, the polymer coatings may have nanoscale or microscale porosity, preferably nanoscale porosity. Such coatings and films are of interest in the design of wetting and non-wetting surfaces, anti-fouling surfaces, and nano/bio-interfaces that could be used to deliver active agents (e.g., antibacterial compounds). In other desirable embodiments, the coatings do not have substantial porosity or roughness.

Polymer coatings able to be formed by the methods of the present invention include, but are not limited to, slippery liquid-infused porous surfaces (SLIPS), where an oil is added to the porous polymer coating following the deposition of the polymer coating on the substrate. The oil coats at least a portion of the polymer coating and at least partially fills the pores of at least a portion of the polymer coating. The infusion of the oil into at least a portion of the rough or porous surfaces of the polymer coating causes other liquids placed in contact with the polymer coating to slide off the polymer coating.

As used herein, “an oil” refers to a non-polar, hydrophobic chemical substance which is a liquid at ambient temperature and which has no or very low solubility in water. When SLIPS are generated, preferably the oil infused into the polymer coating is selected from the group consisting of a silicone oil, a vegetable oil, a mineral oil, a thermotropic liquid crystal, and combinations thereof. Suitable vegetable oils include, but are not limited to, canola oil, coconut oil, olive oil, soybean oil and combinations thereof.

A further embodiment of the invention provides for patterning the substrate so that the polymer coating is formed on a first specified portion of the substrate. A portion of the polymer coating on the first specified portion of the substrate is further functionalized with an amine, hydroxyl group, thiol group, or hydrazine group having the formula R—NH₂, R—OH, R—SH or R—NHNH₂, where R is hydrophobic. In a further embodiment, a second specified portion of the substrate is not covered by the polymer coating, or, alternatively, a portion of the polymer coating on the second specified portion of the substrate is further functionalized with an amine, hydroxyl group, thiol group, or hydrazine group having the formula R—NH₂, R—OH, R—SH or R—NHNH₂, where R is hydrophilic.

Additionally, in a further embodiment, a portion of the polymer coating on the first specified portion of the substrate is further functionalized with an amine, hydroxyl group, thiol group, or hydrazine group having the formula R—NH₂, R—OH, R—SH or R—NHNH₂, where R is hydrophobic, a second specified portion of the substrate is not covered by the polymer coating, and a third portion of the substrate is covered by a polymer coating where a portion of the polymer coating on the third specified portion of the substrate is further functionalized with an amine, hydroxyl group, thiol group, or hydrazine group having the formula R—NH₂, R—OH, R—SH or R—NHNH₂, where R is hydrophilic.

Relative to past approaches to the design of SLIPS using conventional assembly methods, (Sunny et al., Adv. Funct. Mater., 2014, 24: 6658; and Huang et al, ACS Macro Lett., 2013, 2:826) the chemical reactivity of the polymer coatings used herein is unique, and provides means to chemically tune interactions between the matrix and the infused oil phases. The present invention demonstrates that the spatial control over matrix functionalization can be used to create oil-infused SLIPS with precisely controlled chemically-patterned “sticky” regions devoid of oil (“STICKS”) that can prevent or arrest the sliding of aqueous fluids, extract samples of liquid from contacting media, and provide in-plane directional control over the trajectories of sliding droplets.

The first and second polymers of the polymer coating can comprise any polymers or combination of polymers able to form a stable polymer coating and where the first polymer is optionally able to be functionalized and the second polymer is optionally also able to be functionalized (as described in U.S. Pat. No. 8,071,210). The chemical reactivity of the functionalized polymer layers provides means to tune interactions between the different polymer layers and, optionally, the polymer layers and infused oil for SLIPS materials. For example, spatial control over the functionalization can be used to create SLIPS with regions devoid of oil that can prevent or arrest the sliding of aqueous fluids, extract samples of liquid from contacting media, or provide control over the trajectories of sliding droplets. Preferably, the first polymer is able to covalently cross-link with the second polymer. In further embodiments, the polymer layers are reacted with small chemical groups containing a hydrophobic or hydrophilic amine to further functionalize the polymer coating (i.e., to install secondary surface functionality).

One or more copolymers may be added with the first and/or second polymer. In an embodiment, the first and/or second polymer is a copolymer. For example, the first and/or second polymer may comprise two or more monomers, including co-monomers such as acrylic acid, methacrylic acid, acrylamide (AAm), dimethylacrylamide (DMAA), hydroxyethyl methacrylate (HEMA), and methoxy poly(ethylene glycol) methacrylate, that can alter the water solubility of the polymer or other co-monomers that can change the physical and chemical properties of the formed films. In an embodiment, the first polymer is partially functionalized with tri(ethylene glycol) monoethyl ether, 2-(2-(2-ethoxyethoxy)ethoxy)ethanamine, dimethylaminopropylamine (DMAPA), or ethanolamine. In an embodiment, the first polymer comprises 2-vinyl-4,4-dimethyl azlactone (VDMA) copolymerized with another type of monomer.

Smooth and/or non-porous coatings are able to be generated through the selection of appropriate polymers and polymer combinations and/or by altering other fabrication process parameters. For example, coatings formed using polymers having unhydrolyzed or partially hydrolyzed azlactone groups can result in non-porous coatings depending on the manner in which the polymer solutions are sprayed onto the substrate. As used herein, “non-porous” means the coating or polymer layer does not feature a high density or regular occurrence of pores with a diameter of at least 0.1 μm.

In an embodiment, the first polymer comprises an optionally functionalized azlactone having the formula:

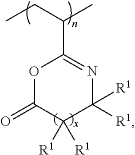

wherein x is 0 or the integers 1 or 2; and each R¹ is independently selected from the group consisting of: hydrogen, alkyl groups, alkenyl groups, alkynyl groups, carbocyclic groups, heterocyclic groups, aryl groups, heteroaryl groups, alkoxy groups, aldehyde groups, ether groups, and ester groups, any of which may be substituted or unsubstituted. The azlactone groups of the polymer may be hydrolyzed, unhydrolyzed or partially hydrolyzed. In an embodiment, the first polymer comprises functionalized poly(vinyl-4,4-dimethylazlactone) (PVDMA). In an embodiment, the first polymer consists of functionalized, partially hydrolyzed or unhydrolyzed poly(vinyl-4,4-dimethylazlactone) (PVDMA). In a further embodiment, the PVDMA was synthesized by free-radical polymerization of PVDMA with intentionally added cyclic azlactone-functionalized oligomer in an amount ranging from 1 wt % to 10 wt %, preferably between 5 wt % and 8 wt %.

Useful functionalized azlactone polymers include, but are not limited to, poly(vinyl-4,4-dimethylazlactone), poly(2-vinyl-4,4-dimethyl-2-oxazolin-5-one), poly(2-isopropenyl-4,4-dimethyl-2-oxazolin-5-one), poly(2-vinyl-4,4-diethyl-2-oxazolin-5-one), poly(2-vinyl-4-ethyl-4-methyl-2-oxazolin-5-one), poly(2-vinyl-4-dodecyl-4-methyl-2-oxazolin-5-one), poly(2-vinyl-4,4-pentamethylene-2-oxazolin-5-one), poly (2-vinyl-4-methyl-4-phenyl-2-oxazolin-5-one), poly(2-isopropenyl-4-benzyl-4-methyl-2-oxazolin-5-one), or poly(2-vinyl-4,4-dimethyl-1,3-oxazin-6-one). Useful azlactone functionalized polymers further include azlactone functionalized polyisoprenes and azlactone functionalized polybutadienes.

In an embodiment, the second polymer is optionally functionalized and comprises an amine functionalized polymer, an alcohol functionalized polymer, or a thiol functionalized polymer. Creating specific functionalities with amine, alcohol, and thiol groups is a process well known in the art (for example, see Bioconjuqate Techniques, 2^{nd} Edition, 2008, Greg T. Hermanson). In embodiments, the second polymer comprises an optionally functionalized polymer selected from the group consisting of poly(ethylene imine) (PEI), polylysine, pollyallylamine, poly(amidoamine) dendrimers, polyvinyl alcohol, poly hydroxyl ethyl methacrylate, poly(methacrlic acid) functionalized with cysteamine, and linear and hyperbranched and dendritic polymers functionalized with primary amines, hydroxyl groups, or thiol groups.

In embodiments, the second polymer comprises a polymer, which is optionally functionalized, selected from the group consisting of polyolefins, poly(alkyls), poly(alkenyls), poly(ethers), poly(esters), poly(imides), polyamides, poly(aryls), poly(heterocycles), poly(ethylene imines), poly(urethanes), poly(α,β-unsaturated carboxylic acids), poly(α,β-unsaturated carboxylic acid derivatives), poly(vinyl esters of carboxylic acids), poly(vinyl halides), poly(vinyl alkyl ethers), poly(N-vinyl compounds), poly(vinyl ketones), poly(vinyl aldehydes) and any combination thereof. In an embodiment, the second polymer comprises poly(ethylene imine) (PEI).

For some embodiments, it may be desirable to further functionalize a portion of the polymer coating. This can be achieved, for example, by reacting a portion of any unreacted functional groups following step b) (also referred to herein as “residual functional groups”) in the polymer layers with an amine group, hydroxyl group, thiol group or hydrazine, or by reacting a portion of the first or second polymer with an amine reactive group or hydroxyl reactive group.

In an embodiment, at least a portion of the unreacted functional groups in the first polymer, second polymer, or both is reacted with isothiocyanates, isocyanates, acyl azides, N-hydroxysuccinimide (NHS) esters, sulfonyl chlorides, aldehydes, glyoxals, epoxides, oxiranes, carbonates, aryl halides, imidoesters, carbodiimides, anhydrides, fluorophenyl esters, or combinations thereof. In an embodiment, at least a portion of the unreacted functional groups (or residual functional groups) in the first or second polymer is reacted, such as generally described in Scheme 1 below, with an amine, hydroxyl group, thiol group, or hydrazine group having the formula R—NH₂, R—OH, R—SH or R—NHNH₂, where R is hydrophobic or hydrophilic (it should be noted that the residual functional groups are not limited to azlactone groups).

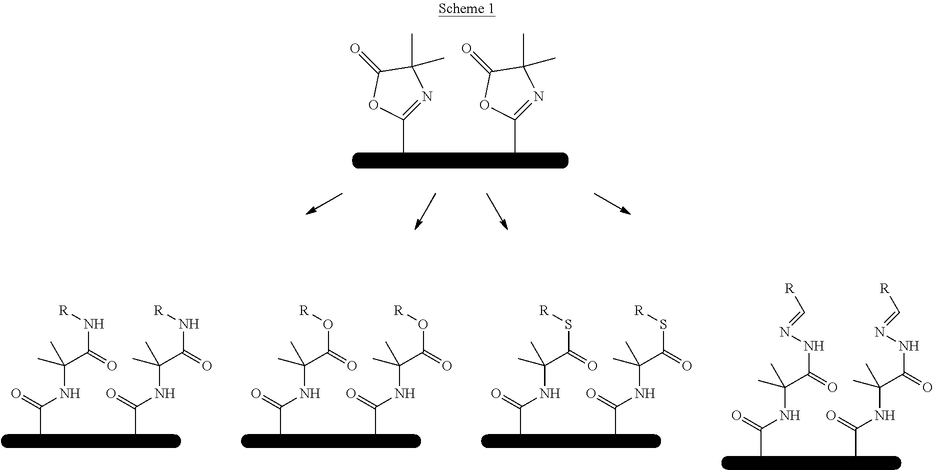

In embodiments, R is a substituted or unsubstituted C₁ to C₂₀ alkyl group, preferably a C₁ to C₁₂ alkyl group. In other embodiments, R is a substituted or unsubstituted 02 to 020 alkenyl group, preferably a C₂ to C₁₂ alkenyl group. In further embodiments, at least a portion of the unreacted functional groups in the polymer coating is reacted with an amine selected from the group consisting of methylamine, ethylamine, propylamine, butylamine, pentylamine, hexylamine, heptylamine, octylamine, nonylamine, decylamine, undecylamine, dodecylamine, and combinations thereof, preferably n-propylamine, n-octylamine, or n-decylamine. In other embodiments, R is an alkyl group substituted with one or more hydroxyl groups or charged groups such as COO⁻ or NR3⁻. In further embodiments, at least a portion of the residual functional groups in the polymer coating is reacted with an alcohol selected from the group consisting of methanol, ethanol, propanol, butanol, pentanol, hexanol, heptanol, octanol, nonanol, decanol, and combinations thereof. In further embodiments, at least a portion of the residual functional groups in the polymer coating is reacted with a thiol selected from the group consisting of methanethiol, ethanethiol, propanethiol, butanethiol, pentanethiol, hexanethiol, heptanethiol, octanethiol, nonanethiol, decanethiol, and combinations thereof. In an embodiment, at least a portion of the residual functional groups in the polymer coating is reacted with an amino sugar, amino alcohol, amino polyol, glucamine (preferably D-glucamine), dimethylaminopropylamine (DMAPA), or combinations thereof. In other embodiments, at least a portion of the residual functional groups in the polymer coating is reacted with a hydrazine group to form an acylhydrazine group.

In a further embodiment, at least a portion of the residual functional polymer is reacted to form polymer coatings with chemically labile amide/ester-, amide/thioester-, and amide/imine-type bonds. These chemically labile bonds are able to be broken, such as through hydrolysis, in order to undergo stimuli-responsive and reversible changes in wetting behaviors. For example, a functionalized layer (not hydrolyzed) can be designed to be hydrophobic while the functionalized layer which has been hydrolyzed to break amide/ester- or amide/thioester-type bonds can be designed to be relatively hydrophilic. Alternatively, one or more of the polymers may be hydrolyzed to control the porosity of the resulting coating. Coatings fabricated using unhydrolyzed polymers may have reduced porosity or may even be non-porous.

In a further embodiment, the invention provides for patterning the substrate so that a nanoporous or microporous polymer layer having unhydrolyzed functionalized azlactone layer is sprayed on a first specified portion of the substrate while the nanoporous or microporous polymer layer having a hydrolyzed functionalized azlactone layer is sprayed on a second specified portion of the substrate. Preferably, the oil is added to the multilayer film following the hydrolyzing step.

In an embodiment, the first polymer is further functionalized with a hydrophobic (decylamine or propylamine) or hydrophilic (glucamine) primary amine-containing small molecule.

A specific embodiment of the present invention provides a polymer coating fabricated by spraying poly(ethylene imine) (PEI) and poly(vinyl-4,4-dimethylazlactone) (PVDMA) onto a selected region of a substrate. The PVDMA may be hydrolyzed, non-hydrolyzed, or partially hydrolyzed, in order to adjust the characteristics of the polymer coating. For example, the PVDMA may be unhydrolyzed in order to generate a substantially non-porous coating. Optionally, the one or more PVDMA/PEI layers are further functionalized with a decyl group by reacting with n-decylamine and the polymer coating is infused with a silicone oil or an anisotropic thermotropic liquid crystal.

One aspect of the invention provides polymer coatings having thickness equal to or less than 1,000 μm, equal to or less than 500 μm, equal to or less than 100 μm, equal to or less than 50 μm, preferably less than or equal to 10 μm, preferably less than or equal to 5 μm.

Thus, the methods described herein can be used to more efficiently fabricate physically and chemically durable polymer coatings on objects of arbitrary shape, size, and topography. In addition, the present methods allow for the improved fabrication of polymer coatings that are anti-fouling to bacteria, fungi, and mammalian cells. These surfaces could be used as antifouling surfaces, anti-bacterial/fungal surfaces, detectors, and in packaging materials. The liquid phases or solid phases of certain coatings can further be used as reservoirs for the controlled release of other active agents (e.g., antibiotics or anti-biofilm agents, etc.) that can impart additional functions to these surfaces.

### BRIEF DESCRIPTION OF THE DRAWINGS

FIG. 1. A) Schematic showing post-fabrication functionalization of residual azlactone groups in nanoporous PEI/PVDMA multilayers by reaction with n-decylamine in one embodiment of the invention. B and C) Low- and high-magnification SEM images of multilayers in one embodiment showing micro- and nanoscale porosity. D) Schematic showing droplet of water sliding on a tilted oil-infused porous surface. E-G) Top-down images showing a droplet of aqueous tetramethylrhodamine (TMR) (10 μL; tilt angle≈10°) sliding on a silicone oil-infused multilayer.

FIG. 2. A-D) Top-down views of droplets of aqueous TMR (10 μL) sliding down silicone oil-infused multilayers fabricated on PET film (A) and (B) and aluminum foil (C) and (D); tilt angle≈10°; dotted lines show borders between SLIPS-coated (top) and uncoated regions (bottom) of each panel. E and F) Sliding of aliquots of aqueous TMR (20 μL; tilt angle≈3°) inside SLIPS-coated flexible PTFE tubing (left side of each panel); the right of each panel shows plugs of aqueous TMR in uncoated tubes. G-L) Images showing a strip of SLIPS-coated aluminum foil wrapped around a bare glass tube. M and N) A droplet of aqueous TMR (50 μL) sliding on SLIPS-coated stainless-steel wire mesh. 0) Motor oil (bottom of mesh) can pass through the mesh, but water (top of mesh) cannot, providing principles for oil/water separation. P and Q) SEM images of multilayers on wire mesh prior to oil infusion. R and S) Droplets of aqueous TMR sliding on a SLIPS-coated glass slide after severe abrasion by rubbing with sandpaper; the dotted boxes show the location of the abraded region. T and U) SEM images of non-abraded (T) and sandpaper-abraded (U) multilayers in (R) and (S) after extraction of silicone oil.

FIG. 3. A) Images showing samples of chemically complex media sliding down a glass slide coated with silicone oil-infused multilayers: acidic and alkaline water, unfiltered eutrophic lake water, serum-containing cell-culture medium, glycerol, and ketchup are shown. B) Plot showing sliding behaviors of droplets of DI water or aqueous droplets containing SDS (0.4×10⁻³ M), DTAB (0.4×10⁻³ M), HTAB (25×10⁻⁶ M), or LPS (77×10⁻¹² M) on multilayers infused with silicone oil (gray bars) or the thermotropic liquid crystal E7 (black bars) at 23° C.; the white bar shows the sliding behavior of an aqueous droplet of SDS on E7-infused multilayers equilibrated to a temperature of 70° C., well above the nematic/isotropic transition temperature (≈60° C.) for this LC; results are expressed as the time required for a 10 μL droplet to slide 2 cm.

FIG. 4. A and B) Schematic of functionalization of reactive multilayers (A) with D-glucamine to create a porous matrix presenting hydroxyl functionality (B). C) Selective transfer of an aqueous solution of fluorescein onto three sticky patches patterned by selective deposition of glucamine (followed by treatment of surrounding regions with decylamine and infusion of oil; scale=2 mm). D and E) Fluorescence microscopy images reveal aqueous fluids to be confined within glucamine-functionalized spots (D; scale=500 μm) and that sticky regions were devoid of oil (E; oil; scale=500 μm). F-H) Images showing samples of fluid captured from actively sliding drops using patterned sticky patches (white and black arrowheads show samples of fluid that have or have not yet broken free, respectively, as the droplet slides over three sticky patches). I-M) Series of images showing guided control over the in-plane path of a water droplet as it slides down the surface of a SLIPS-coated glass slide patterned with 13 strategically placed sticky spots; the dotted line traces the locations of the sticky spots and shows the non-linear sliding path.

FIG. 5. A-C) Digital photographs showing aqueous droplets of TMR (10 μL) placed on samples of treated filter paper. The right sample in each panel shows a droplet sliding down the surface of filter paper coated with decylamine-functionalized multilayers infused with silicone oil (tilt angle˜10°). The left sample in each panel shows the behavior of a droplet of TMR placed on a control sample of oil-infused filter paper (with no porous multilayer coating; tilt angle˜10°).

FIG. 6. A-I) SEM images of decylamine-treated PEI/PVDMA multilayers (prior to the infusion of oil) fabricated on the surfaces of (A)-(C) planar PET film, (D)-(F) aluminum foil, and (G)-(l) laboratory filter paper. For each series (A)-(C), (D)-(F), and (G)-(I), samples were imaged at three different magnifications.

FIG. 7. A-C) SEM images, at three different magnifications, of nanoporous multilayers (prior to the infusion of oil) fabricated on the inner (luminal) surfaces of flexible PTFE tubes (inner dia.=1.15 mm).

FIG. 8. A-D) Digital photographs showing hollow glass tubes (right side of each panel) and hollow glass tubes with SLIPS-coated inner surfaces (left side of each panel). The images in (B)-(D) show the behaviors of droplets of aqueous TMR (20 μL) placed in the tubes: droplets slid readily in SLIPS-coated samples and remained stuck as plugs in bare, uncoated tubes (tilt angle˜3°). E-F) Digital images showing droplets of aqueous TMR (50 μL) sliding down samples of stainless steel wire mesh (wire dia.˜90 μm, pore size=126.3±3.5 μm) coated with oil-infused multilayers (tilt angle˜3°). G-H) An experiment identical to that shown in (E)-(F), but performed using samples of bare, uncoated mesh.

FIG. 9. A-B) Low- and high-magnification SEM images showing the morphology, topography, and porosity of multilayers fabricated on stainless steel wire mesh (wire dia.˜90 μm, pore size=126.3±3.5 μm). C-D) SEM images of bare, uncoated stainless steel wire mesh. E-G) Proof-of-concept experiments demonstrating principles for the low-energy, gravity-driven separation of oil/water mixtures using SLIPS-coated surfaces. Stainless steel wire mesh coated with nanoporous decylamine-functionalized polymer multilayers (A)-(B) were infused with a conventional automotive motor oil, placed over the open mouth of a laboratory beaker, and maintained at a tilt angle of ˜2° by supporting one side of the mesh using a glass chip (E). A mixture (3:2, v/v) of motor oil and water (or other aqueous solutions) was then poured onto the coated mesh. Oil passed through the mesh and was collected in the beaker below; water did not pass through the mesh, but slid down the slippery surface of the mesh and was collected in a secondary container (F)-(G).

FIG. 10. A-O) Digital photographs demonstrating the retention of slippery properties of substrates coated with oil-infused multilayers after bending, flexing, creasing, and scratching. A-C) Top-down perspective showing a droplet of aqueous TMR (10 μL) sliding on a sample of SLIPS-coated PET plastic film bent and held end-to-end. D-L) Images showing the sliding of aqueous droplets of TMR (10 μL) on SLIPS-coated filter paper (D-F), aluminum foil (G-I), and PET film (J-L); SLIPS coated substrates were permanently creased prior to placing the aqueous droplets, and the aqueous droplets were observed to contact and wet the crease (marked by the locations of the black arrowheads). M-O) Digital images showing the sliding of a droplet of aqueous TMR on a SLIPS-coated PET substrate that was severely scratched in multiple locations (marked by black arrowheads); the droplet was observed to slide unperturbed over the scratches. P-Q) SEM images of a creased multilayer showing the creased region (P) and a scratched polymer film showing the scratched region (Q). Images were acquired after leaching of the infused oil phase.

FIG. 11. A-D) Representative SEM images of cross sections of a porous PEI/PVDMA multilayer revealing the porous structure to extend throughout the bulk of the coating at low (A)-(B) and high (C)-(D) magnifications.

FIG. 12. Plot of advancing water contact angle (closed symbols) and contact angle hysteresis (open symbols) versus time (in days) for multilayers infused with silicone oil immersed for prolonged periods in deionized water (circles), simulated seawater (squares), or unfiltered eutrophic lake water (triangles).

FIG. 13. Top) Structure of the small-molecule thermotropic liquid crystal E7, an anisotropic oil consisting of a mixture of four different cyanobiphenyls containing long aliphatic chains. A-L) Digital photographs showing the sliding behaviors of 10 μL droplets of (A)-(F) deionized water or (G)-(L) an aqueous solution of SDS (0.4 mM) on decylamine functionalized multilayers infused with either silicone oil (A)-(C) and (G)-(I) or E7 (D)-(F) and (J)-(L). All samples were tilted at angles of ˜13°. Also shown are the times required for the droplets to slide down the SLIPS-coated surfaces over a distance of 2 cm. Droplets of water traversed this distance in ˜5 seconds regardless of the identity of the infused oil (A)-(C) and (D), (F). Droplets of aqueous SDS traversed this distance in ˜7 seconds on silicone oil-infused SLIPS (G)-(I), but required ˜49 seconds to traverse this distance on E7-infused SLIPS ((J)-(L); box).

FIG. 14. A-F) Digital images showing the influence of chemical functionalization of the porous multilayer matrix on the sliding behaviors of aqueous droplets; experiments were performed using reactive multilayers fabricated on planar glass slides and functionalized by treatment with n-propylamine and D-glucamine and then infused with silicone oil. A-D) Behavior of an aqueous droplet of TMR (10 μL) on a propylamine-functionalized multilayer infused with silicone oil at tilt angles of 10°, 15°, or 25°; the droplet remained stationary and did not slide until the tilt angle was greater than 15°, a value that is greater than that observed on multilayers functionalized with n-decylamine (which exhibited tilt angles as low as ˜1°). E-F) Image showing the behavior of an aqueous droplet of TMR (10 μL) placed on a glucamine-functionalized multilayer infused with silicone oil; the droplet was observed to at least partially displace the oil and spread readily on the surface of the coating. G-H) SEM images showing porous multilayers functionalized post-fabrication by treatment with propylamine (G) and glucamine (H).

FIG. 15. Chemical structures representing PEI/PVDMA LbL films, with panel (A) showing an azlactone-containing, unfunctionalized film, and films functionalized with decylamine (B), decanol (C) and decanethiol (D). Representative advancing WCA measurements for the corresponding films in (A)-(D) are provided in (E)-(H). I) provides ATR IR thin film spectra for the unfunctionalized film (azlactone C═O carbonyl stretch, 1819 cm⁻¹) and decylamine, decanol or decanethiol functionalized films, showing complete or near complete consumption of the azlactone peak.

FIG. 16. Chemical structures for PEI/PVDMA films functionalized with decanol (A), and the result after treatment by hydroxyl ions, and films functionalized with decanethiol (B), and the result after treatment with hydrazine. C) change in the advancing WCA of decanol functionalized films are shown in (gray bars) and decylamine functionalized films (black bars) upon exposure to 50 mM aqueous NaOH. D) change in the advancing WCA of decanethiol functionalized films (gray bars) and decylamine functionalized films (black bars) upon exposure to hydrazine. E) digital picture of a 3×3 array of hydrophilic spots patterned by hydrolysis with aqueous base onto a decanol functionalized film; a large droplet of water placed nearby beads up on the untreated and still superhydrophobic region. F) fluorescence micrograph of a 2×2 array, prepared the same way as in (E), after loading the hydrophilic spots with the fluorescent dye TMR. G) digital image of an oil (dichloroethane, DCE) droplet on the surface of an underwater-superoleophobic film (˜1×1 cm) submerged in a vial underwater; the film was prepared as in (B). H) advancing oil contact angle underwater. Water and oil were dyed to aid visualization.

FIG. 17. A) shows chemical structure for the reaction of a PEI/PVDMA film functionalized with acylhydrazine and then octyl aldehyde (forward direction) and imine bond cleavage under acidic conditions (reverse direction). B) shows advancing WCA for the hydrophilic acylhydrazine-presenting film and for the superhydrophobic octyl aldehyde functionalized film (C). D) shows a plot showing the reversibility of the process illustrated in (A), as monitored by changes in advancing WCA. One cycle begins with the superhydrophobic octyl aldehyde film, followed by treatment with acidic media, and the subsequent return to the superhydrophobic state. Error bars represent the standard deviation of measurements obtained on three identically prepared films.

FIG. 18. Illustrates limitations of making reactive porous polymer coatings using dipping-based fabrication methods. In terms of time, such methods are limited by the rate of diffusion of the polymer in the solution onto the substrate surface. Additionally, dipping-based methods require a large amount of solution in order to fully immerse the substrate, and may not be applicable to coating large surfaces.

FIG. 19. A-B) show process flow diagrams for the fabrication of layer-by-layer assembly of PEI/PVDMA multilayer using spray-based methods. A) shows the process with a rinse step, and B) shows the process without a rinse step (reduces fabrication time by ½). C) shows a process flow diagram for the fabrication of PEI/PVDMA porous matrix by simultaneous spraying of both the polymer solutions. Simultaneous spraying significantly reduces the fabrication time.

FIG. 20. Shows a top-down SEM image of a multilayer film (35 bilayers) coated on a planar glass substrate by spray coating. The substrate was rinsed with DMF after spraying each polymer solution.

FIG. 21. A) shows a top-down SEM image showing nano- and micro-scale porosity of the multilayers (35 bilayers) coated on a planar glass substrate by spray coating. The polymer solutions—PEI and PVDMA were sprayed consecutively without any rinsing with DMF (in between). B-D) are a series of images showing a droplet of aqueous TMR bouncing off of a superhydrophobic n-decylamine-functionalized spray-coated multilayer coating.

FIG. 22. A-C) are a series of images showing a blob of ketchup sliding around a SLIPS-coated glass container. The inside of the glass container was spray-coated with 35 bilayers of PEI/PVDMA; the multilayers were then reacted with n-decylamine and infused with silicone oil to fabricate SLIPS coatings. D-E) Series of images showing a blob of ketchup stuck inside a bare, uncoated glass container.

FIG. 23. A-B) show top-down low-magnification and high-magnification SEM images showing micro- and nanoscale porosity of multilayers (25 bilayers) coated on the outside surface of polyethylene (PE) tubing segments. C-E) are a series of images showing colored water droplets sliding on the outside surface of SLIPS-coated PE tubing segments. F) is an image showing water droplets stuck on the outside surface of the bare, uncoated PE tubing segment.

FIG. 24. A-C) are a series of images showing that SLIPS-coated polyethylene (PE) tubing segments (left side) are not fouled by blood, whereas bare, uncoated PE tubing segments (right side) are completely covered in blood, after ˜1 min of contact. A) shows the tubing segments prior to submersion into the blood, and C) shows the tubing segments after they are withdrawn.

FIG. 25. A-B) show top-down low-magnification and high-magnification SEM images showing micro- and nanoscale porosity of multilayers (35 bilayers) coated on a planar glass substrate. Solutions of PEI and PVDMA were sprayed simultaneously on the substrate to fabricate multilayers reducing the fabrication time by half. C-E) are a series of images showing droplets of blood sliding on the SLIPS-coated glass slides (coated by simultaneous spraying). F-H) are an analogous series of images showing that blood droplets do not slide on a bare, uncoated glass slide.

FIG. 26. A) shows a plot of ellipsometric thickness versus the number of PEI/PVDMA bilayers for the films fabricated with (●) and without (▪) a rinsing step on a silicon substrate. Linear increase in thickness with the increase in number of bilayers was observed in both the cases (with and without rinse). B) is a plot showing representative PM-IRRAS spectra for PEI/PVDMA multilayers (12 bilayers) deposited on gold-coated silicon substrate before (●) and after functionalization with n-decylamine (▪).

FIG. 27. A-B) show chemical structures of A) partially hydrolyzed (≈22%) and B) unhydrolyzed PVDMA. C) shows top-down SEM images showing micro- and nanoscale porosity of PEI/PVDMA (partially hydrolyzed) multilayers (35 bilayers) coated on a planar glass substrate. D) shows top-down SEM images showing large macroscale features but lacking nanoscale porosity of PEI/PVDMA (unhydrolyzed) multilayers (35 bilayers) coated on a planar glass substrate.

FIG. 28. Structures of (A) poly(2-vinyl-4,4-dimethylazlactone) (PVDMA), (B) a copolymer derivative of PVDMA, called herein “P1”, containing carboxylic acid-functionalized side chains, obtained by partial side-chain azlactone hydrolysis of PVDMA (m=0.22), and (C) branched poly(ethyleneimine) (PEI), the polymer used as an amine-containing building block in an embodiment of the invention.

FIG. 29. A) Schematic showing spray-coating workflow for the LbL fabrication of P1/PEI coatings. The dotted lines track the horizontal movement of the spray nozzles. B) Plot showing the optical thicknesses of P1/PEI films fabricated with (●) and without (▴) intermittent solvent rinse steps on silicon substrates versus the number of spray cycles, as characterized by ellipsometry. Error bars represent the standard deviation of at least three measurements on three separate films. For some points, the error bars are smaller than the symbols used to represent the data and are thus not visible. The dotted (y=5.5x, R²=0.99 and dashed (y=16.9x, R²=0.99) lines are linear fits to the data forced through x=0, y=0.

FIG. 30. Digital photographs (A, D, G; scale bars=25 mm) and low- and high-magnification top-down SEM images (B-C, E-F, H-I) of 35-bilayer P1/PEI films fabricated with (A-C) or without (D-F) rinse steps and 35-bilayer PVDMA/PEI films fabricated without (G-I) rinse steps.

FIG. 31. A) Plot showing PM-IRRAS spectra for 10-bilayer P1/PEI films deposited on a gold-coated silicon substrate before (solid line) and after (dashed line) functionalization by treatment with DMAPA overnight at room temperature. B) Fluorescence microscopy image of a native (azlactone-containing) P1/PEI film ˜80 nm thick after reactive microcontact printing using a PDMS stamp and a solution of tetramethylrhodamine cadaverine. Scale bar=100 μm. C-E) Images showing contact angles of 5 μL water droplets on 35-bilayer P1/PEI multilayers before (C) and after (D-E) functionalization with (D) DMAPA or (E) n-decylamine. The thickness of the needle used to dispense water as shown in the images is 0.718 mm. For simplicity, residual amine functionality present in these films is not shown in the accompanying illustrations of chemical structure.

FIG. 32. Fluorescence microscopy image of a propylamine-treated P1/PEI film (˜80 nm thick and fabricated on a silicon substrate) after reactive microcontact printing using a PDMS stamp inked with TMR-cadaverine. No significant fluorescence was observed in this control experiment. Scale bar=100 μm.

FIG. 33. Cross-sectional SEM images of 35 bilayer P1/PEI films fabricated on a silicon substrate by spray-based assembly in the absence of intermittent spray-rinse steps. The substrate was scratched with a diamond-tipped pen on the back and then fractured along the scratch to expose the cross-section prior to imaging.

FIG. 34. Representative ATR-IR spectrum of a P1/PEI film that was removed from its underlying silicon substrate by scraping.

FIG. 35. Representative images showing (A) beading of a droplet of DCE and (B) the static contact angle (˜160°) of DCE droplets on DMAPA-functionalized P1/PEI multilayers submerged under water. C,D) Images showing (C) beading of a droplet of water and (D) the static contact angle (˜155°) of water droplets, under air, on n-decylamine-functionalized P1/PEI multilayers. The thickness of the needle used to dispense water and DCE as shown in the images is 0.718 mm.

FIG. 36. A-C) Top-down photographs showing a droplet of aqueous TMR (20 μL; tilt angle≈20°) sliding on a glass substrate coated with a silicone oil-infused P1/PEI film (the glass slide is ˜2 cm long). D) Plot showing the sliding times of different liquids on SLIPS-coated glass slides ˜2 cm long; 20 μL droplets were used in each case and the substrates were tilted to 20°. E-G) Series of images showing a sample of tomato ketchup sliding around a SLIPS-coated glass container (same as FIG. 22). The glass container was spray-coated with a 35-bilayer P1/PEI coating that was then reacted with n-decylamine and infused with silicone oil prior to use. H-J) Series of images showing a sample of ketchup stuck inside a bare, uncoated glass container. K-N) Series of images showing that PE tubing segments (˜8 cm long) dipped into whole blood (for ˜10 s) (see also FIG. 24). In each panel, the tube on the left is coated with a P1/PEI SLIPS coating and the tube on the right is uncoated.

FIG. 37. Bare glass and SLIPS-coated substrates were submerged in bacterial cultures and incubated for 24 h. The substrates were then removed from the cultures, and the resulting biofilms were stained with syto-9 fluorescent dye. (A, B) Representative fluorescence microscopy images of P. aeruginosa bacterial biofilms formed on SLIPS-coated glass substrates (left) and on bare glass substrates (right). (C,D) Representative fluorescence microscopy images of S. aureus bacterial biofilms formed on SLIPS-coated glass substrates (left) and on bare glass substrates (right). All scale bars are 400 μm.

FIG. 38. Chemical structures of the primary amine-containing small non-polymeric linkers [linker 1 (hexamethylene diamine; difunctional) and linker 2 (Jeffamine® T-403, trifunctional)] used for fabrication of thin reactive films. (C,D) Plot of optical thickness (as determined by ellipsometry) versus the number bilayers of (C) P1/linker 1 and (D) P1/linker 2 sprayed onto planar silicon substrates. (E,F) Plots showing representative PM-IRRAS spectra for (E) P1/linker 1 and (F) P1/linker 2 fabricated on gold-coated silicon substrates. The absorbance peak at ˜1826 cm-1 in each spectrum corresponds to the carbonyl group of unreacted azlactone groups present in the films.

FIG. 39. Plot of optical thickness (as determined by ellipsometry) versus the number of bilayers fabricated by sequentially spraying P1 (10 mM in DMSO) and amine-functionalized silica nanoparticles (1 wt % in DMSO) on a planar silicon substrate. (B) Plot showing representative PM-IRRAS spectra for P1/silica nanoparticle films fabricated on a gold-coated silicon substrate. The absorbance at ˜1826 cm-1 corresponds to the carbonyl group of unreacted azlactone functionality. (C) Representative SEM image of a P1/nanoparticle film showing micro- and nano-scale porosity. Scale bar=1 μm; 100 nm inset.

FIG. 40. Schematic showing the simultaneous spraying of P1 and PEI to fabricate P1/PEI coatings. The dotted lines track the horizontal movement of the spray nozzles. B) Plot showing the optical thicknesses of P1/PEI films as a function of number of bilayers at five different ratios of spraying rates, 1:7 (●), 1:3 (▴), 1:1 (▾), 1.9:1 (♦), and 3:1 (∘). The combined P1 and PEI spraying rate was kept constant at 7.2±1.2 mmol/s. For some points, the error bars are smaller than the sizes of the symbols used to represent the data and are therefore not visible. For the 1:1 P1/PEI ratio, the thickness after 145 s of spraying time (denoted in the plot by an inverted triangle with an asterisk; ▾*) was determined from cross-sectional SEM images. The dotted lines are the linear fits (R²≥0.99) to the data forced through x=0 and y=0. The dashed double arrow is included only as a guide to the eye. C) Plot showing the growth rate taken from the slopes of the dotted lines shown in (B) versus the P1/PEI spraying rate ratio; error bars are smaller than the sizes of the symbols used to represent the data. D) Low- and high-magnification (inset) SEM images of coatings fabricated by simultaneously spraying P1 and PEI at 1:1 ratio of spraying rates on a silicon substrate for 145 seconds. Scale bar=2 μm; 400 nm insets

FIG. 41. Cross-sectional SEM images of P1/PEI films fabricated on a silicon substrate by simultaneously spraying P1 and PEI (at spraying rate ratio of 1:1) for 145 seconds. The substrate was scratched with a diamond-tipped pen on the back and then fractured along the scratch to expose the cross-section prior to imaging.

FIG. 42. SEM images (top-down) of films fabricated by simultaneously spraying solutions of P1 and PEI at (A) 1:7, (B) 1:3, (C) 1.9:1, and (D) 3:1 ratios (P1/PEI) of spraying rates onto planar silicon substrates. For all experiments, the combined polymer spraying rate was kept constant at 7.2±1.2 mmol/s. Inset scale bar=(A) 2 μm, (B) 1 μm, (C) 400 nm, and (D) 400 nm.

FIG. 43. Low- and high-magnification SEM images of films fabricated by simultaneously spraying P1 and PEI at 1:1 ratio of spraying rates on a silicon substrate for 145 seconds. Images show the boundaries between intact films and areas where the films were scratched away.

FIG. 44. SEM images (top-down) of films fabricated by simultaneously spraying solutions of P1 and PEI at 1:1 ratio (P1/PEI) of spraying rates after (A) 6 s, (B) 38 s, and (C) 145 s onto planar silicon substrates. Panel C is reproduced from FIG. 40D. Scale bar=2 μm.

FIG. 45. Plot showing contact angle of water droplets (5 μL) on films fabricated by simultaneously spraying solutions of P1 and PEI at different ratios of P1/PEI spraying rates onto planar silicon substrates.

FIG. 46. Digital photos (scale bar=50 mm) of PVDMA/PEI and P1/PEI films fabricated by simultaneous spraying onto planar silicon substrates (after 145 seconds of cumulative spraying time). The spraying rate ratio was fixed at 1:1 for both PVDMA/PEI and P1/PEI films. (C,D) low- and high-magnification SEM images (top-down) of the PVDMA/PEI film shown in (A).

FIG. 47. A) Plot showing PM-IRRAS spectra for P1/PEI films (fabricated using simultaneous spraying-based procedures, P1/PEI spraying ratio=1:1) deposited on a gold-coated silicon substrate before functionalization (solid line) and after treatment with n-decylamine (dotted line) and then treatment with n-decanoyl chloride (dashed line). B,C) Fluorescence microscopy images of a (B) amine-containing (C) decanoyl chloride-treated P1/PEI film (˜170 nm thick, fabricated on a silicon substrates, and pretreated with propylamine to exhaust residual azlactone functionality) after treatment with 7-(diethylamino)coumarin-3-carboxylic acid N-succinimidyl ester. (D) Merged fluorescence images of native (amine and azlactone-containing) P1/PEI films after treatment with tetramethylrhodamine cadaverine, followed by treatment with coumarin-NHS ester. Scale bars=100 μm. E-I) Images showing contact angles of 5 μL water droplets on P1/PEI films (E) before and after (F-I) functionalization with (F) DMAPA (the contact angle of a 5 μL DCE droplet on the same film under water is shown in (G)), (H) n-decylamine, and (I) n-decylamine followed by n-decanoyl chloride. The thickness of the needle used to dispense water as shown in panel G is 0.718 mm.

FIG. 48. A) Images showing 20 μL drops of liquid media sliding down a glass slide (˜2 cm long, tilted to 20°) coated with silicone oil-infused P1/PEI films: droplets of urine, blood, tea, soy sauce, eutrophic lake water and yogurt drink are shown. (B-E) Top-down perspective showing droplets of aqueous TMR (20 μL) on a sample of SLIPS-coated (B,C) and uncoated (D,E) flexible polyester substrates bent and held end-to-end. (F,G) Photographs showing the sliding of a droplet of aqueous TMR on a SLIPS-coated glass substrate (˜2 cm long) that was scratched in multiple locations (marked by the dotted white line); the droplet was observed to slide unperturbed over the scratches. (H) SEM image of the scratched coating showing the scratched region; this image was acquired after leaching of the infused oil phase. (I-K) Images showing the sliding of aqueous droplets (15 μL) on SLIPS-coated filter paper. SLIPS coated filter paper was permanently creased prior to placing the aqueous droplets, and the aqueous droplets were observed to contact and wet the crease. L,M) A droplet of aqueous TMR (20 μL) sliding on SLIPS-coated stainless-steel wire mesh. N,O) Low- and high magnification SEM images of P1/PEI coatings on wire mesh prior to oil infusion.

FIG. 49. (A-C) show stability of SLIPS substrates fabricated using spray coating. The sliding time of a 40 μL water droplet at a 20° angle does not appreciably change after bending, scratching, or smudging the SLIPS coated substrate. (D) Plot showing water droplet sliding volume on SLIPS coated substrates held at a 15° angle after repeatedly being dipped into ultra pure water. (E) Plot showing water droplet sliding volume on SLIPS coated substrates held at a 15° angle. The top curve indicates SLIPS substrates that have been incubated in ultra pure water at room temperature. The bottom curve indicates SLIPS substrates that have been incubated in air at room temperature.

FIG. 50. (A) Schematic showing simultaneous spraying of PVDMA and PEI for use with continuous fabrication techniques. The dotted line shows the horizontal movement of the substrate with respect to the spray. 30 cm long substrates have been coated as a demonstration of concept. (B) Schematic showing roll-to-roll simultaneous spraying of PVDMA and PEI on a spooled substrate. The dotted line shows the horizontal movement of a substrate from the right spool to the left spool. 150 cm long substrates have been coated as a demonstration of concept.

FIG. 51. (A) An image of a representative simultaneously sprayed PVDMA/PEI film fabricated on a 30 cm long flexible polyester film (Dur-Lar®) before functionalization treatment. (B) Fluorescence microscopy image of a representative section of a native (azlactone-containing) simultaneously sprayed PVDMA/PEI film after treatment with tetramethylrhodamine cadaverine. Scale bar=400 μm. (C) Low- and high-magnification (inset) SEM image (‘top-down’) of a representative section of simultaneously sprayed PVDMA/PEI film fabricated on a 30 cm long flexible polyester film (Dur-Lar®). Scale bar of insets=400 nm. (D-F) Images showing contact angle of 5 μL water droplets on representative pieces of simultaneously sprayed PVDMA/PEI films fabricated on a 30 cm long flexible polyester film (Dur-Lar®) before (θ˜86°) (D) and after functionalization with n-decylamine (θ˜115°) (E) and DMAPA (θ˜42°) (F) overnight at room temperature.

FIG. 52. A) Top-down images showing a droplet of aqueous TMR (100 μL; tilt angle≈10°) sliding on a silicone oil-infused simultaneously sprayed PVDMA/PEI film fabricated on a 30 cm long flexible polyester film (Dur-Lar®). The films were treated with n-decylamine (10 mM in THF, for ˜4 hours) followed by treatment with n-decanoyl chloride (10 mM in heptane, for ˜1 hour) before infusion with silicone oil. The dotted lines mark the position of the coated film. B) Images showing contact angle hysteresis (Θ_{hys}) at different points (ends and middle) on the (30 cm long) SLIPS-coated polyester film.

FIG. 53. Top-down images showing droplets of various chemically complex fluids sliding on silicone oil-infused simultaneously sprayed PVDMA/PEI coatings fabricated on 30 cm long flexible polyester film substrates (Dur-Lar®). The films were treated with n-decylamine followed by treatment with n-decanoyl chloride before infusion with silicone oil.

FIG. 54. A) Representative top-down SEM image of a coated film obtained through a roll-to-roll process pulling the film at a rate of ˜0.7 cm/s and simultaneously spraying PEI and PVDMA solutions (each 20 mM in DMF). B,C) Representative images showing contact angle of 5 μL water droplets on uncoated and coated films after functionalization with n-decylamine and decanoyl chloride. The functionalized films infused with silicone oil demonstrated robust slippery behaviors, as evident by images in (D) showing aqueous droplets of TMR (50 μL) sliding on substrates tilted at ˜10°.

FIG. 55. (A-C) Images of a slippery, non-fouling plastic bag fabricated by heat-sealing the edges of SLIPS-coated plastic film. The bag is shown filled with tomato ketchup (A); ketchup was easily removed from the bag by gentle pouring and inversion, leaving no fouling or residue on the surface of the bag (B-C). (D-F) Images of a transparent glass substrate with a SLIPS-coated adhesive sticker-strip placed in the center (D; the strip is framed by dotted lines to guide the eye); panels E-F show the same substrate after ketchup was poured on the surface.

### DETAILED DESCRIPTION OF THE INVENTION

### Definitions

An “amine-reactive group” or “hydroxyl-reactive group” can be any functional group able to react with an amine group or hydroxyl group, respectively.

As used herein, the term “anti-fouling” refers to a material's ability to resist adhesion by an undesirable material, such as oils, organic compounds, commercially relevant liquids and gels, and organisms. In particular, it is desirable to prevent or reduce the adhesion of hydrophobic compounds and organisms to a material which is submerged or in contact with water.

As used herein, the term “slippery” refers to surfaces that allow liquid droplets and other compounds to slide off the surface with sliding angles of 90° or less, 70° or less, 50° or less, 40° or less, 30° or less, 20° or less, 10° or less, preferably 5° or less, 2.5° or less, or 2° or less.

The term “nanoscale” refers to a length less than 1,000 nm, preferably less than 100 nm, and the term “microscale” refers to a length less than 1,000 μm, preferably less than 100 μm.

The term “alkyl” refers to a monoradical of a branched or unbranched (straight-chain or linear) saturated hydrocarbon and to cycloalkyl groups having one or more rings. Alkyl groups as used herein include those having from 1 to 20 carbon atoms, preferably having from 1 to 12 carbon atoms. Alkyl groups include small alkyl groups having 1 to 3 carbon atoms. Alkyl groups include medium length alkyl groups having from 4-10 carbon atoms. Alkyl groups include long alkyl groups having more than 10 carbon atoms, particularly those having 10-20 carbon atoms. Cycoalkyl groups include those having one or more rings. Cyclic alkyl groups include those having a 3-, 4-, 5-, 6-, 7-, 8-, 9-, 10-, 11- or 12-member carbon ring and particularly those having a 3-, 4-, 5-, 6-, or 7-member ring. The carbon rings in cyclic alkyl groups can also carry alkyl groups. Cyclic alkyl groups can include bicyclic and tricyclic alkyl groups. Alkyl groups are optionally substituted. Substituted alkyl groups include among others those which are substituted with aryl groups, which in turn can be optionally substituted. Specific alkyl groups include methyl, ethyl, n-propyl, iso-propyl, cyclopropyl, n-butyl, s-butyl, t-butyl, cyclobutyl, n-pentyl, branched-pentyl, cyclopentyl, n-hexyl, branched hexyl, and cyclohexyl groups, all of which are optionally substituted. Substituted alkyl groups include fully halogenated or semihalogenated alkyl groups, such as alkyl groups having one or more hydrogens replaced with one or more fluorine atoms, chlorine atoms, bromine atoms and/or iodine atoms. Substituted alkyl groups include fully fluorinated or semifluorinated alkyl groups, such as alkyl groups having one or more hydrogens replaced with one or more fluorine atoms. An alkoxy group is an alkyl group linked to oxygen and can be represented by the formula R—O. Examples of alkoxy groups include, but are not limited to, methoxy, ethoxy, propoxy, butoxy and heptoxy. Alkoxy groups include substituted alkoxy groups wherein the alky portion of the groups is substituted as provided herein in connection with the description of alkyl groups.

The term “alkenyl” refers to a monoradical of a branched or unbranched unsaturated hydrocarbon group having one or more double bonds and to cycloalkenyl groups having one or more rings wherein at least one ring contains a double bond. Alkenyl groups include those having 1, 2 or more double bonds and those in which two or more of the double bonds are conjugated double bonds. Alkenyl groups include those having from 2 to 20 carbon atoms, preferably having from 2 to 12 carbon atoms. Alkenyl groups include small alkenyl groups having 2 to 3 carbon atoms. Alkenyl groups include medium length alkenyl groups having from 4-10 carbon atoms. Alkenyl groups include long alkenyl groups having more than 10 carbon atoms, particularly those having 10-20 carbon atoms. Cycloalkenyl groups include those having one or more rings. Cyclic alkenyl groups include those in which a double bond is in the ring or in an alkenyl group attached to a ring. Cyclic alkenyl groups include those having a 3-, 4-, 5-, 6-, 7-, 8-, 9-, 10-, 11- or 12-member carbon ring and particularly those having a 3-, 4-, 5-, 6- or 7-member ring. The carbon rings in cyclic alkenyl groups can also carry alkyl groups. Cyclic alkenyl groups can include bicyclic and tricyclic alkyl groups. Alkenyl groups are optionally substituted. Substituted alkenyl groups include among others those which are substituted with alkyl or aryl groups, which groups in turn can be optionally substituted. Specific alkenyl groups include ethenyl, prop-1-enyl, prop-2-enyl, cycloprop-1-enyl, but-1-enyl, but-2-enyl, cyclobut-1-enyl, cyclobut-2-enyl, pent-1-enyl, pent-2-enyl, branched pentenyl, cyclopent-1-enyl, hex-1-enyl, branched hexenyl, cyclohexenyl, all of which are optionally substituted. Substituted alkenyl groups include fully halogenated or semihalogenated alkenyl groups, such as alkenyl groups having one or more hydrogens replaced with one or more fluorine atoms, chlorine atoms, bromine atoms and/or iodine atoms. Substituted alkenyl groups include fully fluorinated or semifluorinated alkenyl groups, such as alkenyl groups having one or more hydrogens replaced with one or more fluorine atoms.

The term “aryl” refers to a chemical group having one or more 5-, 6- or 7-member aromatic or heterocyclic aromatic rings. An aromatic hydrocarbon is a hydrocarbon with a conjugated cyclic molecular structure. Aryl groups include those having from 4 to 30 carbon atoms, preferably having from 6 to 18 carbon atoms. Aryl groups can contain a single ring (e.g., phenyl), one or more rings (e.g., biphenyl) or multiple condensed (fused) rings, wherein at least one ring is aromatic (e.g., naphthyl, dihydrophenanthrenyl, fluorenyl, or anthryl). Heterocyclic aromatic rings can include one or more N, O, or S atoms in the ring. Heterocyclic aromatic rings can include those with one, two or three N, those with one or two O, and those with one or two S, or combinations of one or two or three N, O or S. Aryl groups are optionally substituted. Substituted aryl groups include among others those which are substituted with alkyl or alkenyl groups, which groups in turn can be optionally substituted. Specific aryl groups include phenyl groups, biphenyl groups, pyridinyl groups, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms. Aryl groups include, but are not limited to, aromatic group-containing or heterocylic aromatic group-containing groups corresponding to any one of the following benzene, naphthalene, naphthoquinone, diphenylmethane, fluorene, fluoranthene, anthracene, anthraquinone, phenanthrene, tetracene, naphthacenedione, pyridine, quinoline, isoquinoline, indoles, isoindole, pyrrole, imidazole, oxazole, thiazole, pyrazole, pyrazine, pyrimidine, purine, benzimidazole, furans, benzofuran, dibenzofuran, carbazole, acridine, acridone, phenanthridine, thiophene, benzothiophene, dibenzothiophene, xanthene, xanthone, flavone, coumarin, azulene or anthracycline. As used herein, a group corresponding to the groups listed above expressly includes an aromatic or heterocyclic aromatic radical, including monovalent, divalent and polyvalent radicals, of the aromatic and heterocyclic aromatic groups listed above provided in a covalently bonded configuration in the compounds of the present invention. Aryl groups optionally have one or more aromatic rings or heterocyclic aromatic rings having one or more electron donating groups, electron withdrawing groups and/or targeting ligands provided as substituents.

Arylalkyl groups are alkyl groups substituted with one or more aryl groups wherein the alkyl groups optionally carry additional substituents and the aryl groups are optionally substituted. Specific alkylaryl groups are phenyl-substituted alkyl groups, e.g., phenylmethyl groups. Alkylaryl groups are alternatively described as aryl groups substituted with one or more alkyl groups wherein the alkyl groups optionally carry additional substituents and the aryl groups are optionally substituted. Specific alkylaryl groups are alkyl-substituted phenyl groups such as methylphenyl. Substituted arylalkyl groups include fully halogenated or semihalogenated arylalkyl groups, such as arylalkyl groups having one or more alkyl and/or aryl having one or more hydrogens replaced with one or more fluorine atoms, chlorine atoms, bromine atoms and/or iodine atoms.

Optional substitution of any alkyl, alkenyl and aryl groups includes substitution with one or more of the following substituents: halogens, —CN, —COOR, —OR, —COR, —OCOOR, —CON(R)₂, —OCON(R)₂, —N(R)₂, —NO₂, —SR, —SO₂R, —SO₂N(R)₂ or —SOR groups. Optional substitution of alkyl groups includes substitution with one or more alkenyl groups, aryl groups or both, wherein the alkenyl groups or aryl groups are optionally substituted. Optional substitution of alkenyl groups includes substitution with one or more alkyl groups, aryl groups, or both, wherein the alkyl groups or aryl groups are optionally substituted. Optional substitution of aryl groups includes substitution of the aryl ring with one or more alkyl groups, alkenyl groups, or both, wherein the alkyl groups or alkenyl groups are optionally substituted.

Optional substituents for alkyl and alkenyl groups include among others:

—COOR where R is a hydrogen or an alkyl group or an aryl group and more specifically where R is methyl, ethyl, propyl, butyl, or phenyl groups all of which are optionally substituted;

—COR where R is a hydrogen, or an alkyl group or an aryl groups and more specifically where R is methyl, ethyl, propyl, butyl, or phenyl groups all of which groups are optionally substituted;

—CON(R)₂ where each R, independently of each other R, is a hydrogen or an alkyl group or an aryl group and more specifically where R is methyl, ethyl, propyl, butyl, or phenyl groups all of which groups are optionally substituted; R and R can form a ring which may contain one or more double bonds;

—OCON(R)₂ where each R, independently of each other R, is a hydrogen or an alkyl group or an aryl group and more specifically where R is methyl, ethyl, propyl, butyl, or phenyl groups all of which groups are optionally substituted; R and R can form a ring which may contain one or more double bonds;

—N(R)₂ where each R, independently of each other R, is an alkyl group, acyl group or an aryl group and more specifically where R is methyl, ethyl, propyl, butyl, or phenyl or acetyl groups all of which are optionally substituted; or R and R can form a ring which may contain one or more double bonds.

—SR, —SO₂R, or —SOR where R is an alkyl group or an aryl groups and more specifically where R is methyl, ethyl, propyl, butyl, phenyl groups all of which are optionally substituted; for —SR, R can be hydrogen;

—OCOOR where R is an alkyl group or an aryl groups; —SO₂N(R)₂ where R is a hydrogen, an alkyl group, or an aryl group and R and R can form a ring;

—OR where R is H, alkyl, aryl, or acyl; for example, R can be an acyl yielding —OCOR* where R* is a hydrogen or an alkyl group or an aryl group and more specifically where R* is methyl, ethyl, propyl, butyl, or phenyl groups all of which groups are optionally substituted.

As used herein, the term “alkylene” refers to a divalent radical derived from an alkyl group or as defined herein. Alkylene groups in some embodiments function as attaching and/or spacer groups in the present compositions. Compounds of the present invention include substituted and unsubstituted C₁-C₃₀ alkylene, C₁-C₁₂ alkylene and C₁-C₅ alkylene groups. The term “alkylene” includes cycloalkylene and non-cyclic alkylene groups.

As used herein, the term “cycloalkylene” refers to a divalent radical derived from a cycloalkyl group as defined herein. Cycloalkylene groups in some embodiments function as attaching and/or spacer groups in the present compositions. Compounds of the present invention include substituted and unsubstituted C₁-C₃₀ cycloalkenylene, C₁-C₁₂ cycloalkenylene and C₁-C₅ cycloalkenylene groups.

As used herein, the term “alkenylene” refers to a divalent radical derived from an alkenyl group as defined herein. Alkenylene groups in some embodiments function as attaching and/or spacer groups in the present compositions. Compounds of the present invention include substituted and unsubstituted C₁-C₂₀ alkenylene, C₁-C₁₂ alkenylene and C₁-C₅ alkenylene groups. The term “alkenylene” includes cycloalkenylene and non-cyclic alkenylene groups.

As used herein, the term “cycloalkenylene” refers to a divalent radical derived from a cylcoalkenyl group as defined herein. Cycloalkenylene groups in some embodiments function as attaching and/or spacer groups in the present compositions.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups, and methoxyphenyl groups, particularly 4-methoxyphenyl groups.

As used herein, the term “halo” refers to a halogen group such as a fluoro (—F), chloro (—Cl), bromo (—Br) or iodo (—I).

As to any of the above groups which contain one or more substituents, it is understood, that such groups do not contain any substitution or substitution patterns which are sterically impractical and/or synthetically non-feasible. In addition, the compounds of this invention include all stereochemical isomers arising from the substitution of these compounds.

### Fabrication of SLIPS Materials

A number of nanoporous PEI/PVDMA coatings (˜3.5 micrometers thick) were fabricated and then functionalized by reaction with n-decylamine to impart hydrophobic character. Silicon oil was infused for the model oil phase. The infused nanoporous films were subjected to a number of tests to demonstrate their capabilities and their ability to retain their desired characteristics (e.g., repeated bending and flexing, creasing, stretching, deep scratching, and surface abrasion). SLIPS fabricated by infusion of silicone oil may be stable and slippery when contacted with a broad range of chemically complex liquids (e.g., acidic and alkaline solutions, unfiltered lake water, serum-containing cell culture medium, seawater, and ketchup). Additional oils were also infused for comparison including canola, coconut, and olive oil.

One aspect of the invention provides an infusion of a thermotropic liquid crystal (an anisotropic oil) yielding SLIPS with sliding angles and velocities that depend critically upon the chemical compositions of contacting aqueous phases, revealing a novel “sliding” basis for the sensing and naked-eye detection of environmental analytes, including bacterial endotoxin, in aqueous media.

It is anticipated that these approaches will also be useful for the design of advanced and multifunctional anti-fouling surfaces that provide control over the avoidance, manipulation, transport, collection, and detection of aqueous fluids in fundamental and applied contexts. These results provide new principles and expand the range of tools that can be used to manipulate the properties and behaviors of liquid-infused anti-fouling surfaces and open the door to new potential applications of this emerging class of slippery soft materials.

It is to be understood that this invention is not limited to only the specific methodology, protocols, subjects, or reagents described, and as such may vary. It is also to be understood that the terminology used herein is for the purpose of describing particular embodiments only, and is not intended to limit the scope of the present invention, which is limited only by the claims. The following examples are offered to illustrate, but not to limit the claimed invention.

### Example 1—Fabrication Using Dip Coating

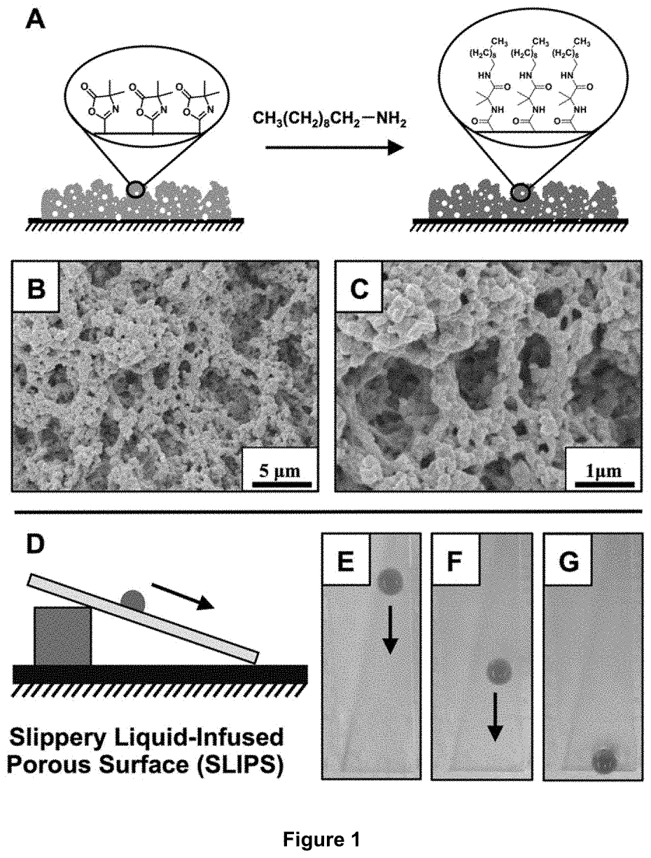

In an embodiment, azlactone-functionalized multilayers are fabricated using poly(vinyl-4,4-dimethylazlactone) (PVDMA) and branched poly(ethyleneimine) (PEI) to generally explore the feasibility of these polymers, for several reasons: i) PEI/PVDMA multilayers are covalently cross-linked and, thus, chemically robust and physically durable, ii) residual azlactone functionality in these coatings can be used to tune surface and bulk wetting behaviors by treatment with strategically-selected amine functionalized molecules (e.g., FIG. 1 (A)), and iii) they can be fabricated with micro- and nanoporous morphologies containing voids and other features (FIGS. 1 (B) and (C)) that can trap and host secondary liquid phases (Buck et al., Adv. Mater. (2007), 19:3951; Manna et al., Adv. Funct. Mater. (2015), 25:1672; Manna et al., Adv. Mater. (2013), 25:5104; Manna et al., Adv. Mater. (2012), 24:4291; and Buck et al., Chem. Mater. (2010), 22:6319). Multilayer films having the same or similar properties to these films can be fabricated using the spray-based methods described herein.

For the studies described in this example, nanoporous PEI/PVDMA coatings≈3.5±0.9 μm-thick were used and functionalized by reaction with n-decylamine (FIG. 1 (A)) to impart hydrophobic character; and silicon oil was used as a model oil phase. Infusion of oil into porous multilayers fabricated on planar glass yielded stable oil-infused SLIPS that allowed droplets of aqueous solutions to slide off unimpeded (see FIG. 1 (D)). FIG. 1 (E)-(G) shows top-down views of an aqueous droplet of tetramethylrhodamine (TMR) (10 μL) placed at the upper end of a slippery surface tilted at ≈10°; the droplet was observed to slide down the surface at a rate of 2.9 mm s⁻¹. Droplets of this size also slid down these surfaces at angles as low as 1° (albeit more slowly, at a rate of 0.133 mm s⁻¹).

### Example 2—Fabrication of SLIPS Using Dip Coating

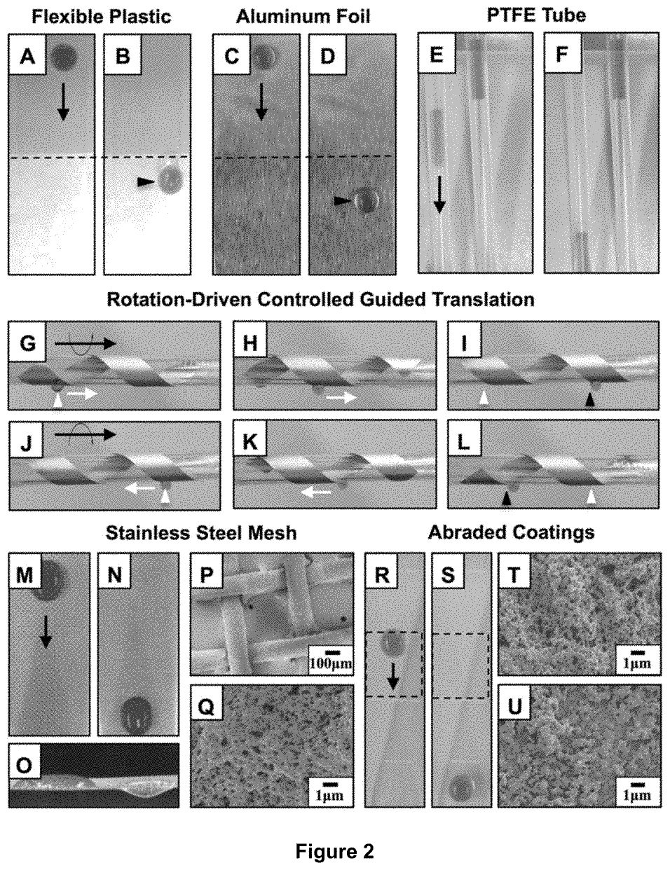

This reactive layer-by-layer approach described in Example 1 is well suited for fabrication of SLIPS on surfaces of arbitrary shape and composition. FIG. 2 (A)-(D) shows top-down images of droplets of aqueous TMR sliding on flexible plastic film (A,B) and aluminum foil (C,D) coated with oil-infused PEI/PVDMA multilayers (dotted lines show borders between SLIPS-coated (top) and uncoated (bottom) regions; droplets slid freely at angles of ≈10° on coated regions (A,C), and came to rest upon contact with uncoated regions (B,D)).

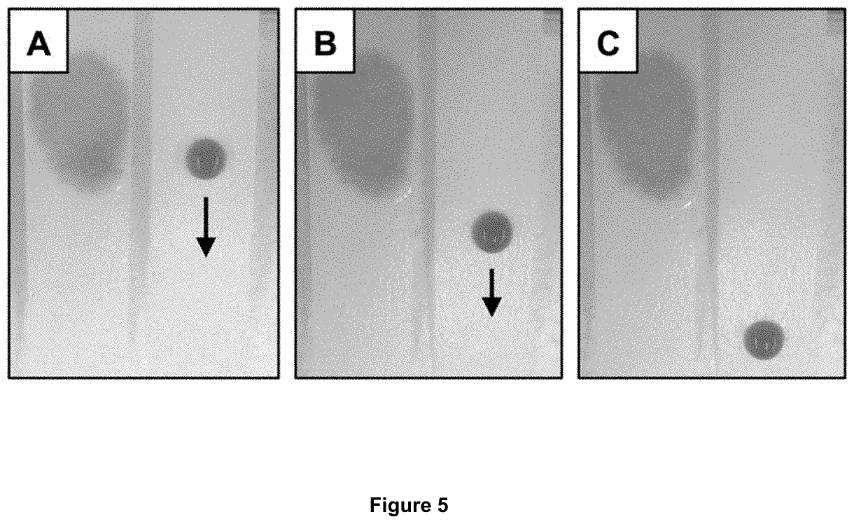

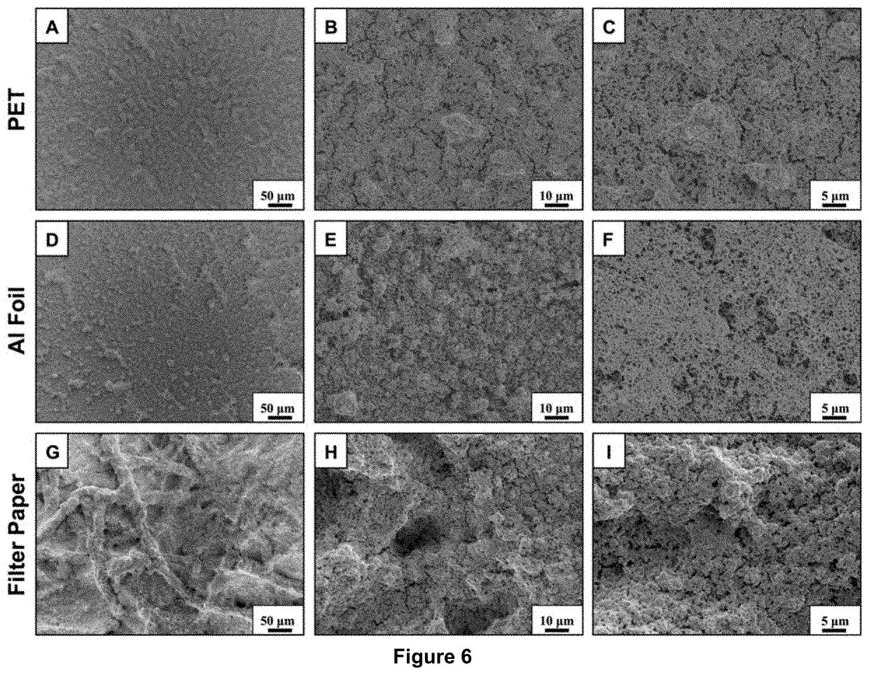

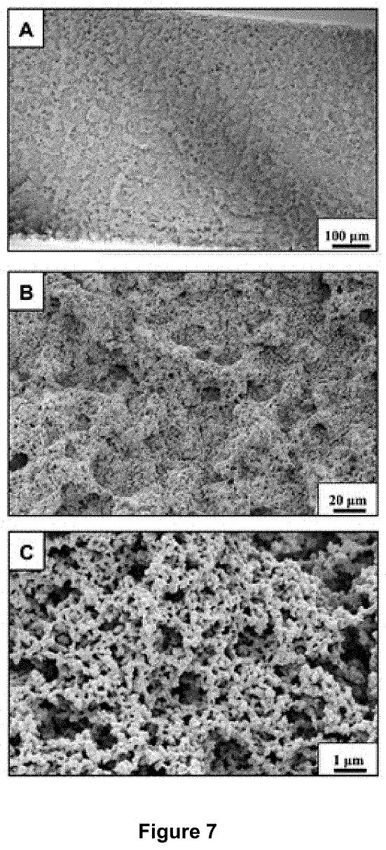

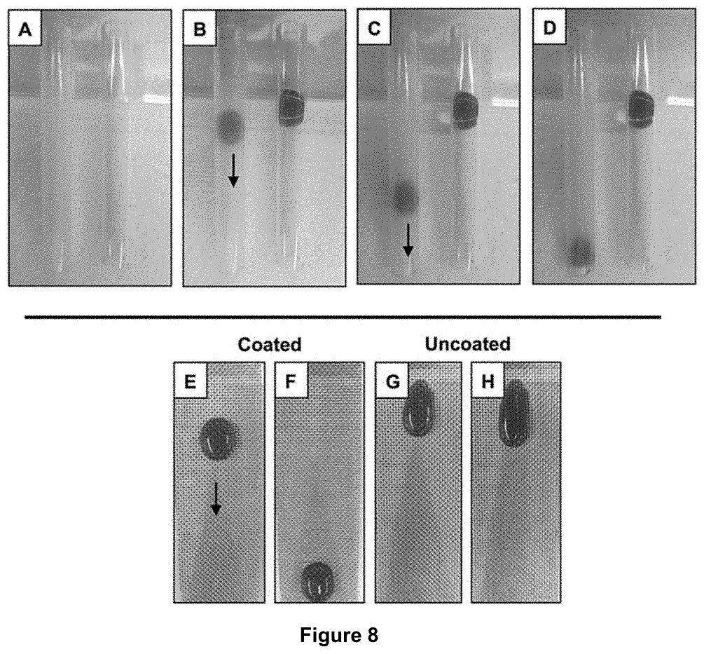

FIGS. 5 and 6 show images of droplets sliding on SLIPS-coated filter paper and scanning electron microscopy (SEM) images of the multilayers in FIG. 2 (A)-(D) prior to oil infusion. This approach can also be used to fabricate SLIPS on the inner (luminal) surfaces of tubes. FIG. 7 shows SEM images of multilayers coated on the insides of flexible poly(tetrafluoroethylene) (PTFE) tubing (inner diameter=1.15 mm). FIGS. 2 (E) and (F) (left side of each panel) shows drops of aqueous TMR (20 μL) placed in the tubes after infusion of oil (droplets in uncoated PTFE tubes are shown at the right of each panel). These images reveal plugs of aqueous fluid (θ≈100°) to slip rapidly through the coated tubes at tilt angles as low as 3° (in contrast, fluid in uncoated tubes remained stationary, even at tilt angles of 90°; FIG. 8 shows similar experiments using SLIPS-coated glass tubes. Finally, panels (M) and (N) of FIG. 2 show a droplet of aqueous TMR on stainless-steel wire mesh coated with oil-infused multilayers. Droplets also slipped and slid readily on these topologically complex substrates (at angles as low as 3°; droplets on uncoated mesh shown in FIG. 8). The results suggest these SLIPS to be coated uniformly on the wires comprising the mesh; SEM images prior to oil infusion (FIGS. 2 (P) and (Q)) provide support for this conclusion.

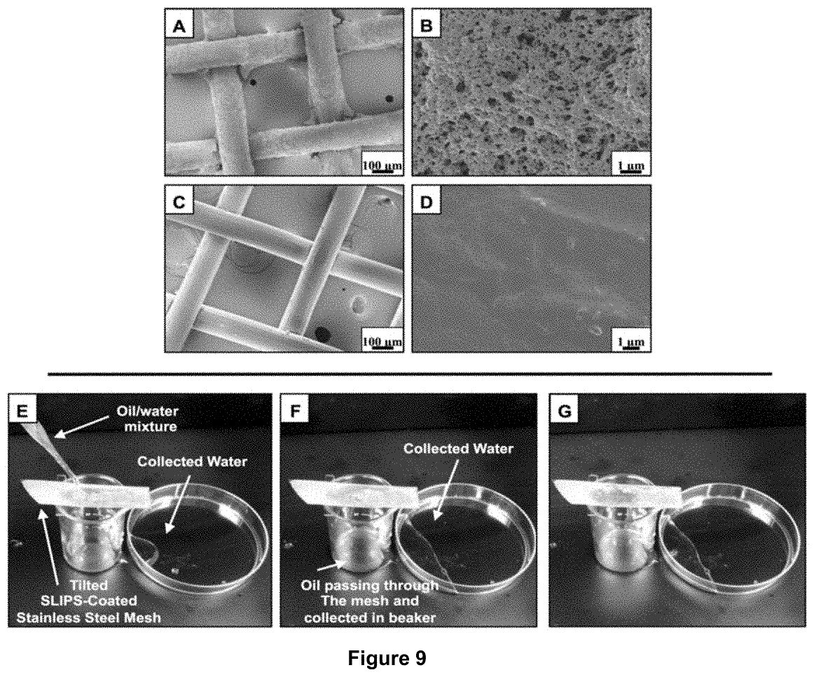

Multilayer-coated mesh infused with motor oil (rather than silicone oil) were also slippery and impermeable to water, but allowed motor oil to pass through unimpeded (FIG. 2 (O)), providing principles useful for the gravity-driven separation of oil/water mixtures using slippery surfaces (see FIG. 9).

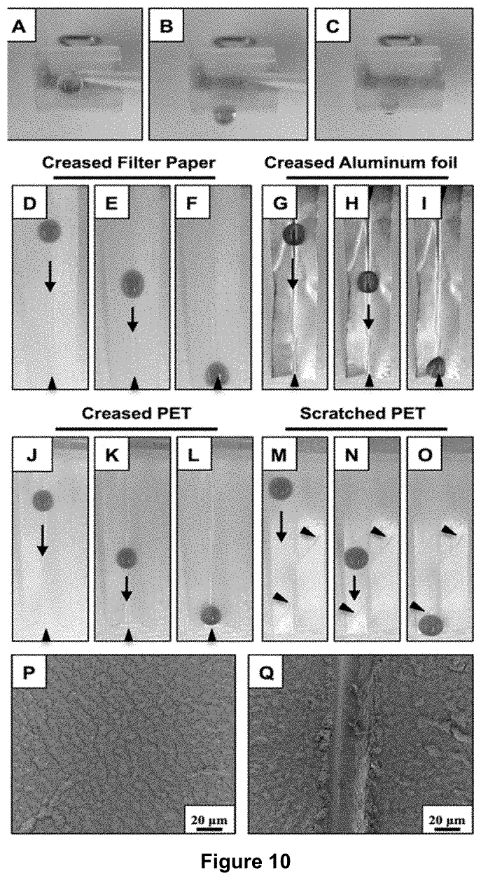

The physically robust nature of PEI/PVDMA multilayers (Manna et al., Adv. Mater. (2012), 24:4291; and Manna et al., Adv. Mater. (2013), 25:5104) allowed the oil-infused SLIPS described above to maintain slippery properties upon repeated bending and flexing, permanent creasing, and deep scratching (FIG. 10) (Yao et al., Nat. Mater. (2013), 12:529; Wei et al., Adv. Mater. (2014), 26:7358; and Vogel et al., Nat. Commun. (2013), 4:2176). This feature also permitted SLIPS to be cut into arbitrary shapes and transferred to other complex surfaces to endow them with slippery properties (e.g., as demonstrated in FIG. 2 (G)), which shows a strip of SLIPS-coated aluminum foil wrapped on a glass tube; in this proof-of-concept demonstration, transfer of a slippery “track” permits facile rotation-driven control over the transfer of aqueous drops; FIG. 2 (G)-(L)). The images in FIG. 2 (G)-(L) demonstrate how the approach of the present invention can be used to control the lateral transfer of aqueous droplets: a droplet placed at one end can be guided left and right along the slippery track by rotation of the tube clockwise or anti-clockwise.

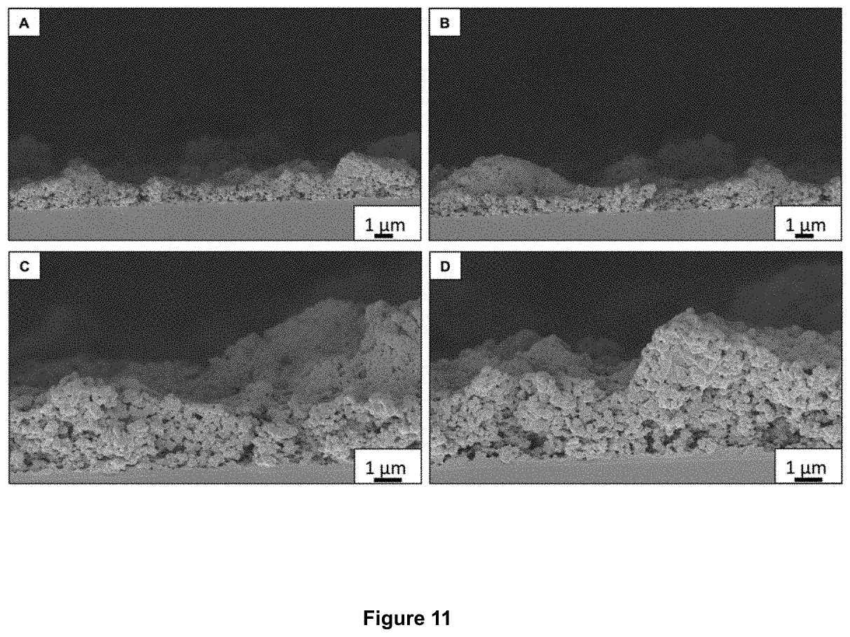

Further, because the hydrophobic nature of nanoporous PEI/PVDMA multilayers extends throughout the bulk of the films (FIG. 11), these SLIPS are also able to withstand other forms of severe physical abuse without loss of slippery properties. FIGS. 2 (R) and (S) show a SLIPS-coated surface that was severely abraded by aggressively rubbing the surface with abrasive sand paper (resulting in substantial loss of both oil and porous coating by visual inspection). The dotted boxes in FIGS. 2 (R) and (S) show the location of the abraded region; when combined, these images reveal the coatings to remain slippery despite removal of large amounts of the oil-infused matrix. SEM characterization after leaching of infused oil (FIG. 2 (U)) revealed abrasion to unmask underlying layers of porous material with a morphology similar to that of the original matrix (FIG. 2 (T)) that is sufficient to maintain and host a thin layer of infused oil after severe surface erosion. Finally, the slippery properties of these materials remained unaltered after other physical and chemical insults experienced during repeated freezing and thawing, immersion in boiling water, and exposure to steam-sterilization cycles in an autoclave.

### Example 3—SLIPS Fabricated Using Dip Coating

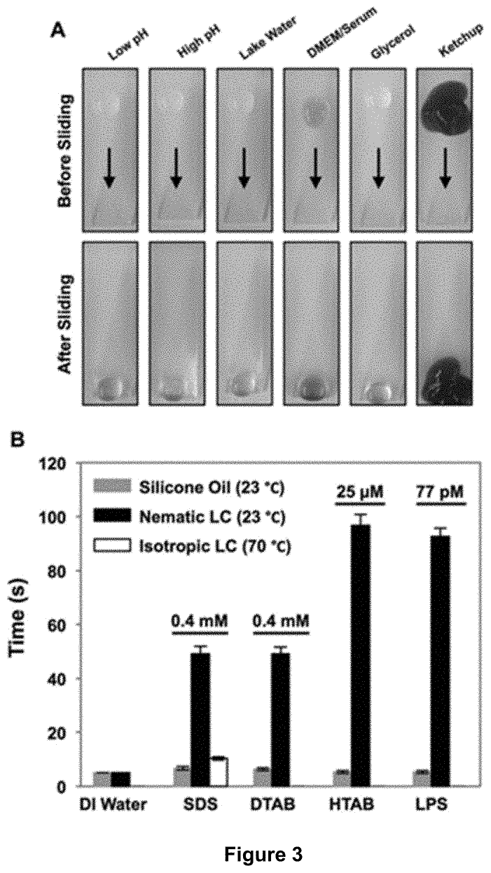

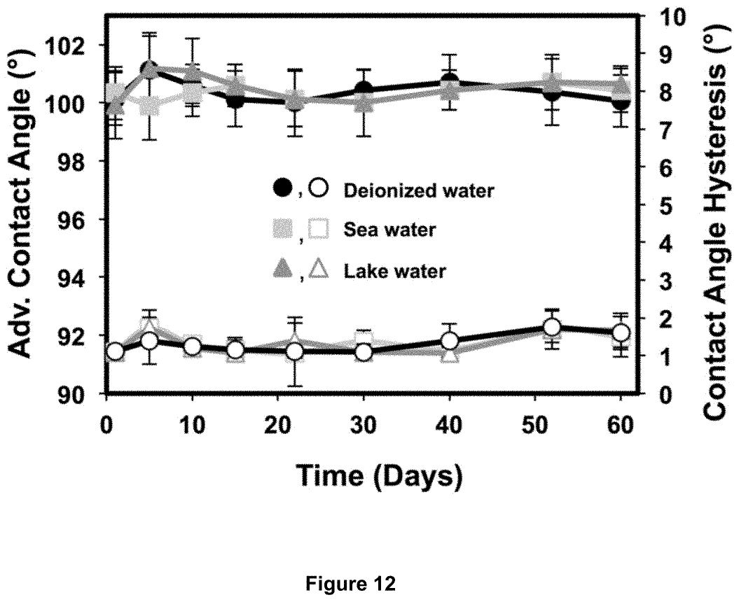

SLIPS fabricated by infusion of silicone oil were stable and slippery when contacted with a broad range of chemically complex liquids (including acidic and alkaline solutions, unfiltered eutrophic lake water, serum-containing cell culture medium, and ketchup; FIG. 3 (A)), and slippery properties were maintained upon incubation in simulated seawater for at least 2 months (FIG. 12). Infusion of other natural and biocompatible oils into these porous coatings yielded surfaces that were slippery to a similar range of liquid media, but afforded additional control over oil adhesiveness and droplet sliding. Table 1 (below) shows contact angle hysteresis and sliding velocities for droplets of water placed on multilayers (tilted at 10°) infused with silicone, canola, coconut, or olive oils. Hysteresis increased monotonically across this series, and sliding velocities decreased substantially with an increase in hysteresis (e.g., from 6 mm s⁻¹ for silicone oil to ≈110 μm s⁻¹ for droplets on films infused with olive oil). Past studies have demonstrated that the velocities of liquid droplets on SLIPS can be manipulated by changing the viscosity of the infused lubricant (with low viscosity liquids resulting in higher velocities) (Daniel et al., Appl. Phys. Lett. (2013), 102:231601). The viscosities of the oils used here, however, vary over a much smaller range (from 40 to 100 cps) than those used in past studies (from 1 to 2500 cps), and the sliding velocities in Table 1 do not vary monotonically with these small changes.

TABLE 1
Influence of infused oils on SLIPS

| Infused | | | Velocity |
|---|---|---|---|
| Lubricant | θ_{Adv} (°) | θ_{Hyst} (°) | (mm/s) |
| Silicone oil | 101.2 ± 1.3 | 2.1 ± 1.1 | 6.0 ± 0 |
| Canola oil | 89.4 ± 1.1 | 5.3 ± 1.5 | 3.4 ± 0.4 |
| Coconut oil | 82.7 ± 0.9 | 10.2 ± 1.5 | 0.23 ± 0.01 |
| Olive oil | 81.3 ± 1.2 | 13.5 ± 2.1 | 0.11 ± 0.01 |

Table 1 shows wetting behaviors (advancing contact angles and contact angle hysteresis) and sliding velocities of droplets of water (20 μL) on multilayers infused with silicone, canola, coconut, and olive oils (tilt angle≈10°).

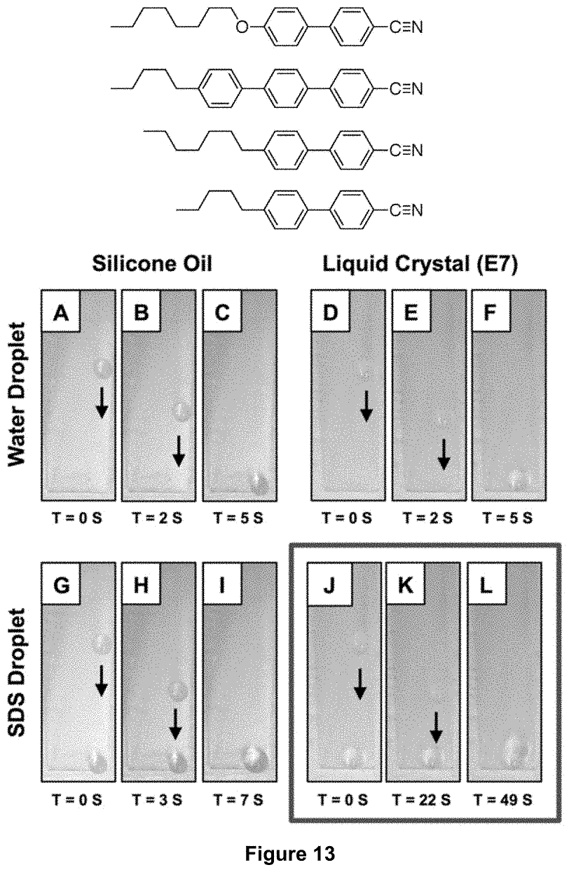

The results of additional experiments using multilayers infused with a thermotropic liquid crystal (LC; an anisotropic oil) revealed additional principles useful for control over the mobility of aqueous droplets on SLIPS-coated surfaces. The results in FIG. 3, panel (B) show the times required for 10 μL droplets of either deionized (DI) water or water containing one of four different amphiphiles [sodium dodecyl sulfate (SDS), dodecyltrimethylammonium bromide (DTAB), hexadecyltrimethylammonium bromide (HTAB), or bacterial endotoxin (lipopolysaccharide, LPS)] to slide 2.0 cm down multilayer-coated surfaces infused with either: i) silicone oil (gray bars) or ii) the small molecule nematic liquid crystal E7 (black bars; at tilt angles of 13°; the structure of E7 is shown in FIG. 13). At ambient temperature (23° C.), droplets of DI water traversed this distance in ≈5 s on both types of slippery surfaces (FIG. 13 shows images of the sliding droplets in these experiments). These results reveal that droplets containing SDS (at 0.4×10⁻³ M) require ≈7 s to slide this distance on films infused with silicon oil (gray; similar to results exhibited by DI water). Further inspection, however, reveals droplets containing 0.4×10⁻³ M SDS to slide≈10 times more slowly on E7-infused surfaces (black; over ≈49 s).

It is well known that amphiphiles with long hydrophobic tails can interact with LCs at aqueous/LC interfaces and promote orientational changes in the ordering of the LC (e.g., from planar to homeotropic anchoring) (Brake et al., Science (2003), 302:2094; and Bai et al., Langmuir (2011), 27:5719). It is speculated that differences in the sliding velocities of SDS-containing droplets on E7-infused surfaces arise from the anisotropic nature of the LC and transient changes in LC orientation beneath the droplets that lead to changes in droplet adhesion (droplets of DI water placed on surfaces previously exposed to aqueous SDS also slid rapidly (≈5 s), suggesting that any changes promoted by interactions with SDS-containing droplets are transient). The results of experiments using E7-infused SLIPS maintained at 70° C. (well above the nematic/isotropic transition temperature (≈60° C.) of E7) provide additional support for this hypothesis. As shown in FIG. 3 (B) (white bar), droplets of aqueous SDS (at 0.4×10⁻³ M) slid down surfaces infused with isotropic LC over a period of ≈10 s, a time significantly shorter than that observed on surfaces infused with LC in the nematic phase (≈49 s) and similar to that observed for SDS-containing droplets on surfaces infused with silicone oil.

The results of additional experiments reveal that the sensitivity of droplet mobility to the presence of SDS also extends to the presence of other amphiphiles. For example, 10 μL droplets containing 0.4×10⁻³ M DTAB (a cationic surfactant with a tail length identical to that of SDS) were observed to exhibit sliding times similar to those of droplets containing SDS s; FIG. 3 (B)). Experiments using droplets containing HTAB, a cationic surfactant with a tail length four carbons longer than that of DTAB, demonstrated that manipulation of both surfactant tail length and concentration can also be used to manipulate sliding behaviors. Droplets containing 0.4×10⁻³ M HTAB, for example, did not slide down LC-infused surfaces at tilt angles of 13° (not shown). However, droplets containing 25×10⁻⁶ M HTAB slid down these surfaces over a period of ≈96 s (FIG. 3 (B); a time that is significantly longer than that required for droplets of DTAB, at a concentration 16 times higher (0.4×10⁻³ M), to slide the same distance). These results are consistent with the view that interactions between the amphiphile and the LC play an important role in governing sliding behaviors.

These results also demonstrate that these LC-infused surfaces can be used to report the presence of bacterial endotoxin, a highly toxic polysaccharide-based amphiphile, in aqueous droplets (Lin et al., Science (2011), 332:1297). As shown in FIG. 3 (B), droplets containing very low concentrations of LPS (77×10⁻¹² M) slid down E7-infused surfaces over ≈93 s, a time substantially longer than that exhibited by droplets of DI water. Overall, this sensitivity of mobility to droplet compositions provides new opportunities to tune droplet behaviors (e.g., by manipulation of surfactant structure or concentration) and provides a basis for the sensing and naked-eye detection of aqueous analytes using slippery surfaces (e.g., by characterizing changes in droplet sliding velocities as a function of analyte concentration). The use of this “sliding” platform can therefore be used to qualitatively or quantitatively detect the presence of environmental analytes and toxins. These results using LC-infused SLIPS also provide opportunities to design slippery surfaces that could permit active and external control over droplet adhesion and mobility.

### Example 4—Functionalization of Multilayer Films Fabricated Using Dip Coating

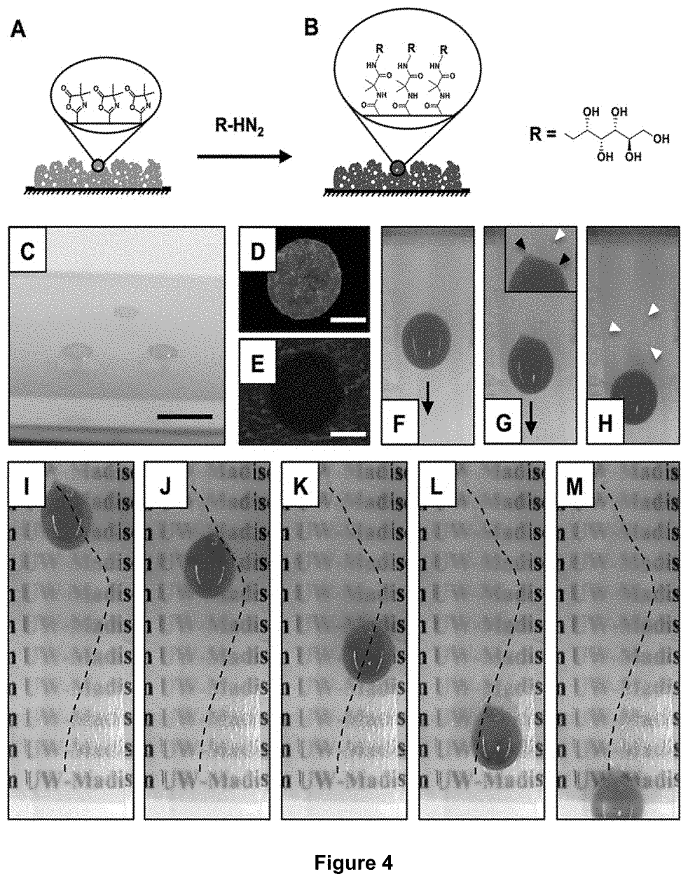

Finally, the chemical reactivity of the multilayers described herein can be used to functionalize and spatially pattern the surfaces and the bulk of these coatings with a variety of functionality—ranging from hydrophobic, as demonstrated above (FIG. 1 (A)), to highly hydrophilic—by treatment with strategically selected primary amines (Manna et al., Adv. Funct. Mater. (2015), 25:1672; and Manna et al., Adv. Mater. (2012), 24:4291). This feature can be exploited to design SLIPS with patterned features that exclude infused oils and, as a result, create “sticky” patches (or “STICKS”) that are wet by aqueous media. To demonstrate proof-of-concept, a porous multilayers spatially patterned was used by treatment with small aqueous droplets containing the hydrophilic molecule D-glucamine (FIGS. 4 (A) and (B); azlactone groups in surrounding areas were then functionalized with decylamine prior to infusion with oil). FIG. 4 (C) shows a SLIPS-coated surface patterned with three sticky patches after immersion and removal from an aqueous solution of the fluorophore fluorescein. This image reveals the patterned “STICKS” to capture aliquots of aqueous solution, and that patterning does not compromise the slippery character of the surrounding surface. Experiments using patterned SLIPS infused with silicone oil containing Nile red dye revealed the patterned regions to be devoid of oil (FIG. 4 (E); as determined by fluorescence microscopy) and that the capture of aqueous fluid was confined strictly to the patterned patches (FIG. 4 (D)).

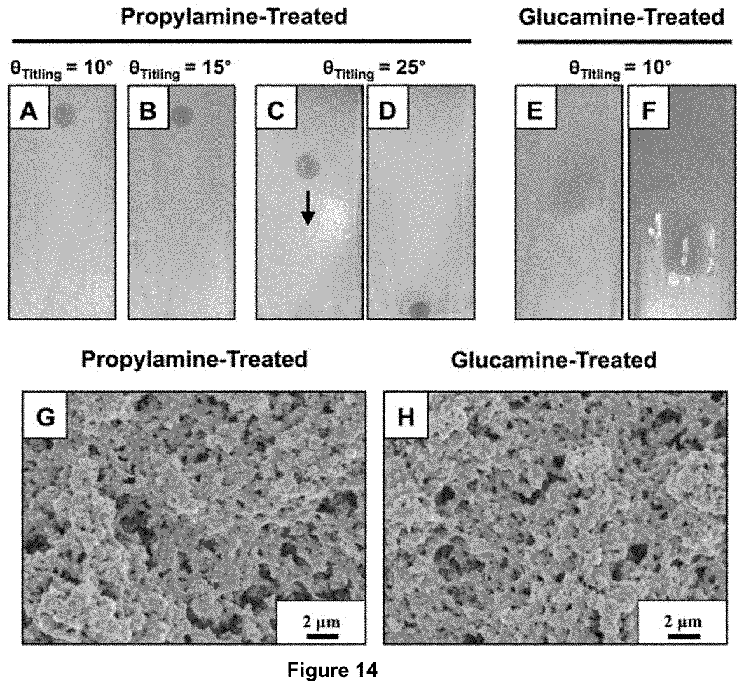

Control over the “stickiness” of SLIPS-coated surfaces can also be achieved by functionalizing PEI/PVDMA multilayers with hydrophobic n-alkanes shorter and less hydrophobic than n-decylamine. For example, infusion of silicon oil into films functionalized with n-propylamine resulted in SLIPS with higher contact angle hysteresis (≈20°) and, thus, significantly larger critical sliding angles relative to SLIPS designed using decylamine-functionalized multilayers (see FIG. 14). Control over the sizes, numbers, and relative locations of sticky patches on patterned SLIPS provided opportunities to capture samples of aqueous fluids from sliding droplets (FIG. 4 (F)-(H)), temporarily halt or completely arrest the motion of sliding droplets, and promote the transfer and mixing of fluids from multiple different sliding droplets. Provided that droplets are sufficiently large compared with the spacing between sticky patches, this approach can also be used to control the velocities and guide the in-plane trajectories of aqueous droplets as they slide along planar surfaces (e.g., along prescribed, non-linear sticky-patch paths; FIG. 4 (I)-(M)).

The work reported here addresses challenges related to the fabrication and chemical functionalization of SLIPS on complex surfaces, and provides tools for tuning interfacial properties and manipulating the behaviors of fluids in contact with this emerging class of soft materials.

### Example 5—Methods and Materials for Above Examples

The following section describes the materials and procedures used in the above examples. While the SLIPS described in Examples 2-4 were made using dip coating, SLIPS having the same or similar properties can be fabricated using the spray-based methods as described herein.

Materials. 2-Vinyl-4,4-dimethylazlactone (VDMA) was a gift from 3M Corporation, Minneapolis, Minn. Poly(2-vinyl-4,4-dimethylazlactone) (PVDMA) was synthesized by free-radical polymerization of VDMA as described previously (Buck et al., Chem. Mater., 2010, 22:6319).

Branched poly(ethylene imine) (BPEI; MW ˜25,000), propylamine, ndecylamine (95%), acetone (H PLC grade), tetrahydrofuran (THF, HPLC grade), sodium dodecyl sulfate (SDS), dodecyltrimethylammonium bromide (DTAB), hexadecyltrimethylammonium bromide (HTAB), lipopolysaccharide from E. coli 0127:B8 (LPS), dichloroethane (DCE), carbon tetrachloride (CCl4), dibromomethane (CH2Br2), magnesium sulfate, calcium chloride, and silicone oil were purchased from Sigma Aldrich (Milwaukee, Wis.). D-Glucamine (>95%) was purchased from TCI America (Portland, Oreg.). Tomato ketchup was obtained from the H. J. Heinz Company (Pittsburgh, Pa.). Glycerol was purchased from Fisher Chemicals (New Jersey, USA). Glass microscope slides were purchased from Fischer Scientific (Pittsburgh, Pa.). Thin sheets of poly(ethylene terephthalate) film (PET; 0.004 in. thick) were purchased from McMaster Carr. Stainless steel wire meshes were obtained from MSC Industrial Supply Co. (Melville, N.Y.). Aluminum foil was obtained from Reynolds Consumer Products, LLC (Richmond, Va.). Filter paper was obtained from Whatman (Maidstone, England). The thermotropic liquid crystal E7 was purchased from Licristal, Japan. Sodium chloride (NaCl) and magnesium chloride (MgCl2) were obtained from Fisher Scientific. Coconut oil was obtained from Nihar Naturals, India and canola oil was obtained from Kirkland, Canada and olive oil was obtained from Filippo Berio (Italy). All chemicals were used as received without further purification unless otherwise noted.

General Considerations. Compressed air used to dry samples was filtered through a 0.2 μm membrane syringe filter. Scanning electron micrographs were acquired using a LEO 1530 scanning electron microscope at an accelerating voltage of 3 kV. Samples were coated with a thin layer of gold using a gold sputterer operating at 45 mA under a vacuum pressure of 50 mTorr for 40 s prior to imaging. Measurements of film thickness were made by characterizing the cross-sections of films using SEM. Cross-sectional images were acquired at several different locations (typically 4) across the edge of a film, and 25 individual measurements of thickness were made across each edge; values of film thickness are presented as an average (with standard deviation) of these 100 measurements. Digital pictures were acquired using a Canon PowerShot SX130 IS digital camera. Contact angles were measured using a Dataphysics OCA 15 Plus contact angle goniometer at ambient temperature with 10 μL of deionized water. Artificial seawater was prepared by mixing 26.73 g of NaCl, 2.26 g of MgCl2, 3.25 g of MgSO₄, and 1.12 g of CaCl₂) in 1.0 L of deionized water. Unless otherwise noted, all experiments were conducted at ambient room temperature (˜23° C.). Experiments to characterize the behaviors of aqueous droplets on LC-infused surfaces at 70° C. were performed by pre-heating a hot plate (tilted at an angle of 13°) to 70° C., placing SLIPS-coated glass substrates in contact with the surface of the hot plate, and allowing the temperature of the coated substrate to equilibrate for 1 hour.

Covalent Layer-by-Layer Fabrication of Porous Polymer Multilayers.

PEI/PVDMA multilayers were deposited on glass substrates using the following general procedure: (i) substrates were submerged in a solution of BPEI (20 mM in acetone with respect to the polymer repeat unit) for 20 s; (ii) substrates were removed and immersed in an initial acetone bath for 20 s followed by a second acetone bath for 20 s; (iii) substrates were submerged in a solution of PVDMA (20 mM in acetone with respect to the polymer repeat unit) for 20 s; and (iv) substrates were removed and rinsed again using the procedure outlined under step (ii). This cycle was repeated 35 times to fabricate porous polymer multilayers consisting of 35 BPEI/PVDMA layer pairs (or ‘bilayers’). The concentrations of the polymer solutions were maintained by addition of acetone as needed to compensate for solvent evaporation after every dipping cycle. All other substrates used in this study (glass tubes, aluminum foil, PET film, PTFE tubes, wire meshes, and filter paper) were also coated using this protocol. Multilayers were characterized and used in subsequent experiments immediately or dried under a stream of filtered, compressed air and stored in a vacuum desiccator until use. All films were fabricated at ambient room temperature.

Chemical Functionalization of Porous Polymer Multilayers. Porous polymer multilayers containing unreacted azlactone groups were functionalized by treatment with various hydrophobic (decylamine or propylamine) and hydrophilic (glucamine) primary amine-containing small molecules. Solutions of decylamine and propylamine (20 nmM) were prepared in THF, and solutions of glucamine (20 mM) were prepared in either DMSO or PBS buffer. Amine-reactive multilayers were then immersed in these solutions at room temperature for two hours to install hydrophobic or hydrophilic functionality over large areas (Manna et al., Adv. Mater., 2012, 24:4291). Functionalized films were then rinsed with THF or DMSO and acetone and dried with filtered air.

Infusion of Oils into Porous Polymer Multilayers. Hydrophobic multilayers (5 cm×1 cm) were infused with lubricating liquids (silicone oil, canola oil, olive oil, coconut oil, motor oil, or the thermotropic liquid crystal E7) using the following general protocol. A droplet of 5 μL of oil was placed onto the film and spread over the surface using weighing paper. After two minutes, excess oil was removed from the surface by soaking it into weighing paper.

Characterization of Physical and Chemical Robustness of Liquid-Infused Coatings. All tests used to characterize the integrity of liquid-infused multilayers after exposure to physical abuse and chemically harsh conditions were performed using decylamine-treated multilayers. For experiments to characterize the influence of scratching on slippery properties, syringe needles were dragged manually across the surfaces of oil-infused coatings to create full-thickness scratches. For experiments to characterize the stability of slippery coatings upon exposure to rapidly flowing water, oil-infused coatings were exposed to a stream of water having a flow rate of 100 mL/s for 15 min. For experiments to characterize the influence of immersion in aqueous environments on stability, oil-infused films were immersed in water, 1.0 M NaCl solutions, artificial seawater, and samples of locally-sourced lake eutrophic water (Lake Mendota, Madison, Wis.) for two months; film properties were characterized at regular time intervals. The influence of freezing was characterized by placing a glass slide coated in oil-infused multilayers in deionized water and placing the whole system in a freezer for six hours; the resulting block of ice was thawed to room temperature and the interfacial properties of the oil-infused films (e.g., water sliding angles) were characterized; freezing/thawing/characterization cycles were performed 10 times. Substrates exposed to steam were autoclaved for 45 minutes at 121° C. using an Allen-Bradley Panel View Plus 600 System. Bending and creasing of slippery, liquid-infused multilayers fabricated on soft and flexible substrates (PET) was accomplished manually by repeatedly bending (˜50 times) and then finally permanently creasing the substrates using moderate pressure.

Separation of Oil/Water Mixtures using Porous Meshes Coated with Liquid-Infused Multilayers. Stainless steel wire meshes (1.5 cm×4 cm; wire diameter ˜90 μm; pore size=126.3±3.5 μm) coated with decylamine-functionalized multilayers were infused with conventional automotive motor oil, placed over the open mouth of a laboratory beaker, and maintained at a tilted angle of ˜2° with respect to the mouth of the beaker by supporting one side of the mesh using a glass chip (see FIG. 9 (E). A mixture (3:2, v/v) of motor oil and water (or other aqueous fluids) was then poured onto the coated mesh. Oil that passed through the mesh was collected in the beaker; water was observed to slip off of the surface of the oil-infused mesh, and was collected in a secondary container (see FIGS. 9 (F) and (G)).

Selective and Guided Transfer of Water on Slippery, Oil-Infused Multilayers Patterned with Hydrophilic Patches. Reactive porous polymer multilayers, fabricated as described above, were patterned with small hydrophilic domains by placing droplets of aqueous solutions of glucamine (e.g., 0.5 μL of a 20 mg/mL glucamine solution in PBS buffer, adjusted to pH 9.0) for 10 minutes, as previously described (Manna et al., Adv. Mater., 2012, 24:4291). These chemically patterned samples were then immersed in n-decylamine using the procedure described above to react with remaining azlactone functionality and render the remainder of the surrounding regions of the films hydrophobic. To characterize the fidelity of patterning and the behavior of liquid lubricants in the hydrophilic glucamine-patterned regions after oil infusion, samples were infused with silicon oil containing Nile red (an oil-soluble, water immiscible dye). The oil infused patterned substrate was then submerged in an aqueous solution of fluorescein (20 μg/mL) for several seconds and removed. Visual inspection and fluorescence microscopy were then used to characterize the locations of red (Nile red) and green (fluorescein) signal in the hydrophobic and hydrophilic patterned regions of the films. Experiments to investigate (i) the ability of patterned spots to capture samples of sliding aqueous droplets and (ii) the ability of networks or ‘tracks’ of multiple small hydrophilic spots to guide the gravity-driven transfer of larger water droplets were conducted using 55 μL droplets of an aqueous TMR solution and chemically patterned substrates maintained at an inclination angle of 5°.

### Example 6—Functionalization of Azlactone-Containing Polymer Multilayers

As described above, polymers bearing amine-reactive azlactone functionality can be used to drive reactive layer-by-layer assembly with polymers that contain primary amines. Azlactones react rapidly, through ring-opening reactions, with primary amines under mild conditions (Buck et al., Polymer Chemistry (2012), 3 (1):66; and Heilmann et al. Journal of Polymer Science, Part A: Polymer Chemistry (2001), 39 (21): 3655), leading to unique and stable amide/amide-type crosslinks between polymer chains. Residual azlactone functionality in resulting PEI/PVDMA multilayers can be used as reactive handles for further functionalization by treatment with any of a broad range of readily available amine-based nucleophiles to impart a new surface and bulk properties, such as hydrophobicity of the multilayer or interaction with an oils as part of SLIPS, through the creation of unique and chemically stable amide/amide-type bonds.

Additionally, the surface and bulk properties of azlactone-containing materials can also be altered using other classes of non-amine-based nucleophiles (see Scheme 1). For example, azlactone groups are understood to react with primary alcohols and thiols under certain conditions such as in the presence of a catalyst and at higher temperatures (Heilmann et al. Journal of Polymer Science, Part A: Polymer Chemistry (2001), 39 (21): 3655; Schmitt et al., Adv. Healthcare Mater. (2015), 4(10):1555; Schmitt et al., Biomacromolecules (2016), 17(3):1040; Heilmann et al., J. Polym. Sci., Polym. Chem. Ed. (1984), 22 (5):1179; Rasmussen et al., Makromol. Chem. Rapid Commun. (1984), 5 (2):67; Heilmann et al., Tetrahedron (1998), 54(40):12151; and Pereira et al., Tetrahedron (2014), 70(20):3271).

The use of these nucleophiles to design new materials is far less developed than approaches that exploit the reactivity of azlactones with more nucleophilic primary amines. Strategies for the rapid and robust functionalization of azlactone groups in polymer assemblies using primary alcohols and thiols could be broadly useful in at least two ways. First, such methods would substantially increase the pool of commercially or readily available molecules that is available for post-fabrication functionalization (and, thus, expand the range of new properties that could be imparted to azlactone-containing assemblies). Second, the reaction of azlactones with primary alcohols and thiols results in the formation of unique amide/ester- and amide/thioester-type bonds that, in contrast to the amide/amide bonds formed by reactions with primary amines, can be hydrolyzed under relatively mild conditions. Thus, a functionalized azlactone layer (not hydrolyzed) can be designed to be hydrophobic while the functionalized azlactone layer which has been hydrolyzed to break amide/ester- or amide/thioester-type bonds can be designed to be relatively hydrophilic.

Methods for the functionalization of surfaces and coatings using these labile and stimuli-responsive linkages thus provide new approaches to the design of surfaces with dynamic or stimuli-responsive properties.

Functionalization of azlactone-containing PEI/PVDMA multilayers using primary alcohol and thiol-containing nucleophiles is thus provided. Alcohol- or thiol-containing compounds can react uniformly and extensively with the residual azlactone functionality in these materials when an organic catalyst is used, and the properties of these compounds (e.g., whether they are hydrophobic or hydrophilic, etc.) can be used to dictate important interfacial properties and pattern useful surface features. It is further demonstrated that the amide/ester and amide/thioester groups that result from these new reactions can be cleaved under mild conditions, leading to dynamic and stimuli responsive materials that can undergo stimuli-responsive changes in hydrophobicity and interactions with oils. The post-fabrication conversion of installed thioester groups can also be used to create acylhydrazine functionality that can react through ‘click-like’ reactions with aldehydes (Xin et al., Polymer Chemistry (2012), 3(11):3045; and Kool et al., Journal of the American Chemical Society (2013), 135(47):17663) to anchor new surface features through acid-responsive imine bonds. These results expand the range of chemical functionality and new functions that can be imparted to azlactone-containing materials beyond those that can be attained by functionalization using primary amines. The strategies reported here, demonstrated using model polymer-based reactive multilayer coatings, can also prove useful for the design of new materials based on other types of azlactone-functionalized polymers, assemblies, and coatings.

Functionalization of Polymer Multilayers Using Amine, Alcohol, and Thiol-Containing Nucleophiles. PEI/PVDMA multilayers were fabricated on glass substrates using the general procedure described above. Films were then functionalized with nucleophiles using the following general procedure. Treatment with pyrenebutanol and pyrene (serving as a control) was performed by immersing a 10-bilayer film (0.9×1 cm) on a glass substrate in 1.5 mL of the desired fluorophore solution (40 mg/mL in DCE) in a glass vial, followed by the addition of 2 μL of DBU. The vial was capped, sealed with parafilm, and left on a shaker plate overnight at room temperature. Films were removed and rinsed copiously with DCE, and then placed in large vials containing fresh DCE rinse solution for several days in order to remove any non-specifically adsorbed fluorophore and the DBU catalyst. The rinse solution was changed several times each day. Films were finally rinsed with ˜25 mL each of DCM, methanol, water, and acetone, and then dried in a stream of compressed air.

Decanol and decanethiol treatments were performed in a similar manner by immersing films (˜0.9 cm×3 cm) in ˜4 mL of the desired nucleophile solution (1:1 wt/wt in DCE) in a glass vial followed by addition of 54 μL of DBU. The vial was capped, sealed with parafilm, and left on a shaker plate overnight. Films were rinsed copiously with DCE and then DCM before being placed in DCM rinse vials for several days, as above. Decylamine and hydrazine functionalization reactions were performed by immersing a film (˜0.9 cm×3 cm) in a ˜4 mL solution of either decylamine (20 mg/mL in THF) or anhydrous hydrazine (20 mg/mL in MeOH) overnight and then rinsing with THF or MeOH, respectively, and then acetone, before drying in a stream of compressed air.

Hydrolysis of Ester and Thioester Bonds in Functionalized Films. Experiments designed to characterize the hydrolysis of the ester bonds in multilayers functionalized using decanol were performed by placing small droplets of aqueous NaOH (0.05 M) onto the surface of a film and incubating it in a humid chamber for pre-determined periods of time. The NaOH droplet was rinsed from the surface of the film using Millipore water and then subsequently with acetone before drying in compressed air. To facilitate imaging, newly created hydrophilic spots on these films were loaded selectively with TMR by submersion of the entire film into an aqueous solution of the dye (˜0.05 mg/mL) for ˜2 seconds. To demonstrate the reactivity of thioester bonds in decanethiol treated films, samples (0.9×1 cm) were immersed in 1.5 mL of hydrazine solution (20 mg/mL in MeOH) at 50° C., removed at pre-determined time intervals, rinsed in MeOH and acetone, and then dried in compressed air prior to characterization.

Reversible Reactions of Imine Bonds in Hydrazine-Functionalized Multilayers. Films functionalized by treatment with hydrazine were treated with octylaldehyde (20 mg/mL in MeOH) for 1 hour at room temperature and then rinsed copiously with MeOH and acetone before being dried in a stream of compressed air. These superhydrophobic films were cut to desired sizes (1×1 cm) and immersed in 2 mL of a 1 M HCl solution (1:1 H₂O:THF, v/v) overnight at room temperature. The resulting hydrophilic films were then removed and rinsed copiously with THF, water, and acetone before being dried in a stream of compressed air for contact angle analysis. Experiments were also performed without HCl by placing films into solutions of 1:1 v/v H₂O:THF and removing after pre-determined periods of time. This process was repeated several times to characterize the reversibility of the imine bond formation/hydrolysis reaction.

Functionalization of Azlactone-Containing Multilayers Using Alcohol-Based Nucleophiles. The reactivity of the residual azlactone groups in PEI/PVDMA multilayers with primary alcohol-based nucleophiles was characterized. These initial experiments were conducted using PEI/PVDMA multilayers 10 bilayers (˜160 nm) thick and pyrenebutanol as a model fluorescent primary alcohol to facilitate characterization. Prior to experiments using azlactone-containing multilayers, studies were conducted using solutions of pyrenebutanol and PVDMA to identify reaction conditions that lead to efficient coupling. Past studies demonstrate that reactions between azlactones and alcohols do not occur substantially in the absence of a catalyst, but that these reactions can be promoted by catalytic amounts of trifluoroacetic acid or strong amidine bases such as 1,8-diazabicycloundec-7-ene (DBU) (Heilmann et al., Journal of Polymer Science, Part A: Polymer Chemistry (2001), 39(21): 3655; Pereira et al., Tetrahedron (2014), 70(20): 3271; and Sun et al., Journal of Controlled Release (2010), 148(1):91). DBU was selected as a catalyst for these studies because this approach is more general and because it can also be used to promote reactions between azlactones and thiols (trifluoroacetic acid can catalyze the addition of alcohols to azlactone groups, but does not promote reactions using thiols). The addition of pyrenebutanol to solutions of PVDMA in the presence of DBU (0.05 eq. pyrenebutanol, 0.1 eq. DBU with respect to pyrenebutanol) yielded random copolymers containing both reactive azlactone functionality and pyrenebutanol-based side chains attached to the backbone through amide/ester linkages, as characterized by ¹H NMR spectroscopy and gel permeation chromatography.

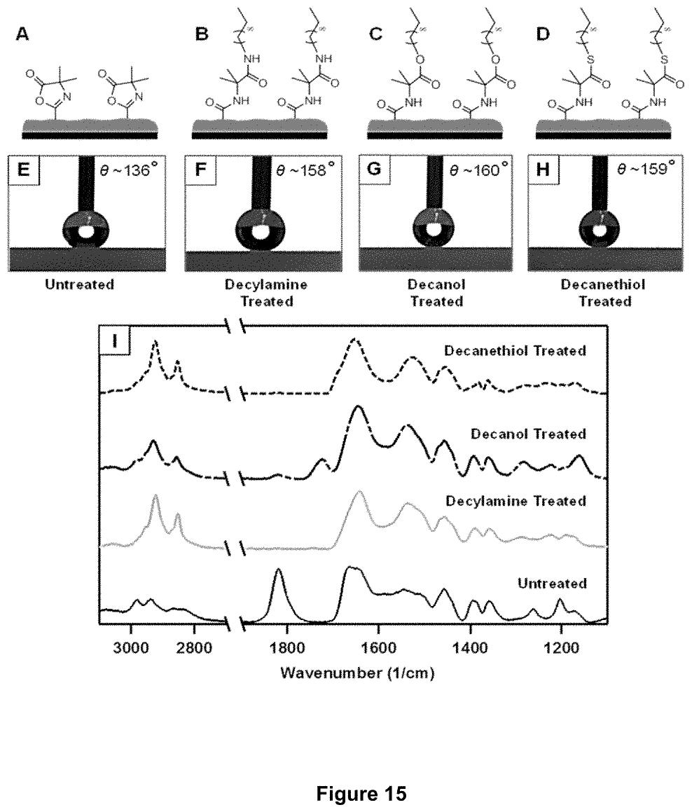

Modification of Interfacial Properties Using Alcohol- and Thiol-Based Nucleophiles. Previous experiments demonstrate that the surface energies and wetting behaviors of native (azlactone-containing) PEI/PVDMA films can be permanently modified (through the creation of amide/amide-type bonds) by treatment with primary amines functionalized with hydrophobic or hydrophilic groups. Those prior experiments reveal that when these covalent modifications are made to multilayers possessing nano- and microscale topographic features, this approach can also be used to design films that are superhydrophobic, or extremely non-wetting to water [superhydrophobic surfaces are defined here having advancing water contact angles (WCAs) >150°, with low water roll-off angles]. The functionalization of nanoporous PEI/PVDMA films ˜3.5 μm thick by reaction with n-decylamine yielded an increase in WCA from 135.6° (±1.9°) (FIGS. 15 (A) and (E) for native, azlactone-functionalized films) to 158.3° (±1.7°) (FIGS. 15 (B) and (F)).

The images in FIGS. 15 (C)-(D) and (H)-(G) reveal that superhydrophobicity can also be achieved by the DBU-catalyzed reaction of residual azlactones with the hydrophobic alcohol n-decanol (WCA=160.3±1.8°; panel (G)) and the hydrophobic thiol n-decanethiol (WCA=159.0±1.6°; panel (G)). These decanol- and decanethiol-functionalized films were uniformly superhydrophobic across the entirety of the material, with properties and behaviors that were both quantitatively and qualitatively similar to those exhibited by decylamine-functionalized films when placed in contact with or immersed in water.

FIG. 15 (I) shows representative ATR IR spectra of an untreated (azlactone-containing) PEI/PVDMA film and decylamine-, decanol-, and decanethiol-treated films used in the experiments above. The IR spectrum of the untreated film exhibited a cyclic carbonyl C═O stretch characteristic of residual azlactone groups at 1819 cm⁻¹; the two coalescing absorbance bands with peaks at 1666 cm⁻¹ and 1646 cm⁻¹ correspond to the C═N functionality in the azlactone ring and the C═O stretch of amide bonds that make up the crosslinks of the film, respectively. For films treated with decylamine, the peak corresponding to the azlactone functionality at 1819 cm⁻¹ was completely consumed, suggesting exhaustive reaction of the azlactone groups with the incoming amine-based nucleophile and consistent with the results of past studies. For films treated with decanol, the intensity of the azlactone carbonyl stretch at 1819 cm⁻¹ was also substantially reduced, and a carbonyl C═O stretch at 1724 cm⁻¹ appeared, consistent with the formation of ester bonds upon the reaction of the azlactone groups with this alcohol-based nucleophile. Finally, for films treated with decanethiol, the azlactone peak was also consumed and close inspection of the data reveals a shoulder on the amide C═O stretch (near 1652 cm⁻¹) that were attributed to the C═O carbonyl stretching of thioester functionality. These results, when combined, are consistent with the ring-opening of residual azlactone rings by these alcohol- and thiol-based nucleophiles under these DBU-catalyzed conditions.

The results of additional experiments demonstrated that, whereas the superhydrophobicity of decylamine-treated films can be maintained for long periods in aqueous environments, the extremely non-wetting behaviors of decanol- and decanethiol-treated films could be permanently erased and eliminated by exposure to aqueous analytes that cleave ester and thioester bonds. For these experiments, PEI/PVDMA films fabricated on amine-functionalized poly(ethylene terephthalate) (PET) substrates were used to improve stability at the film/substrate interface and reduce the likelihood of film delamination.

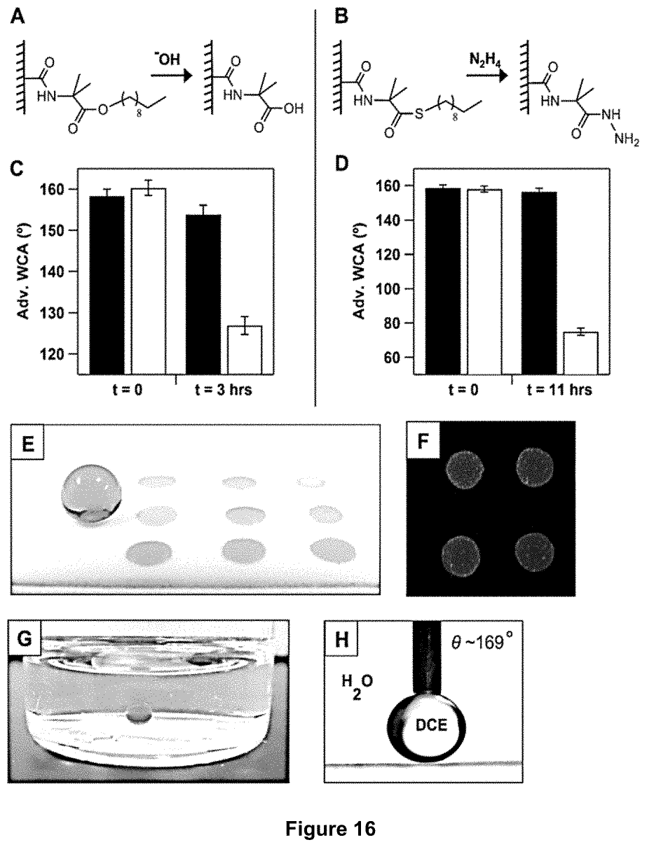

In an initial series of experiments, the wetting behaviors of decylamine- and decanol-treated films exposed to aqueous base were characterized, with the reasoning that the hydrolysis of ester bonds would reveal hydrophilic carboxylic acid groups (e.g., FIG. 16 (A)) and result in large reductions in WCAs. FIG. 16 (C) shows the results of an experiment in which a large aqueous droplet of 50 mM NaOH was placed onto the surfaces of both decylamine- and decanol-treated films in a humid environment for ˜3 hours at room temperature. Inspection of these results reveals a large reduction in the WCA of the decanol-treated film (from ˜160° to ˜126.9±2.2°; FIG. 16 (C), gray bars) in the areas of the film treated with aqueous base. In contrast, the WCA of the decylamine-treated films remained largely unaffected under these conditions (FIG. 16 (C), black bars). These results are also consistent with the hydrolysis of the ester bonds of decanol-treated materials. The hydrolyzed regions of the decanol-treated films were rapidly and uniformly wet when contacted with water, whereas surrounding areas that were not treated remained superhydrophobic and were jacketed by a layer of air, as is typical of superhydrophobic surfaces in the Wenzel-Cassie state, when immersed in water. This observation suggests new approaches to the chemical patterning of superhydrophobic materials and provides a basis for the design of new surfaces with patterned contrasts in wettability. The selective deposition of small (10 μL) droplets of aqueous base were used to pattern a small array of hydrophilic spots distributed within a superhydrophobic background (FIG. 16 (E); small droplets of colored water show the locations of the hydrophilic spots; a larger droplet reveals the maintenance of superhydrophobicity in surrounding, untreated areas). These arrays of hydrophilic spots could also be used to directly capture and position small samples of water by direct dipping into aqueous solutions without substantial wetting or contamination of the surrounding superhydrophobic surfaces (FIG. 16 (F)).

A similar series of experiments using superhydrophobic decanethiol-treated films to determine if these thioester-functionalized films could be induced to undergo changes in structure and wetting behavior in response to a specific chemical stimulus. For these experiments, hydrazine was used as a model nucleophile to attack the thioester and displace hydrophobic decyl chains (FIG. 16 (B)). FIG. 16 (D) shows the results of experiments in which decanethiol-functionalized films were treated with hydrazine over a period of ˜11 hours. These results reveal a dramatic reduction in WCA from >150° to ˜75.0° (±6.2°) for decanethiol-functionalized films (gray bars; results using decylamine-functionalized films treated with hydrazine were again stable and did not exhibit changes in contact angle under these conditions; FIG. 16 (D); black bars). A formal loss of superhydrophobicity was also observed in decanethiol-functionalized films at shorter reaction times; for example, WCAs decreased to ˜134.2° (±5.3°) after ˜5 hours, suggesting that lower exposure times could be used in instances where simple transitions in wetting states are desired. These results are consistent with the hydrazine-mediated cleavage of the hydrophobic thioester groups and the installation of more hydrophilic acylhydrazine groups (FIG. 16 (B)).

The inherent nano- and microscale roughness of these superhydrophobic coatings, combined with the degree of hydrophilicity induced by treatment with hydrazine and the cleavage of hydrophobic thioester functionality, resulted in films that were highly absorbent to water but extremely repellant of oils when placed in aqueous environments (a phenomenon known as ‘underwater superoleophobicity’). FIG. 16 (G) shows a droplet of a model oil (dichloroethane, stained with a red hydrophobic dye) placed on a hydrazine-treated film submerged in water. As shown in FIG. 16 (H), this surface exhibits an underwater advancing oil contact angle of approximately 169°, indicating a transition to a robust and extremely oil repellant state (whereas the surface is fully wet by water in air). This feature, combined with the ability to chemically pattern regions of hydrophilicity on these substrates are useful for the design of new surfaces that can capture, manipulate, and guide the transport of oily substances in underwater environments.

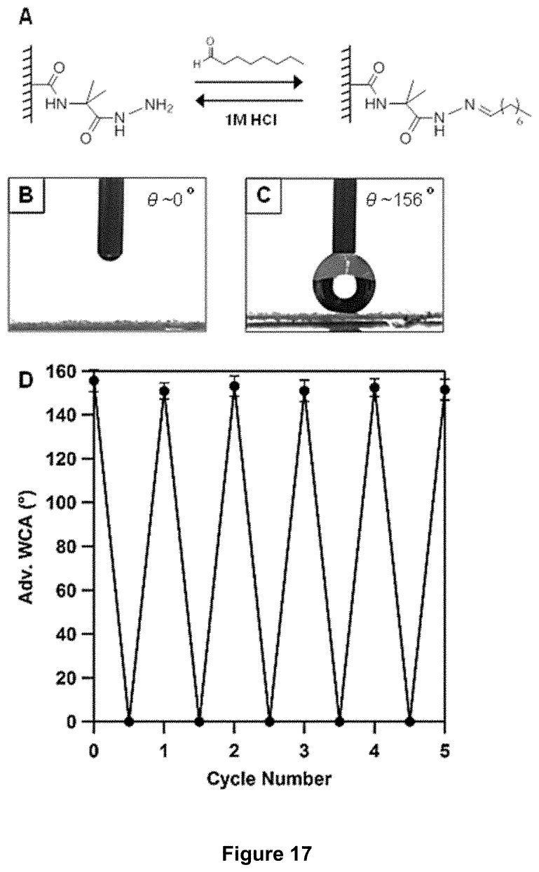

Characterization of Reactive Acylhydrazine-Functionalized Multilayers. The ability to functionalize azlactone-containing films using alcohol- and thiol-based nucleophiles substantially expands the range of additional molecules that can be installed and, as described above, introduces new functionality (e.g., the introduction of chemically labile linkers) that can lead to materials with new and useful behaviors that differ substantially from those designed using primary amine-based nucleophiles. The introduction of acylhydrazine groups in the work described above—a byproduct of treatment with hydrazine to cleave surface-bound thioester functionality—could also be used as a useful reactive synthon that could further expand the range of functional groups that could be installed in these materials (i.e., by broadening the pool further, to include the immobilization of aldehyde-containing molecules; FIG. 17 (A)) and, thus, the range of functionality that can be achieved through the installation of acid-labile imine bonds and other chemically reversible groups.

To explore the feasibility of this approach, experiments were performed using nanoporous PEI/PVDMA multilayers reacted exhaustively with hydrazine (20 mg/mL in methanol, overnight). These acylhydrazine-functionalized films were superhydrophilic (they exhibited WCAs of ˜0°; FIG. 17 (B)) and were extremely non-wetting to oils when submerged in water, as expected from our observations described above. These acylhydrazine-functionalized coatings were treated with octyl aldehyde to install hydrophobic octyl groups through a rapid and ‘click-like’ reaction that results in the formation of an acid-sensitive imine linker (20 mg/mL in methanol, 1 hour; FIG. 17 (A)). Characterization of these surfaces after octyl aldehyde treatment revealed these coatings to exhibit robust superhydrophobicity (WCA 156; FIG. 17 (C)) similar to those obtained by treatment with hydrophobic amine-, alcohol, and thiol-based nucleophiles (e.g., FIG. 15).

The introduction of imine bonds rendered these surfaces sensitive to acidic conditions—exposure to acidic media (1.0 M HCl; 1:1 THF/H₂O) resulted in the cleavage of the imine bonds, the recovery of acylhydrazine functionality on the coatings, and the concurrent return of superhydrophilic surface character (WCAs ˜0°) and underwater-superoleophobic behavior. Because this acid-catalyzed cleavage process regenerates acylhydrazine functionality, superhydrophobicity could be restored by re-treatment with octyl aldehyde—transitions between superhydrophobicity and superhydrophilicity/underwater superoleophobicity could be cycled reversibly at least 5 times without erosion of expected wetting behaviors (FIG. 17 (D)).

Thus, new approaches for the chemical modification of azlactone-functionalized polymer multilayers using alcohol- and thiol-based nucleophiles or by direct treatment with hydrazine are hereby provided. These methods broaden the pool of compounds available for the post-fabrication functionalization of these reactive multilayers substantially (e.g., to include molecules functionalized with alcohol, thiol, or aldehyde groups) and provide strategies for the design of thin films and surface coatings with novel amide/ester-, amide/thioester-, and amide/imine-type bonds that are, in contrast to those produced by reactions with primary amines, chemically labile and stimuli responsive. These results open the door to the design of new environmentally responsive materials and coatings, including surfaces that can promote the traceless release of covalently-immobilized molecules and coatings that undergo dynamic and predictable changes in extreme wetting behaviors, such as superhydrophobicity, superhydrophilicity, or underwater superoleophobicity, in response to environmental stimuli. The properties and behaviors of these materials could prove useful in emerging applications of special-wetting surfaces, including the design of surfaces that can capture and guide the passive transport of fluids, new materials for oil/water separation, and in areas such as controlled release, where controlled and time-dependent changes in extreme wetting behaviors could be used to control the ingress of water into a coating (and, thus, provide control over the rate at imbedded water-soluble or water-sensitive agents are released). Overall, the results of this example broaden the range of chemical functionality that can be installed in azlactone-containing multilayers, and thus also expand the range of new functions and properties that can be imparted, beyond those that can be attained by functionalization using primary amines.

### Example 7—Fabrication of Polymer Coatings Using Spray-Based Methods

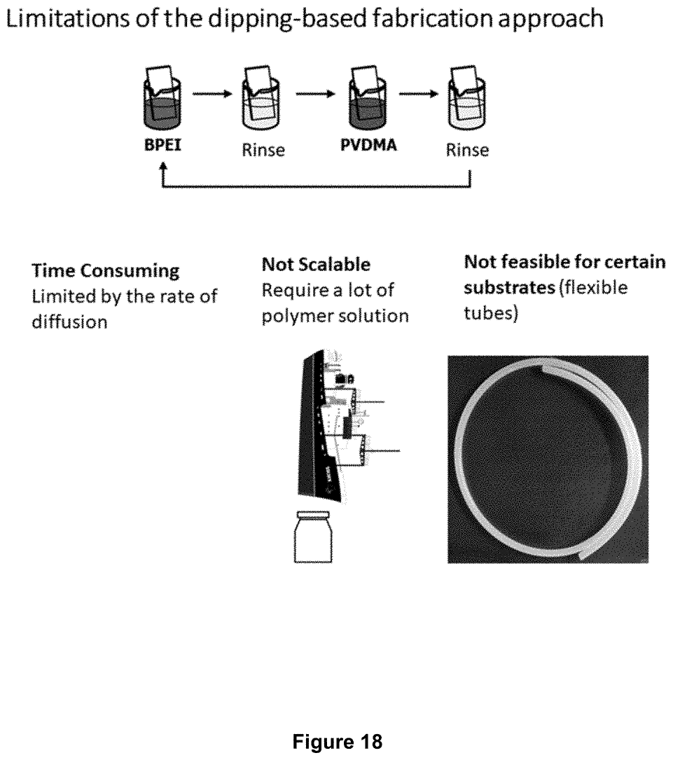

As illustrated in FIG. 18, dipping-based methods for making reactive porous multilayer polymer films, such as the SLIPS materials above, generally require that the substrate be immersed in a container containing the polymer solution. After dipping the substrate into each polymer solution, the excess solution must be removed by further dipping the substrate into a rinse solution or by otherwise washing the excess solution off of the substrate.

Accordingly, dipping-based methods are limited by the rate of diffusion of the polymer in the solution onto the substrate surface and by the time necessary to perform the rinsing steps. Additionally, dipping-based methods require a large amount of solution in order to fully immerse the substrate, and may not be applicable to coating large surfaces that cannot be submersed into a container.

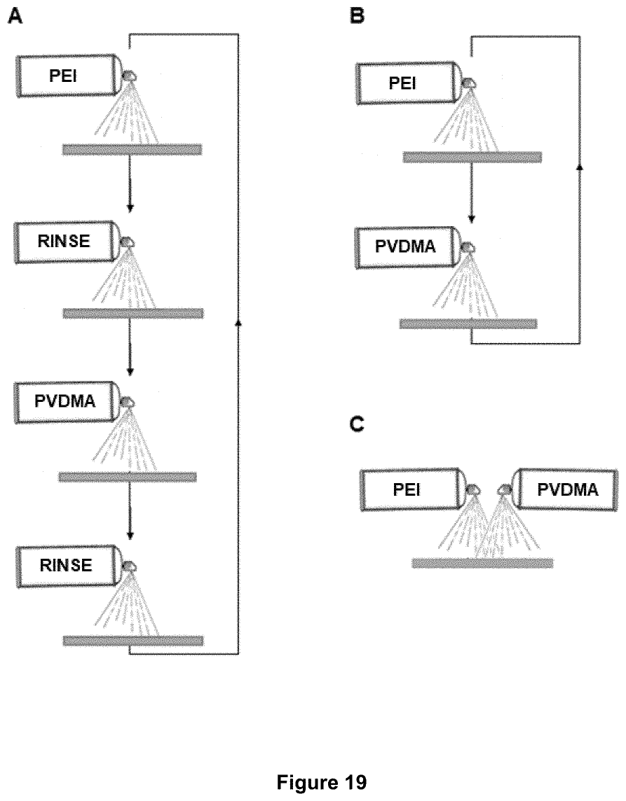

As demonstrated herein, spray-based methods are able to fabricate reactive porous multilayer polymer films while overcoming these limitations. FIG. 19 panel A) and B) illustrate the fabrication of a PEI/PVDMA multilayer film using spraying. PEI and PVDMA are alternately sprayed onto a substrate and may further contain a rinse step (panel A)). As the substrate is not immersed into a solution, the rinsing step may not be necessary and omitting the rinsing step reduces fabrication time by approximately one half. FIG. 19, panel C) illustrates that a PEI/PVDMA polymer layer may be sprayed onto the substrate by simultaneous spraying of both the polymer solutions. Simultaneous spraying further significantly reduces the fabrication time.

Experiments fabricating and characterizing multilayer porous polymer coatings using these spray methods are described further below.

Materials and Methods. Compressed air used to dry samples was filtered through a 0.2 μm membrane syringe filter. Scanning electron micrographs were acquired using a LEO 1550 SEM at an accelerating voltage of 3 kV using an in-lens SEM detector. Coated tubes were sectioned into ˜1 cm long segments, and coated glass slides were cut into 1×1 cm section. The samples were mounted on a SEM stub by conductive carbon tape, and the sides of the tubing segments and glass slides were grounded to the stub using conductive carbon cement. Samples were coated with a thin layer of gold using a gold sputterer operating at 45 mA under a vacuum pressure of 50 mTorr for 2 min before imaging. Digital photographs and videos were acquired using a Samsung Galaxy S8+ smartphone.

For contact angle measurements, the coated glass slides were cut into 1×1 cm squares. Contact angle measurements were obtained using a Dataphysics OCA 15 Plus contact angle goniometer at ambient temperature with 2 μL of Mili-Q water droplets. The advancing and receding contact angles were measured by the droplet volume change method. Optical thicknesses of films fabricated on silicon substrates were acquired using a Gaertner LSE ellipsometer (632.8 nm, incident angle=70°), and data points were processed using the Gaertner ellipsometer measurement software. Relative thicknesses were calculated assuming an average index of refraction of 1.55 for the multilayered films. Thicknesses were determined for at least three substrates in at least five different locations on each substrate and are presented as averages with standard deviations.

Polarization modulation infrared reflectance-absorbance spectroscopy (PM-IRRAS) was conducted in analogy to previously reported methods (Zhang et al., 2006, J Polym Sci Part A: Polym Chem, 44: 5161-5173; and Yang et al., 2004, J. Phys. Chem. B, 108(52): 20180-20186). Silicon substrates used for reflective infrared (IR) spectroscopy experiments were prepared by depositing thin layers of titanium (10 nm) and gold (200 nm) sequentially on clean silicon wafers using an electron-beam evaporator (Tek-Vac Industries, Brentwood, N.Y.). Coated silicon substrates were placed at an incident angle of 83° in a Nicolet Magna-IR 860 Fourier transform infrared spectrophotometer equipped with a photoelastic modulator (PEM-90, Hinds Instruments, Hillsboro, Oreg.), a synchronous sampling demodulator (SSD-100, GWC Technologies, Madison, Wis.), and a liquid-nitrogen-cooled mercury cadmium telluride detector. For each sample, 500 scans were taken at a resolution of 4 cm⁻¹, and data was collected as differential reflectance vs. wavenumber. All the data were analyzed using Microsoft Excel for office 360 and plotted using GraphPad Prism 7 (version 7.0 h).

Fabrication of SLIPS-based coatings. Glass and silicon slides were cut into 3×3 cm squares, and polyethylene tubing segments were cut to 20 cm long segments. All substrates were cleaned with acetone, dried under a stream of filtered and compressed air, and oxygen plasma-treated for 600 s (Plasma Etch, Carson City, Nev.).

The multilayer coatings were fabricated by layer-by-layer spray coatings of PEI and PVDMA using an automated SPALAS™ coatings system (AGILTRON®, Woburn, Mass.). In-house compressed air lines supplied pressurized gas with overpressure fixed at 20 psi. The planar substrates were placed horizontally from the nozzle, and the solutions were sprayed perpendicularly onto the substrates with a horizontal movement to improve homogeneity (coating a total surface area of 2 cm²).

For coating the outside surfaces of tubing segments, a longitudinal rod was inserted through the tubing segments ends to create a rotation axis perpendicular to the spray nozzles. The tubing segments were rotated at 400 rpm while the spray nozzle sprayed solutions along the length of the tubing segments, resulting in homogenous coatings all along the outside surface of the tubing segments.

For coating the inside surfaces of containers, the container was placed horizontally on a rotating platform with the rotational axis 45° to the spray nozzles. The container was rotated at while the spray nozzle sprayed the solutions, resulting in homogenous coatings on the inside surface of the container.

Multilayers were fabricated using the sequence of steps illustrated in FIG. 19: (i) the substrate was sprayed with PEI solution (10 mM in DMF)≈12 s; (ii) rinsed by spraying with DMF for ≈12 s; (iii) sprayed again with PVDMA solution (10 mM in DMF) for ≈12 s; and (iv) rinsed again with the procedure outlined in step 2. This cycle was repeated 35 times to fabricate multilayers consisting of 35 PEI/PVDMA layer pairs (or “bilayers”).

After fabrication, multilayers were dried under a stream of filtered, compressed air, and used in subsequent experiments immediately or stored in a vacuum desiccator until use. In one modification to the general protocol described above, the DMF rinse step between spraying polymer solutions (PEI and PVDMA) was eliminated. In another modification, the polymer solutions were sprayed simultaneously on the substrate for ≈12 s, followed by waiting for ≈12 s. The cycle was repeated 35 times. All the coatings were fabricated at room temperature.

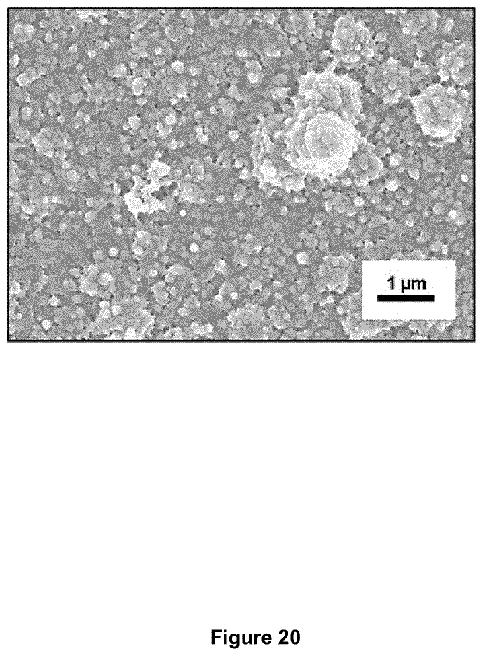

SEM images of nano- and micro-scale porosity of multilayer coatings and effect of rinse step. FIG. 20 shows a top-down SEM image of a nanoporous multilayer film (35 bilayers) coated on a planar glass substrate by the spray coating method above. The substrate was rinsed with DMF after spraying each polymer solution.

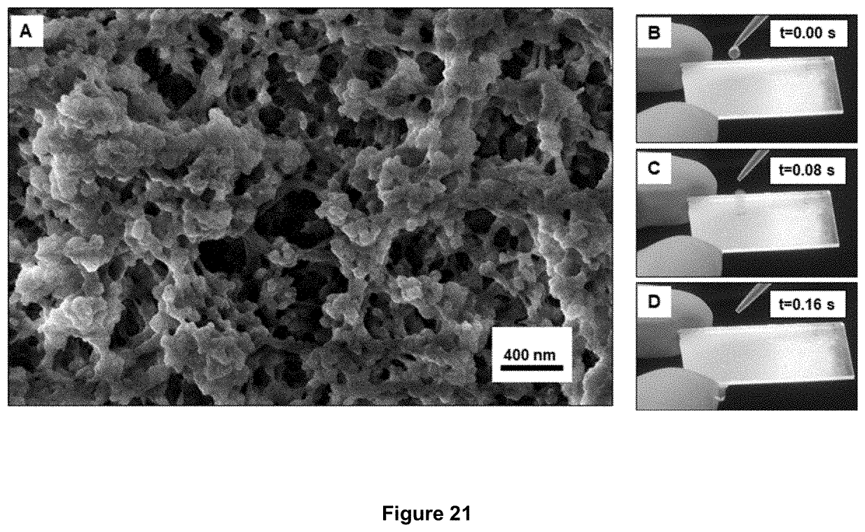

FIG. 21 similarly shows a top-down SEM image of a nanoporous multilayer film (35 bilayers) coated on a planar glass substrate by the spray coating method above where PEI and PVDMA polymer solutions were sprayed consecutively onto the substrate without any rinsing with DMF in between.

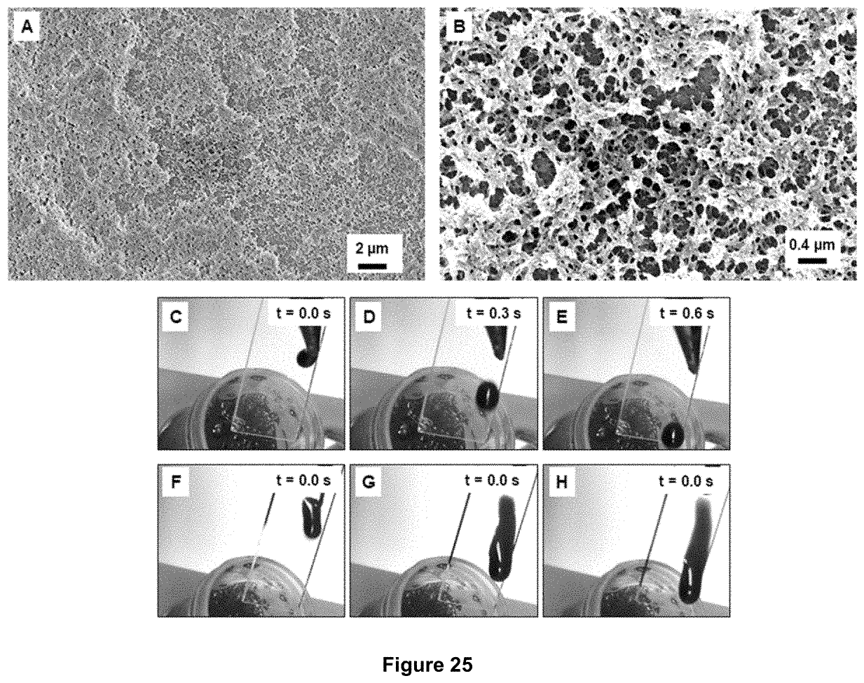

FIG. 25, panels A-B), similarly show low-magnification and high-magnification SEM images of multilayers (35 bilayers) coated on a planar glass substrate, where the PEI and PVDMA polymer solutions were sprayed onto the substrate simultaneously.

As can be seen by these images, the spraying methods described above successfully produced multilayer films having nanoscale to microscale porosity on a scale similar to multilayer films made by dip coating methods (see FIGS. 6 and 7).

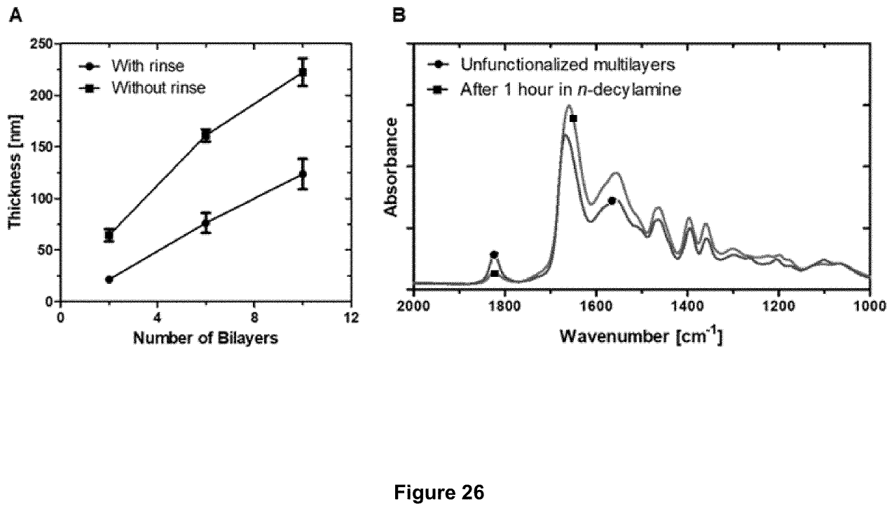

With regard to the rinse step between the application of the polymer solutions, FIG. 26 shows a plot of film thickness versus the number of PEI/PVDMA bilayers for the films fabricated with (●) and without (▪) a rinsing step on a silicon substrate. Linear increase in thickness with the increase in number of bilayers was observed with and without rinse steps. FIG. 26, panel B), also shows representative PM-IRRAS spectra for PEI/PVDMA multilayers (12 bilayers) deposited on gold-coated silicon substrate before (●) and after functionalization with n-decylamine (▪).

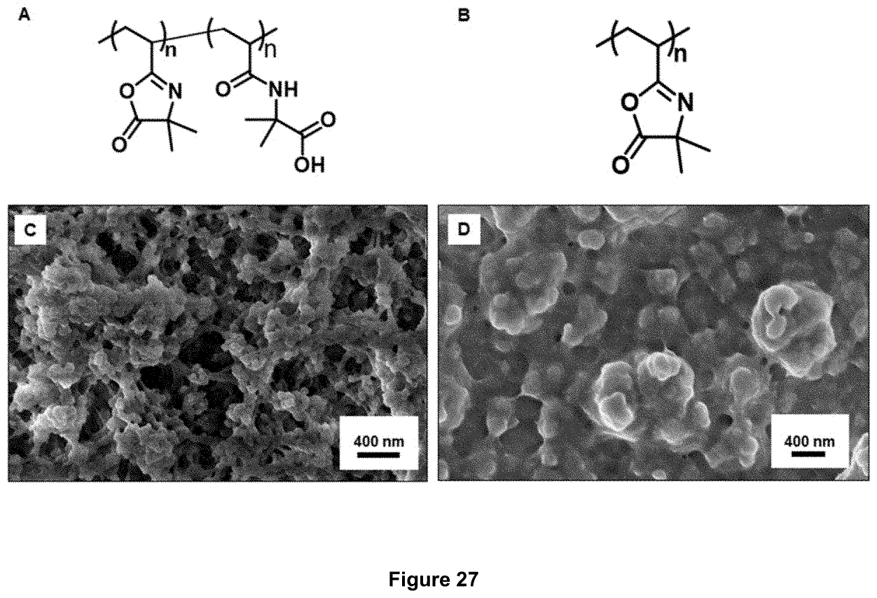

For PEI/PVDMA coatings, hydrolysis of the azlactone groups of PVDMA can affect the porosity of the coatings. FIG. 27 shows the chemical structures of partially hydrolyzed (≈22%) and unhydrolyzed PVDMA. Top-down SEM images of PEI/PVDMA multilayers fabricated using partially hydrolyzed PVDMA (C) and multilayers fabricated using unhydrolyzed PVDMA (D) coated on a planar glass substrate (35 bilayers each), indicate the multilayers fabricated using unhydrolyzed PVDMA have large macroscale features but lack nanoscale porosity.

Chemical Functionalization of Multilayers and Infusion of Silicone Oil. Porous polymer multilayers containing unreacted azlactone groups, prepared as described above, were functionalized by treatment with solutions of decylamine (10 mM in THF) overnight at room temperature. Functionalized films were then rinsed with THF and acetone, dried with filtered air, and placed in the vacuum overnight (to remove any solvents left from the hydrophobic multilayer fabrication process). Panels B-D) of FIG. 21 further show a droplet of aqueous tetramethylrhodamine (TMR) sliding off of a superhydrophobic n-decylamine-functionalized spray-coated multilayer coating.

The resulting hydrophobic multilayers were infused with lubricating liquids, thereby forming a SLIPS material. The required number of droplets of silicone oil (5 μL) were placed onto the coated surface and spread over the surface using weighing paper. The excess silicone oil was wiped-off using the weighing paper.

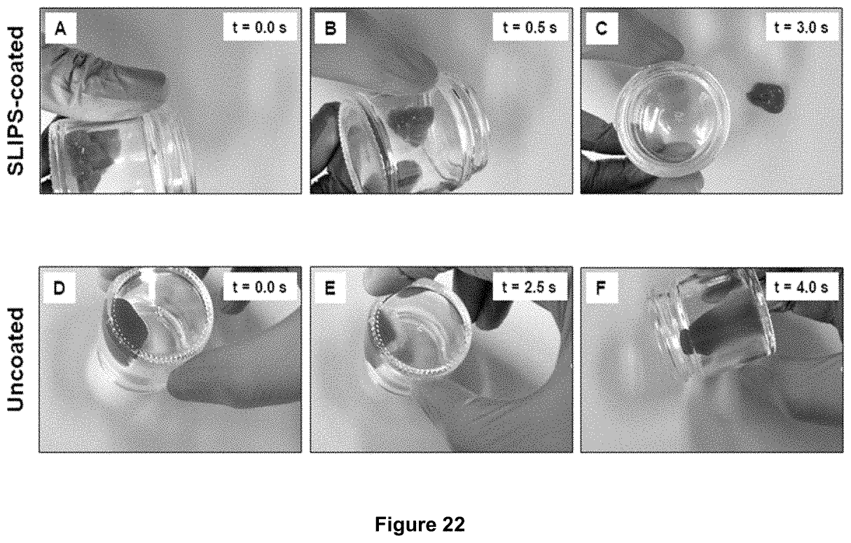

FIG. 22 shows a series of images of a blob of ketchup sliding through a SLIPS-coated glass container. The glass container was spray-coated with 35 bilayers of PEI/PVDMA, and then the multilayers were then reacted with n-decylamine and infused with silicone oil to fabricate SLIPS coatings. As can be seen, the blob of ketchup was able to slide out of the container in approximately 3 seconds. In contrast, panels D-E) of FIG. 22 show that a similar blob of ketchup became stuck inside a bare, uncoated glass container.

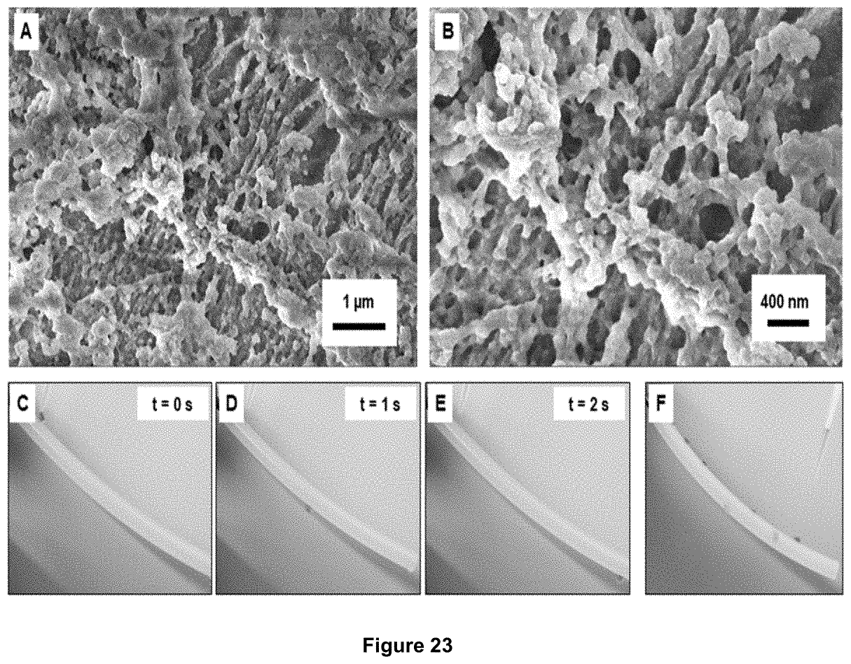

A similar experiment was performed on the exterior of polyethylene (PE) tubing segments. FIG. 23 shows top-down low-magnification and high-magnification SEM images of micro- and nanoscale porosity of multilayer films (25 bilayers) coated on the outside surface of PE tubing segments. C-E) show colored water droplets sliding along the outside surface of SLIPS-coated PE tubing segments. For contrast, F) shows water droplets stuck on the outside surface of the bare, uncoated PE tubing segment.

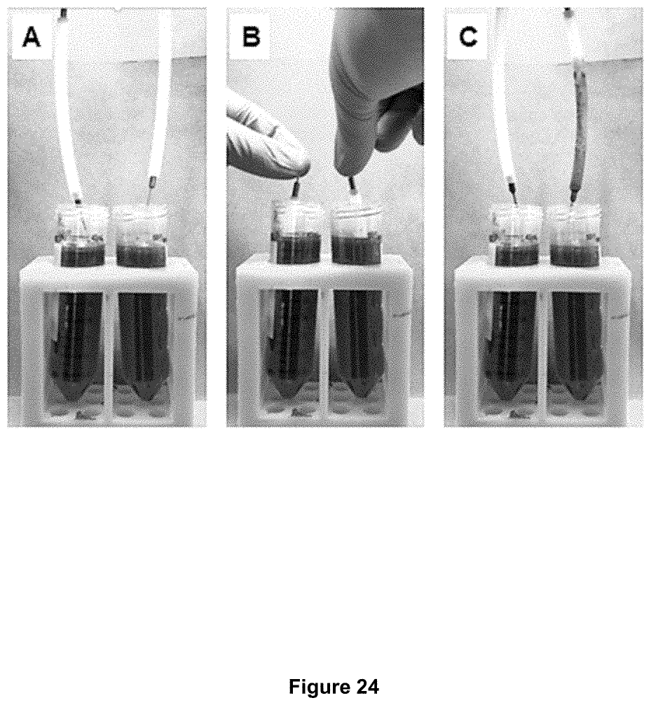

This effect was more strongly demonstrated using a biological fluid (blood). FIG. 24 compares SLIPS-coated polyethylene (PE) tubing segments (left side) with bare, uncoated PE tubing segments (right side) when they were submerged in blood for ˜1 min of contact. As seen in C), the SLIPS-coated PE tubing segments were not fouled by blood when the segments were removed, while the uncoated PE tubing segments were significantly fouled by the blood upon removal.

FIG. 25, panels C-E), similarly show droplets of blood sliding down a SLIPS-coated glass slide (35 bilayers), where the PEI and PVDMA polymer solutions were sprayed onto the substrate simultaneously. F-H) are an analogous series of images showing that blood droplets do not easily slide on the analogous bare, uncoated glass surface.

These results indicate that the spray methods of the present invention are able to successfully generate nanoporous polymer coatings while maintaining the slippery characteristics of analogous materials made using dip coating methods.

### Example 8—Reactive Multilayers and Polymer Coatings Fabricated by Spray Assembly

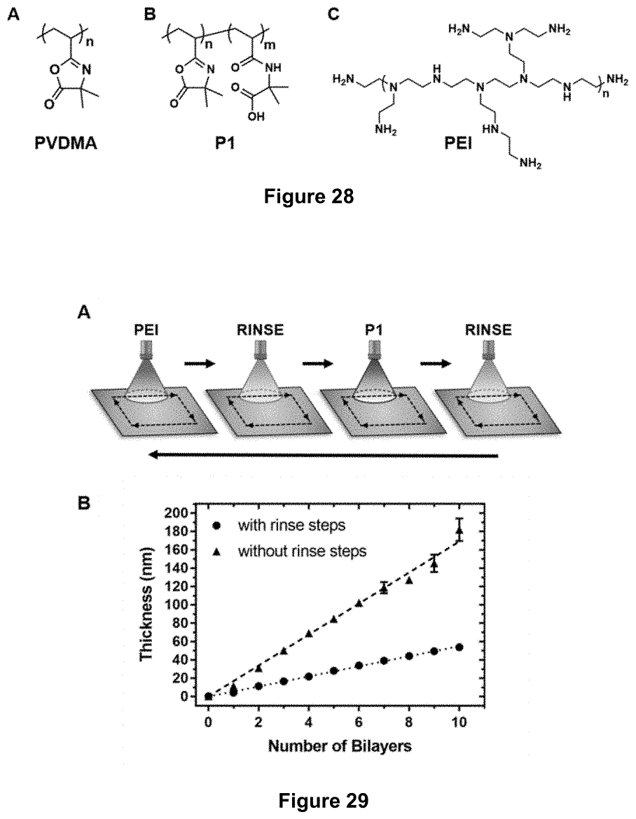

In previous studies, interfacial reactions between amine-reactive poly(2-vinyl-4,4-dimethylazlactone) (PVDMA; see FIG. 28) and the amine-containing polymer poly(ethyleneimine) (PEI; FIG. 28) can drive layer-by-layer (LbL) assembly into films that are either: (i) thin, smooth, and relatively featureless at the nanometer scale, or (ii) thicker and possessing salient nano- and microscale surface features that lead to coatings with surface or bulk properties (e.g., anti-fouling or anti-wetting behaviors and stability in complex media) of potential utility in many different applications (see Buck et al., Adv. Mater. 2007: 19, 3951-3955; Broderick et al., Biomacromolecules 2011, 12: 1998-2007; Broderick et al., ACS Appl. Mater. Interfaces 2013, 5: 351-359; Buck et al., Chem. Mater. 2010, 22: 6319-6327; Manna et al., Adv. Funct. Mater. 2015, 25: 1672-1681; and Manna et al., Adv. Mater. 2015, 27: 3007-3012).

It is noted, however, that this past work and many other conventional LbL processes involve the repetitive immersion of substrates into solutions of polymer building blocks—a process that is time-consuming, cumbersome, and, in general, challenging to implement on a commercial scale or for the coating of larger objects (Richardson et al., Chem. Rev. 2016, 116: 14828-14867; Richardson et al., Science 2015, 348: aaa2491; and Hammond et al., AIChE J. 2011, 57: 2928-2940).

The introduction of spray-assisted methods for LbL assembly has resulted in significant practical advances, such as potentially enabling the deposition and patterning of thin films and coatings over large areas, on substrates of arbitrary size and shape, and in industrial and commercial contexts (Richardson et al., Chem. Rev. 2016, 116: 14828-14867; Richardson et al., Science 2015, 348: aaa2491; Hammond et al., AIChE J. 2011, 57: 2928-2940; Dierendonck et al., Soft Matter 2014, 10: 804-807; Li et al., Chem. Soc. Rev. 2012, 41: 5998-6009; and Schlenoff et al., Langmuir 2000, 16: 9968-9969).

In addition to practical gains related to efficiency and scale, these spray-based methods also introduce many new process parameters (e.g., spray velocity and angle, droplet size, etc.) and enable fundamentally new approaches, including those involving simultaneous spraying that can be used to tune film morphologies and resulting functional behaviors (see Alongi et al. Polym. 2013, 92: 114-119; Mulhearn et al., Soft Matter 2012, 8: 10419-10427; Kyung et al., Japanese Journal of Applied Physics 2011, 50: 025602; Krogman et al., Nat. Mater. 2009, 8: 512-518; Izquierdo et al., Langmuir 2005, 21: 7558-7567; Schaaf et al., Adv. Mater. 2012, 24: 1001-1016; Lefort et al., Angew. Chem. Int. Ed. 2010, 49: 10110-10113; and Porcel et al., Langmuir 2005, 21: 800-802).

The work reported in this example was motivated by the broad goal of understanding relationships between spray process parameters and elements of polymer structure and chemical reactivity that influence assembly and govern structure formation in coatings comprised of azlactone-containing polymers.

This example describes approaches to the spray-based assembly of chemically reactive coatings fabricated using PVDMA and copolymers of PVDMA. These spray-based methods enable (i) traditional LbL (i.e., alternate spraying) approaches to reactive assembly that are conceptually similar to conventional sequential-immersion processes, as well as (ii) the introduction of new processes that permit simultaneous spraying of reactive building blocks to construct multicomponent reactive films. The influence of structural features and process parameters that impact film growth and structure formation in these spray-assembled films are also characterized in ways that are important in potential practical applications of these materials.

It is demonstrated that judicious manipulation of these parameters enables the assembly of uniform coatings with a wide variety of morphologies and surface features (e.g., ranging from thin, smooth, and optically transparent to thick, rough, and nanoporous) using automated processes that are faster, more reproducible, and more amenable to scale-up and adoption in processes for continuous manufacturing than immersion-based methods. Finally, it is demonstrated that these spray-assisted methods lead to the retention of both reactive azlactone and reactive amine functionality, thereby permitting the rapid and continuous coating of objects that can be chemically functionalized, post-fabrication, using a wide range of nucleophilic and electrophilic functional groups to impart useful (e.g., anti-fouling, non-wetting, or chemically patterned) interfacial properties. The results of these experiments provide insights, guiding principles, and new experimental methods that are useful for tuning and tailoring the properties and behaviors of azlactone-based coatings, and advance toward an important long-term goal of developing processes for the fabrication of these materials that can be adopted and implemented at-scale in commercial and industrial processes.

Materials and Methods. Branched poly(ethyleneimine) (PEI, MW ˜25 000), acetone (ACS reagent grade), dimethyl sulfoxide (DMSO, ACS reagent grade), N,N-dimethylformamide (DMF, ACS reagent grade), dimethylaminopropylamine (DMAPA), 1-aminodecane (n-decylamine), hexamethylenediamine, (3-aminopropyl)triethoxysilane (APTES, 99%), silicone oil (for oil baths), propylamine (98%), propionyl chloride (98%), decanoyl chloride (98%), N,N-diisopropylethylamine (Hünig's base, 99%), silica nanoparticle dispersions in water (<50 nm, triethoxylpropylaminosilane-functionalized), and toluene (ACS reagent grade) were purchased from Sigma Aldrich (Milwaukee, Wis.).

Lake water was locally sourced from Lake Mendota, Madison, Wis. Nature's Touch skim milk was purchased from Kwik Trip (Madison, Wis.). Pooled human urine was purchased from Innovative Research Inc. (Novi, Mich.). Ethanol (EtOH, 200 proof) was obtained from Decon Laboratories (King of Prussia, Pa.). Skim milk, togurt drink, soy sauce, and double IPA beer were purchased locally (Madison, Wis.). Fresh porcine blood was collected in a 50 mL conical centrifuge tube containing 3.4% sodium citrate in PBS at a ratio of 9:1 (blood:citrate) and stored in a refrigerator until use. Wire mesh was purchased from Gerard Daniel Worldwide, Inc. (Hanover, Pa.). Silicon wafers (4 in) were purchased from Silicon Inc. (Boise, Id.). Silicon substrates used for reflective infrared spectroscopy experiments were prepared by depositing thin layers of titanium (10 nm) and gold (200 nm) sequentially onto clean silicon wafers using an electron-beam evaporator. PDMS (SYLGARD™ 184) was purchased from Dow, Inc. (Midland, Mich.). Flexible polyester films (Grafix Dura-Lar; 0.005 in) were obtained from Amazon.com, Inc. (Seattle, Wash.). Tetrahydrofuran (THF, ACS reagent grade), wide-mouthed glass containers (30 mL), polyethylene tubing (⅛″ ID×¼″ OD×0.062″), Cytiva Whatman™ filter paper (grade 2), and glass microscope slides (Corning) were purchased from Fisher Scientific (Pittsburgh, Pa.).

2-Vinyl-4, 4-dimethyl azlactone (VDMA) was a gift from 3M Corporation (Minneapolis, Minn.). Poly(2-vinyl-4,4-dimethyl azlactone) (P1, MW ˜53, 000; PDI=4.1) and P1 (MW ˜70,100; PDI=3.8; 22% hydrolyzed) were synthesized by the free-radical polymerization of freshly distilled and undistilled VDMA, respectively, using procedures described previously (Buck et al., ACS Appl. Mater. Interfaces 2010, 2: 1421-1429; and Carter et al., Chem. Mater. 2020, 32: 6935-6946). Tetramethylrhodamine cadaverine (TMR-cadaverine) was purchased from Invitrogen (Carlsbad, Calif.). 7-Hydroxycoumarin-3-carboxylic acid N-succinimidyl ester was purchased from ThermoFisher Scientific (Waltham, Mass.). Jeffamine® T-403 was a gift sample from the Huntsman Corporation (The Woodlands, Tex.). All materials were used as received without further purification unless noted otherwise.

General Considerations. Compressed air used to dry samples was filtered through a 0.2 μm membrane syringe filter. Scanning electron micrographs were acquired using a LEO 1550 SEM at an accelerating voltage of 3 kV using an in-lens SEM detector. Coated planar surfaces were cut into 0.5×0.5 cm sections for top-down SEM imaging. For cross-sectional SEM images, the substrates were scored on the back and then manually broken to expose the cross-section of the films. In some cases, a razor blade was used prior to imaging to scratch a pair of perpendicular lines in the films in an arbitrarily chosen location to facilitate imaging of cross-sections of the films. The samples were then mounted on a SEM stub by conductive carbon tape. Samples were coated with a thin layer of gold using a gold sputterer operating at 45 mA under a vacuum pressure of 50 mTorr for 2 min before imaging.

Digital photographs and videos were acquired using a Samsung Galaxy S8+ smartphone. For contact angle measurements, coated substrates were cut into 1×1 cm square sections. Contact angle measurements were made using a Dataphysics OCA 15 Plus contact angle goniometer at ambient temperature with 5 μL Milli-Q water droplets. The advancing and receding contact angles were measured by the droplet volume change method. Optical thicknesses of films fabricated on silicon substrates were acquired using a Gaertner LSE ellipsometer (632.8 nm, incident angle=70°), and data points were processed using the Gaertner ellipsometer measurement software. Relative thicknesses were calculated assuming an average index of refraction of 1.4 for the multilayered films. Thicknesses were determined for at least three substrates in at least three different locations on each substrate and are presented as averages with standard deviations.

Polarization modulation infrared reflectance-absorbance spectroscopy (PM-IRRAS) was conducted in analogy to previously reported methods (Zhang et al., J. Polym. Sci., Part A: Polym. Chem. 2006, 44: 5161-5173; and Cadwell et al., The Journal of Physical Chemistry B 2006, 110: 26081-26088). Silicon substrates used for reflective infrared (IR) spectroscopy experiments were prepared by depositing thin layers of titanium (10 nm) and gold (200 nm) sequentially on clean silicon wafers using an electron-beam evaporator (Tek-Vac Industries, Brentwood, N.Y.). Coated silicon substrates were placed at an incident angle of 83° in a Nicolet Magna-IR 860 Fourier transform infrared spectrophotometer equipped with a photoelastic modulator (PEM-90, Hinds Instruments, Hillsboro, Oreg.), a synchronous sampling demodulator (SSD-100, GWC Technologies, Madison, Wis.), and a liquid-nitrogen-cooled mercury cadmium telluride detector. For each sample, 500 scans were acquired at a resolution of 4 cm⁻¹, and data was collected as differential reflectance vs. wavenumber. Fluorescence microscopy images were acquired using an Olympus IX70 microscope and were analyzed using the Metavue version 4.6 software package (Universal Imaging Corporation). All the data were analyzed using Microsoft Excel for Office 360 and plotted using GraphPad Prism 7 (version 7.0 h).

Fabrication of Spray-Based Coatings. Glass, silicon, and gold-coated silicon slides were cut into 2×2 cm squares. All substrates were cleaned with water, ethanol, and acetone, dried under a stream of filtered and compressed air, and oxygen plasma-treated for 600 s (Plasma Etch, Carson City, Nev.). For films fabricated using P1 and non-polymeric linkers, the silicon substrates were cleaned in the above manner and then coated with APTES to help promote adherence of the coatings to the substrates. Briefly, the cleaned slides were incubated in a 1% APTES (in toluene) solution for one hour at 70° C. The slides were then removed and baked in an oven set at 110° C. for 15 minutes. These APTES-treated slides were then used directly or stored in a desiccator.

Coatings were fabricated using an automated SPALAS™ coatings system (AGILTRON®, Woburn, Mass.) with different nozzles for spraying PEI, PVDMA or P1, and rinse solutions. In-house compressed air lines supplied pressurized gas with an overpressure fixed at 20 psi, and all nozzles were calibrated to flow rates of 3 ml/min±0.5 ml/min. The substrates were placed horizontally (8 cm from the nozzle), and solutions were sprayed perpendicularly to the substrates with horizontal movement to improve homogeneity (typically coating a total surface area of 2 cm²). For coating the outside surfaces of polyethylene tubing segments, a longitudinal rod was inserted through the ends of the tubing segment to create a rotation axis perpendicular to the spray nozzles. The tubing segments were rotated at 400 rpm while the spray nozzle sprayed solutions along the length of the tubing segments, resulting in homogenous coatings along the outside surface of the tubing segments. For coating the inside surfaces of glass containers, the container was placed horizontally on a rotating platform with a rotational axis of 45° relative to the spray nozzles. The container was rotated at 200 rpm while the spray nozzle sprayed the solutions, resulting in homogenous coatings on the inside surfaces of the containers.

The coatings were fabricated either by sequential or simultaneous spraying of dilute organic solutions of PEI and P1 or PVDMA. Sequential spraying was performed in the following general manner: (i) substrates were sprayed with a PEI solution (10 mM in DMF with respect to the molecular repeat unit) for approximately 6 s; (ii) substrates were washed by spraying with DMF for approximately 12 s; (iii) substrates were sprayed again with P1 or PVDMA solution (10 mM in DMF) for approximately 6 s and (iv) finally, substrates were washed again with the procedure outlined in step (ii). This cycle was repeated multiple times to fabricate multilayers consisting of P1/PEI or PVDMA/PEI layer pairs (or ‘bilayers’).

In one modification to the general protocol described above, the DMF rinse steps applied between spraying polymer solutions (PEI and P1 or PEI and PVDMA) were eliminated. The fabrication of multilayers using P1 and non-polymeric linkers followed the same general procedure described above, with the exception that DMSO was used as a solvent instead of DMF. Simultaneous spraying was performed by spraying both PEI and P1 solutions at different concentrations in DMF (keeping the total polymer spray rate constant at 7.2±1.2 mmol·s⁻¹) through two different nozzles at the same time for different cumulative spraying times (see main text). All other substrates used in this study (polyester film, wire mesh, and filter paper) were also coated using this protocol. After fabrication, multilayers were cleaned with DMF, dried under a stream of filtered, compressed air, and used in subsequent experiments immediately or stored in a vacuum desiccator until use. All coatings were fabricated at room temperature.

Post-Fabrication Functionalization and Chemical Patterning of Reactive Thin Films. Films containing unreacted azlactone groups, prepared as described above, were functionalized using the following general procedure. In experiments for which larger-area functionalization of the entire surface of film-coated substrates was desired, substrates coated with azlactone-containing films were immersed in solutions containing primary amine-functionalized molecules. For example, film-coated substrates were immersed in solutions of n-decylamine (10 mM in THF), propylamine (10 mM in THF), or DMAPA (10 mM in THF) overnight at room temperature. Functionalized films were then rinsed with THF and acetone and dried with filtered air.

For experiments in which microcontact printing was used to chemically pattern micrometer-scale features, polydimethylsiloxane (PDMS) stamps consisting of an array of pillars (100 μm square) were used. Inking of the stamps was achieved by first spreading a 3 μL droplet of TMR cadaverine in DMSO (1 mg/mL) on a clean glass substrate using another glass plate to produce a thin layer. The stamp was gently placed onto the wet surface and then quickly transferred and placed gently on the surfaces of azlactone-containing films. Stamps were left in contact with the films for 30 seconds and then removed. The patterned films were then rinsed with copious amounts of DMSO and acetone and dried under a filtered air stream.

Post-fabrication functionalization by chemical modification of residual amine groups was performed using the following general procedure. For functionalization using acid chlorides, coated substrates were immersed in solutions containing propionyl chloride or decanoyl chloride (20 μM in THF) and Hünig's base (30 μM in THF) for ˜3 hours at room temperature. The reaction of film-coated substrates (before or after treatment with acid chloride) with amine-reactive fluorophore was performed by placing a droplet of (7-(diethylamino)coumarin-3-carboxylic acid N-succinimidyl ester) in DMSO (2 mg/mL) for 30 min at room temperature. After functionalization, the substrates were rinsed with copious amounts of DMSO, acetone, and ethanol and dried under a filtered air stream.

Preparation and Characterization of Slippery Surfaces. Porous polymer films fabricated by sequential or simultaneous spraying of P1 and PEI were treated with decylamine and decanoyl chloride, as described above, and then infused with lubricating liquids (oils) using the following general protocol. The required number of droplets of silicone oil droplets (5 μL) were placed onto film-coated surfaces and physically spread over the surface using weighing paper. The excess silicone oil was wiped-off by the weighing paper. For sliding time measurements, a 20 μL water droplet was placed onto the oil-infused surface inclined at an angle of 20 degrees. The time required for the droplet to slide a distance of 2 cm was measured using a digital timer.

Spray-Based LbL Assembly of Reactive Coatings Using an Azlactone-Containing Copolymer. The spray-assisted LbL assembly of thin films was investigated using polyethyleneimine (PEI; an amine-containing polymer) and P1, an azlactone-functionalized copolymer synthesized by the partial hydrolysis of poly(2-vinyl-4,4-dimethyl azlactone) (PVDMA) (Carter et al., Chem. Mater. 2020, 32: 6935-6946). It was previously reported that partial hydrolysis of the azlactone groups of PVDMA can contribute to structure formation and porosity on the nano- and microscale during immersion-based LbL assembly in ways that impart useful functional properties (e.g., coatings that exhibit superhydrophobicity or recapitulate features of other PEI/PVDMA coatings fabricated in past studies using immersion coating that exhibit extreme wetting or anti-fouling properties) (Manna et al., Adv. Funct. Mater. 2015, 25: 1672-1681; Manna et al., Adv. Mater. 2015, 27: 3007-3012; and Carter et al. Chem. Mater. 2020, 32: 6935-6946).

It was not clear whether reactive multilayer assembly (in general) or these useful levels of nanoscale structure (in particular) could also be achieved by the iterative and alternating spraying of these reactive components directly onto surfaces. Accordingly, these experiments began using samples of P1 containing ˜20% ring-opened, carboxylate-functionalized side chains, which is a level of hydrolysis observed to lead to nanoporosity and retention of amine reactivity when co-assembled with PEI using bulk polymer solutions (Carter et al. Chem. Mater. 2020, 32: 6935-6946). This P1/PEI system provided a useful and practical model for these initial studies; additional characterization of spray-based methods using PEI and unhydrolyzed PVDMA are described in other sections below.

P1/PEI films were fabricated on the surfaces of planar substrates using an automated spray coating system with separate spray nozzles for spraying solutions of P1, PEI, and intermittent solvent rinse/wash steps. In these initial experiments, substrates were fixed horizontally, and polymer solutions were sprayed from an angle of 90° relative to the surface in a constant horizontal motion (covering a total surface area of ˜2 cm²). A typical spray-based LbL cycle consisted of alternate and repetitive spraying of dilute organic solutions of P1 or PEI in DMF (used here as a model, non-volatile organic solvent capable of dissolving both polymers and other materials described below) for ˜6 s, with intermittent solvent-only spray steps for ˜12 s (FIG. 29, panel A).

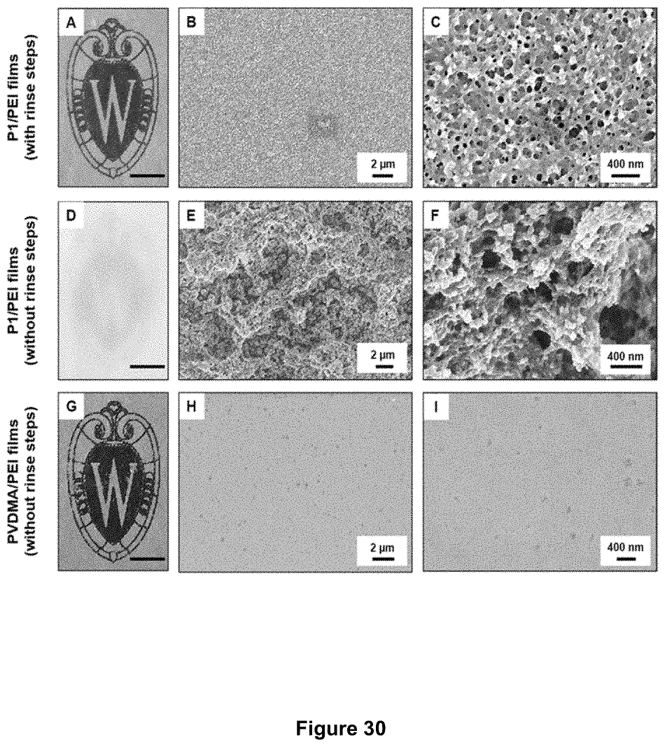

FIG. 29, panel B, (solid circles) shows a plot of optical thickness, as characterized by ellipsometry, versus the number of P1/PEI layers, hereafter referred to as ‘bilayers,’ deposited on reflective silicon substrates. The dotted line represents a linear fit to these data and reveals film thickness to increase as a linear function of the number of bilayers, consistent with stepwise, LbL growth and an average growth rate of ˜5.5 nm for each bilayer. Subsequent experiments performed using longer spraying times (˜10 s) or with the addition of designated delay times of ˜10 s between each spraying step yielded films with thicknesses and growth profiles that did not vary measurably from those shown in FIG. 29, panel B, suggesting that processes that lead to film growth occur rapidly (e.g., with spray times as short as 6 s). FIG. 30, panel A, shows a top-down photograph of a 35-bilayer P1/PEI film ˜220 nm thick fabricated on a silicon substrate. Inspection of this image reveals these films to be optically transparent, smooth, and uniform. Further characterization by SEM reveals coatings fabricated using this spray-based procedure to be relatively featureless and smooth on the micrometer scale and to exhibit nanometer-scale morphological features, including apparent surface nanoporosity (FIG. 30, panels B,C).

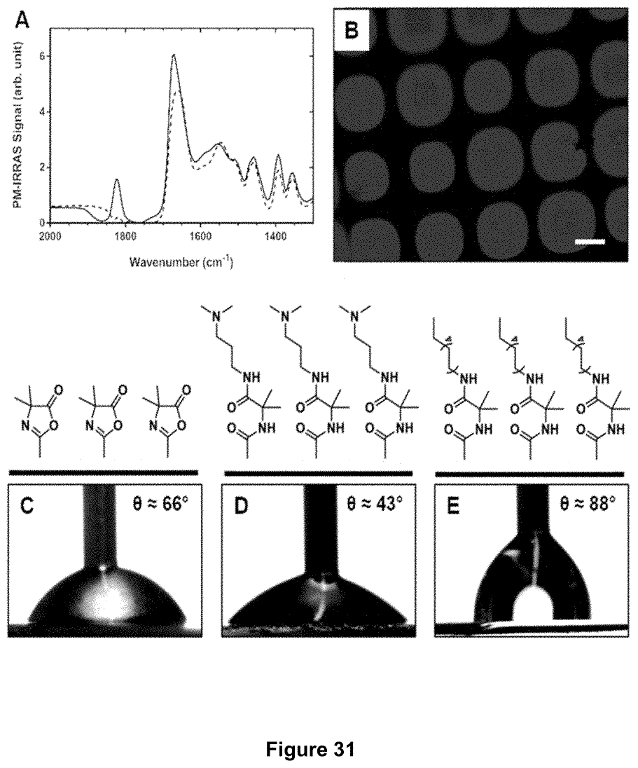

The solid curve in FIG. 31, panel A, shows a representative PM-IRRAS spectrum of a P1/PEI coating fabricated on a gold-coated silicon substrate and reveals an absorbance peak at 1826 cm⁻¹ corresponding to the carbonyl group of the azlactone ring in P1. Further inspection reveals a second peak centered at ˜1670 cm⁻¹ that corresponds to two overlapping peaks that have been attributed in past studies to (i) the amide I peak (C═O) corresponding to the amide bonds in P1 and those formed from the reaction of azlactone groups in P1 with primary amines in PEI and (ii) the peak corresponding to C═N functionality in the azlactone groups of P1. Overall, these and other results described below are consistent with an iterative, reactive spray-assembly process that leads to films that contain residual azlactone functionality at the surface and in the bulk of the material. Subsequent experiments demonstrated that these reactive spray-based coatings could be functionalized, post-fabrication, by treatment with amine-containing nucleophiles to modulate interfacial properties and pattern chemical functionality.

The dashed curve in FIG. 31, panel A, shows a representative PM-IRRAS spectrum of a P1/PEI film after treatment with a solution of the primary-amine-containing small molecule DMAPA. This result reveals the peak at 1826 cm⁻¹ to disappear, consistent with the exhaustive reaction of DMAPA with the unreacted azlactone groups in these materials and the installation of hydrophilic tertiary amine groups. FIG. 31, panels C-E, demonstrates that this approach can be used to tailor the wetting behaviors of these spray-based coatings. The water contact angle of as-fabricated (azlactone-containing) films (θw(a)≈66°, FIG. 31, panel C) decreased after treatment with hydrophilic DMAPA (θw(a)≈43°, FIG. 31, panel D) and increased after treatment with the more hydrophobic nucleophile n-decylamine (θw(a)≈88°, FIG. 31, panel E). These coatings were physically stable in that they did not dissolve, erode, or delaminate from their underlying substrates upon exposure to a range of organic solvents, including THF and acetone used during functionalization steps, or upon immersion in aqueous solutions for several weeks.

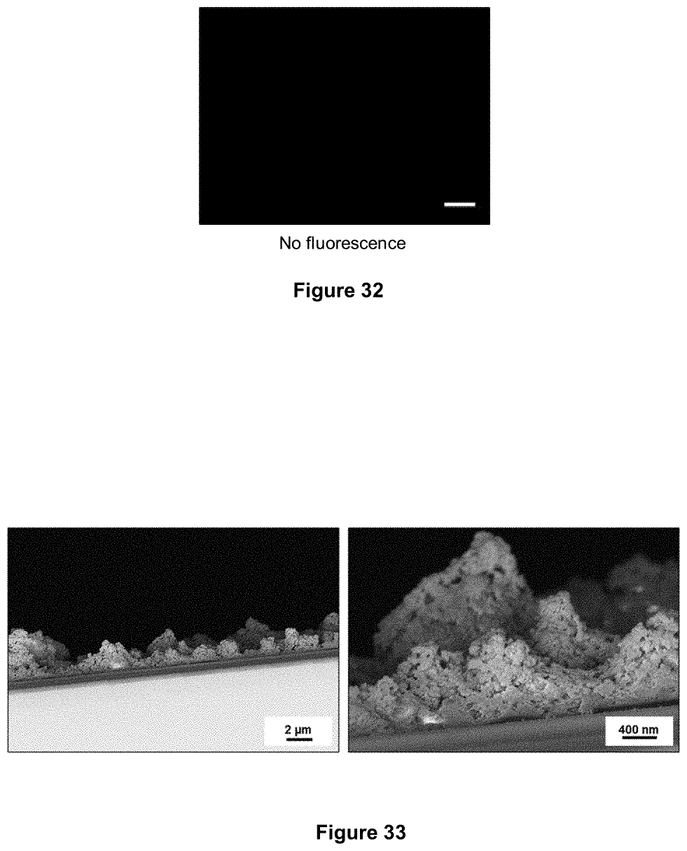

FIG. 31, panel B, shows a representative fluorescence microscopy image of a spray-based P1/PEI film after reactive microcontact printing of the amine-containing fluorophore TMR-cad using a PDMS stamp patterned with 100-micron square posts. The fluorescent features in this image are consistent with covalent immobilization and patterning of TMR-cad on the film via reactions with residual azlactone groups. The intensity of these fluorescent features did not diminish after repeated rinsing with organic solvents, and otherwise identical control films pre-treated with propylamine to consume all remaining azlactone functionality prior to stamping showed no fluorescence, suggesting that the fluorescence observed in FIG. 31, panel B arises from covalent immobilization and not physisorption (see also FIG. 32).

Amine-based nucleophiles were used in the experiments described above because reactions between azlactones and primary amines generally occur rapidly and under mild conditions, and a broad range of amine-functionalized moieties are commercially available (Buck et al., Polymer Chemistry 2012, 3: 66-80; and Heilmann et al., J. Polym. Sci., Part A: Polym. Chem. 2001, 39: 3655-3677). It is likely, based on the results above, that these spray-based coatings could also be functionalized with a range of thiol-containing, hydroxyl-containing, and other nucleophiles that react with azlactones under other conditions (Heilmann et al., Tetrahedron 1998, 54: 12151-12160; Rasmussen et al., Rapid Communications 1984, 5: 67-70; and Carter et al., Chem. Mater. 2016, 28: 5063-5072). Overall, it is concluded on the basis of these initial studies that spray-based methods can be used to promote LbL assembly using azlactone-containing polymers with retention of many of the salient features and practical outcomes common for assemblies fabricated using immersion-based methods. The sections below describe approaches for tuning the physical and chemical morphologies and resulting behaviors of materials fabricated using spray-based methods in ways that are efficient and scalable and that would be difficult to achieve using immersion-based protocols.

Spray Assembly of Rough and Nanoporous Coatings: Characterization & Potential Applications. The results of additional experiments demonstrated that manipulation of spraying parameters, including the removal of solvent rinse steps between polymer spray steps, could bias P1/PEI film growth toward thicker films and result in the development of substantial nano- and microscale roughness and porosity. FIG. 29, panel B (solid triangles) shows a plot of optical thickness as a function of the number of P1/PEI spray cycles conducted in the absence of intermittent washing. These films also increased in thickness linearly, but at a significantly faster rate (˜16 nm per bilayer) compared to films fabricated with intermittent rinse steps under otherwise identical conditions (˜5.5 nm per bilayer; FIG. 29, panel A). After 10 bilayers, these coatings were ˜190 nm thick; films fabricated by the application of additional spray cycles continued to grow but could no longer be characterized using ellipsometry because of substantial increases in roughness. Whereas films fabricated using spray cycles that included washing steps were smooth and optically transparent (FIG. 30, panel A, shows a top-down image of a 35-bilayer thick film fabricated on a glass substrate, revealing the visual clarity of an underlying image), films fabricated in the absence of wash steps were optically opaque (FIG. 30, panel D) and exhibited surface roughness that was apparent to the naked eye. Further characterization of these coatings by SEM revealed micro- and nanoscale morphological features and multiscale, irregular porosity to be present both on the surface (see top-down SEM images shown in FIG. 30, panels E, F) and throughout the bulk (see cross-sectional SEM images shown in FIG. 33) of these films.

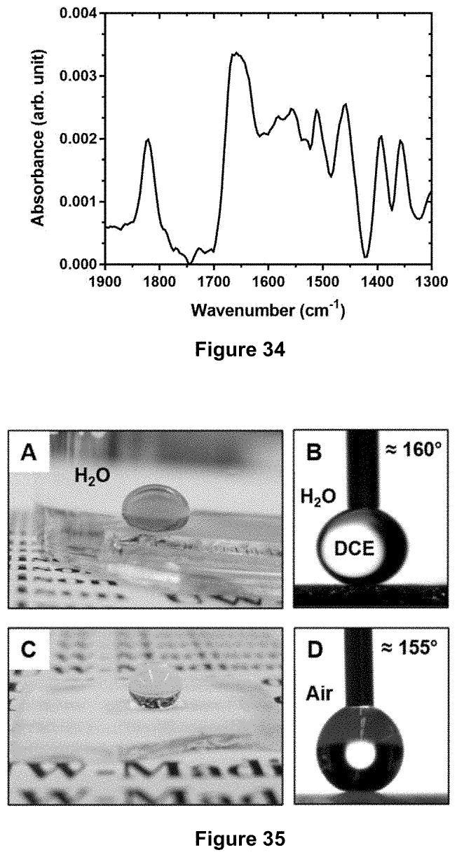

These rough and porous coatings also contained residual azlactone functionality, as indicted by the presence of an IR absorbance peak at 1826 cm⁻¹ (see FIG. 34), and could be subsequently functionalized by treatment with small-molecule amines. The combination of surface topographic features and post-fabrication functionalization with hydrophilic and hydrophobic chemical functionality permitted the design of surface coatings that exhibited extreme wetting behaviors. For example, treatment of these thicker coatings (comprised of 35 P1/PEI bilayers) with solutions of DMAPA resulted in coatings that were superhydrophilic (θ≈0°) and that, when submerged in water, were extremely non-wetting to liquid oils such as DCE. As shown in FIG. 30, panel B, small droplets of DCE (5 μL) exhibited an oil contact angle of ˜160° on these surfaces, surpassing a key criterion used to define so-called ‘underwater superoleophobicity (Feng et al., Adv. Mater. 2006, 18: 3063-3078; and Tian et al., Adv. Mater. 2014, 26: 6872-6897). In contrast, as seen in FIG. 35, panels C and D, treatment with n-decylamine yielded coatings that were superhydrophobic with a water contact angle of ˜155° and low water roll-off angles (Feng et al., Adv. Mater. 2006, 18: 3063-3078; and Feng et al., Adv. Mater. 2002, 14: 1857-1860).

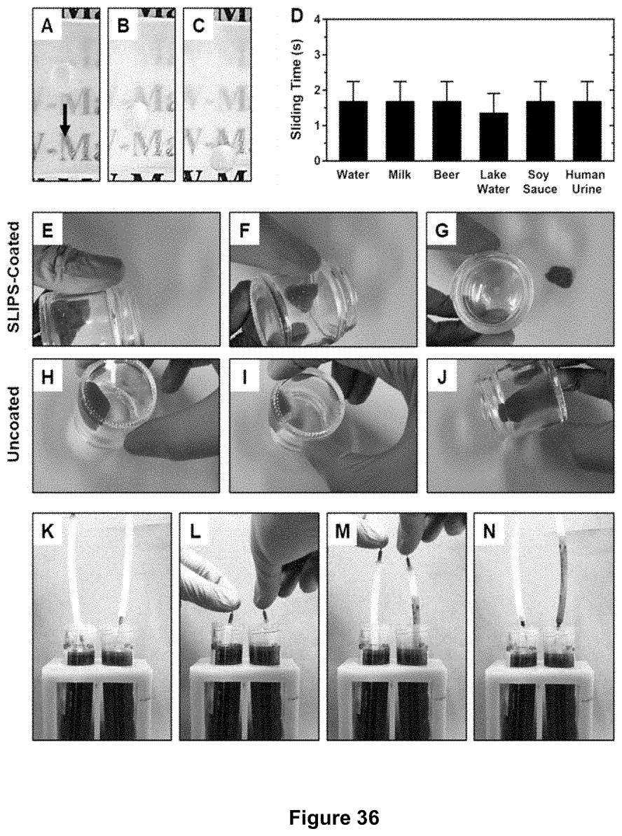

The roughness and porosity inherent to these superhydrophobic materials was sufficient to support the stable infusion of oily liquids, thus also rendering these ‘no-wash’ coatings useful for the design of slippery liquid-infused porous surfaces (SLIPS) (Wong et al., Nature 2011, 477: 443-447; Solomon et al., Chapter 10 Lubricant-Impregnated Surfaces, in Non-Wettable Surfaces: Theory, Preparation and Applications, The Royal Society of Chemistry, 2017, pp 285-318; and Peppou-Chapman et al., Chem. Soc. Rev. 2020, 49: 3688-3715). FIG. 36, panels A-C, shows top-down views of a glass substrate coated with decylamine-functionalized P1/PEI coatings infused with silicone oil. These time-lapse images also show a droplet of water (20 μL) sliding over the surface of the substrate (the substrate was tilted at 20°; the droplet was observed to slide at a rate of ˜1 cm/s under these conditions). These SLIPS were stable and retained their slippery character upon contact with a range of chemically complex liquids, including milk, beer, lake water, soy sauce, and human urine, suggesting potential utility as non-fouling surfaces in a range of commercial and healthcare contexts (FIG. 36, panel D). The results of additional experiments showed that ‘no-wash’ coatings fabricated by spraying as few as 10 P1/PEI bilayers were sufficient to support infusion of oil and produce SLIPS, reducing the overall times needed to fabricate these anti-fouling materials by approximately one-third.

One potential practical advantage of the spray-based approach reported here is that it can be used to fabricate continuous and conformal coatings on objects of arbitrary shape or size. The protocol described above were used to fabricate a continuous SLIPS coating on the inside of a wide-mouthed glass container, used here as a small-scale model of a vessel useful for the storage and dispensing of commercial gels and liquids that would be difficult, cumbersome, or resource-intensive to coat using conventional immersion-based methods.

FIG. 36, panel E-G, shows selected images of a sample of tomato ketchup placed inside a SLIPS-coated container, and shows that the ketchup could slide freely on the inside surfaces of the coated container (see also FIG. 22). Images of a sample of ketchup in an uncoated container, which remained stuck to the walls of the container even at tilt angles of 90°, are included for comparison; see FIG. 36, panels H-J. This simultaneous-spray method was also used to fabricate SLIPS coatings uniformly on the outside surfaces of lengths of flexible polyethylene (PE) tubing (see FIG. 23 for additional details and discussion). FIG. 36, panels K-N, shows a series of images of these SLIPS-coated tubes after contact with whole blood and reveals them to resist fouling in this context (in these images, SLIPS-coated tubes are shown on the left side of each panel; uncoated control tubes are shown at right).

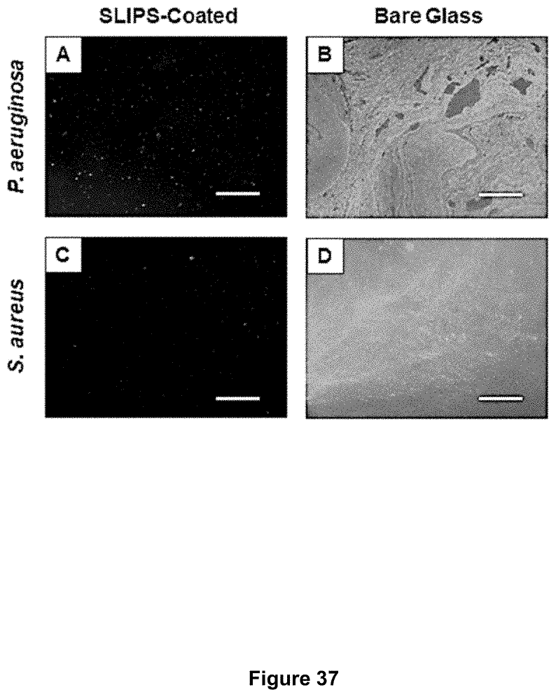

SLIPS-coated substrates also exhibited resistance to bacterial growth. Bare glass and SLIPS-coated substrates were submerged in P. aeruginosa and S. aureus bacterial cultures and incubated for 24 h. The substrates were then removed from the cultures, and the resulting biofilms were stained with syto-9 fluorescent dye. FIG. 37 shows representative fluorescence microscopy images of P. aeruginosa bacterial biofilms (panels A and B) formed on SLIPS-coated glass substrates (left) and on bare glass substrates (right), and representative fluorescence microscopy images of S. aureus bacterial biofilms (panels C and D) formed on SLIPS-coated glass substrates (left) and on bare glass substrates (right). The SLIPS-coated glass substrates showed very little fluorescence compared to the SLIPS-coated substrates.

Overall, these results highlight the potential of these spray-based methods to coat objects that would be otherwise unwieldy, time-consuming, expensive, or impractical to coat using dipping- or flow-based methods.

Influence of Polymer Structure on Film Growth and Morphology. Additional experiments using PVDMA instead of P1 revealed the influence of side-chain hydrolysis (or the carboxylic acid group content) of P1 on structure formation during the fabrication of P1/PEI coatings. Both sequential and repetitive spraying of PVDMA (the unhydrolyzed reactive homopolymer from which P1 is synthesized; FIG. 28) and PEI, without intermittent rinse steps, resulted in thin and optically transparent coatings (FIG. 30, panel G) that grew linearly to an average thickness of ˜140 nm after 35 spray cycles. These PVDMA/PEI coatings were substantially thinner, both overall and on a per-bilayer basis, than 35-bilayer P1/PEI films fabricated under otherwise identical conditions (those films were ˜1 μm thick, as determined from cross-sectional SEM images (FIG. 33) and were optically opaque; FIG. 30, panel D). Additional characterization of these PVDMA/PEI coatings by SEM revealed them to be smooth and relatively featureless at both the micro- and nanoscale, in contrast to films fabricated using P1 (FIG. 30, panels H, I).

These results, when combined, demonstrate that control over polymer (or copolymer) structure can be exploited in the context of spray-based assembly to obtain morphologies, properties, and behaviors that are desirable and useful in the context of particular potential applications. The mechanisms underlying the evolution of roughness and porosity in these systems are not completely understood. These results are, however, consistent with those of past studies on immersion-based assembly demonstrating the role that strategic levels of side chain hydrolysis can play in biasing film growth and morphology in PVDMA/PEI films, including the evolution of nano/microscale roughness and porosity, which was presumed to occur via additional acid/base, ionic, or hydrogen-bonding interactions between P1 and PEI promoted by the ionizable carboxylate side chains of P1 during assembly (Carter et al., Chem. Mater. 2020, 32: 6935-6946).

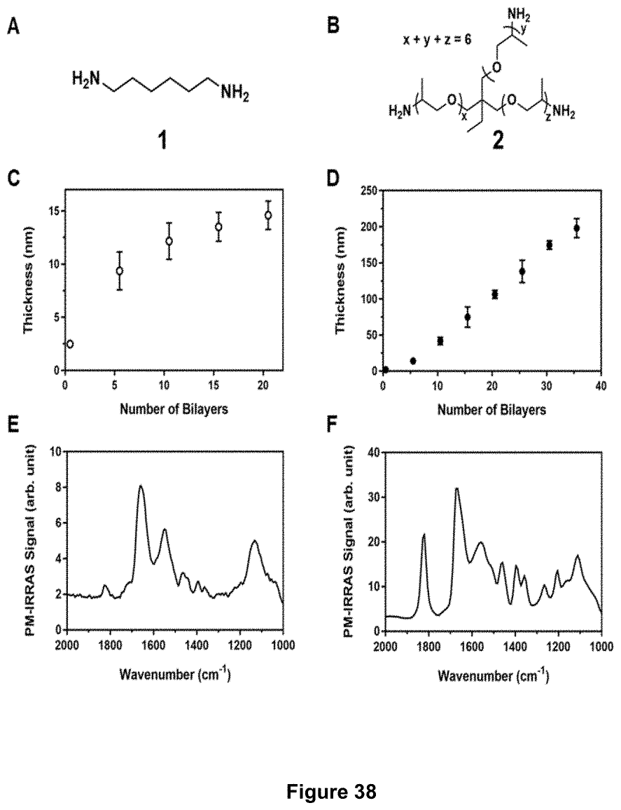

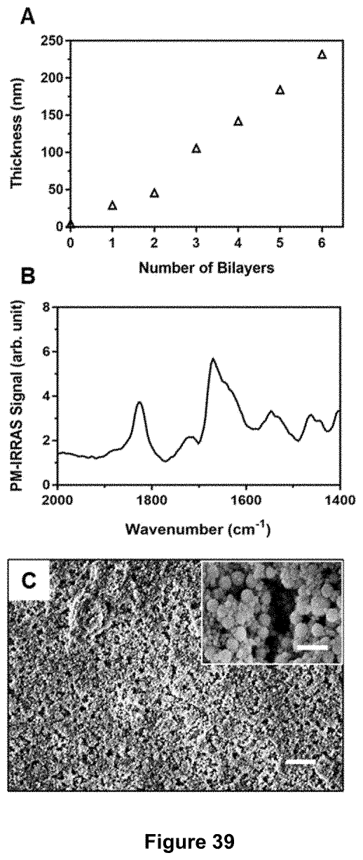

Overall, the results summarized in FIG. 30 and discussed above demonstrate that both polymer structure (e.g., side chain hydrolysis) and process parameters (e.g., the presence or absence of intermittent wash steps) can be manipulated to design films with a broad range of useful properties. In addition to providing useful control over film architecture and function, the elimination of intermittent rinse steps also substantially reduces overall coating times by as much as one-third compared to protocols involving solvent rinses. The spray-based procedures reported here also permit fabrication of azlactone-containing coatings using non-polymeric amine-containing building blocks, leading to materials with significantly different architectures and properties compared to P1/PEI assemblies. The results of experiments to fabricate and characterize reactive, spray-based coatings using (i) small-molecule (non-polymeric) diamine linkers and (ii) amine-functionalized nanoparticles are illustrated in FIGS. 38 and 39.

Further manipulation of other process parameters (e.g., spray droplet size, angle of spray, spraying rate, polymer concentration, and incorporation of additional intermittent rinsing or drying steps) are likely to also lead to new physical and chemical behaviors and have the potential to further improve manufacturing efficiency or broaden the range of potential applications for which these reactive coatings could be useful.

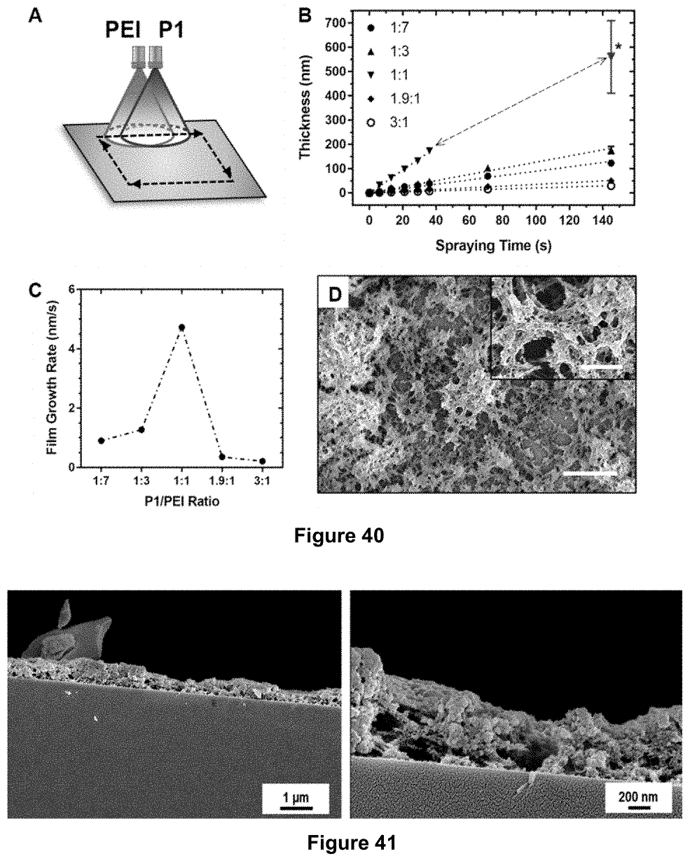

Fabrication of Reactive Coatings by Simultaneous Spray Assembly. Subsequent experiments demonstrated that coatings with useful features could also be fabricated by spraying P1 and PEI as reactive building blocks simultaneously (i.e., at the same time, continuously, and with no washing steps; see schematic in FIG. 40, panel A). To explore the feasibility of this approach, dilute solutions of P1 and PEI were simultaneously sprayed at five different P1/PEI spray rate ratios (1:7, 1:3, 1:1, 1.9:1, and 3:1) while keeping the combined polymer spraying rate (7.2±1.2 mmol/s) constant. For these experiments, all other film fabrication parameters, including spray volume, spray angle, and spray distance, were maintained as described above for alternating, LbL-based spraying procedures and coatings were deposited on silicon substrates to facilitate characterization of film thicknesses and growth.

FIG. 40, panel B shows a plot of optical thickness as a function of spraying time for these different P1/PEI spray rate ratios. The dotted lines represent fitted linear regression curves (R2≥0.99) to these measured optical thicknesses, and reveal film thickness to increase linearly as a function of continuous spraying time regardless of the P1/PEI spray rate ratio used. Due to the notably increased opacity of films fabricated at the 1:1 P1/PEI ratio at longer spray times, thicknesses could not be measured by ellipsometry. The thicknesses of films fabricated at this condition (e.g., a 1:1 P1/PEI ratio after spraying for 145 s) were estimated from cross-sectional SEM images (see FIG. 41; the thickness value resulting from this measurement is indicated by the triangle in FIG. 40, panel B, which is also marked with an asterisk to differentiate it from values obtained using ellipsometry). This SEM-derived thickness cannot be compared formally to the optical thicknesses measured using ellipsometry; however, this physical thickness falls near a value close to what would be predicted based on the linear growth rate observed during shorter spraying times (FIG. 40, panel B, filled inverted triangles; the dashed arrow shows a linear projection to longer times and is included only to guide the eye).

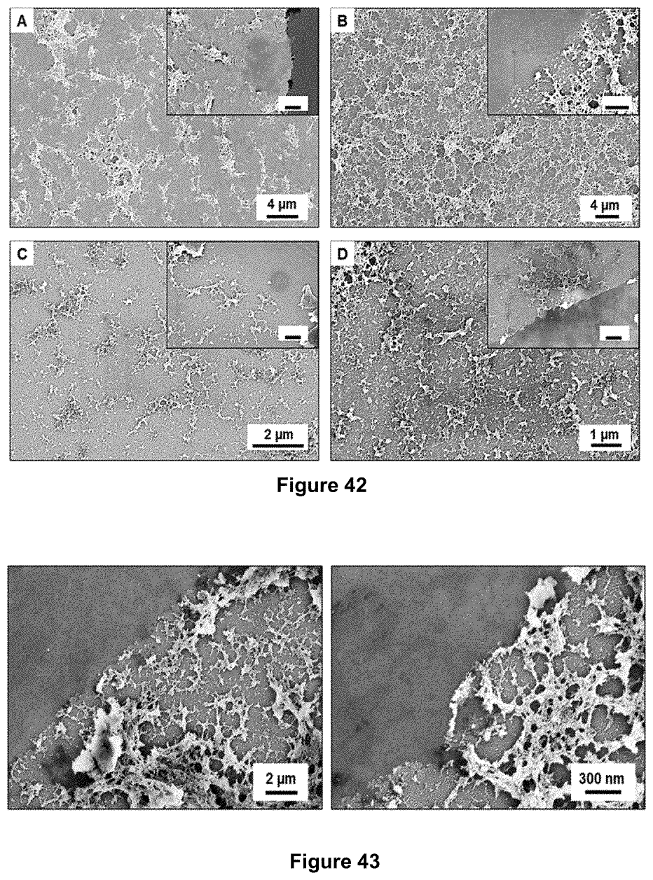

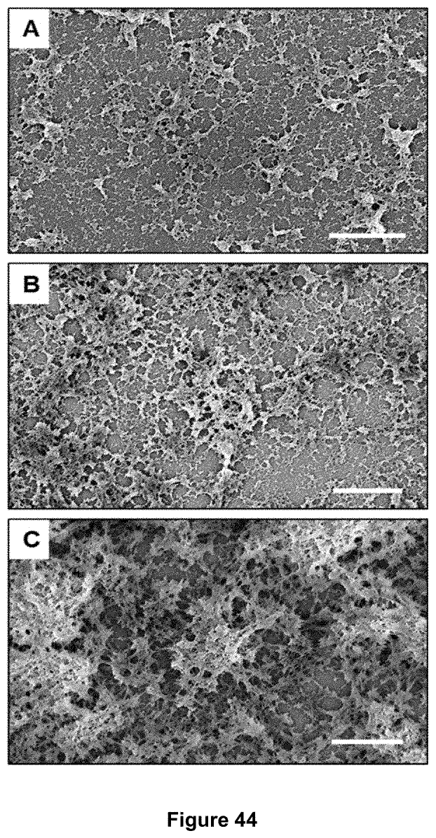

Overall, the P1/PEI spray ratio was found to influence film growth rate, with maximum growth rates observed for the continuous spraying at a ratio of 1:1 (see FIG. 40, panel B). FIG. 40, panel C also shows a plot of the growth rates, determined from the slopes of linear regression curves in FIG. 40, panel B, as a function of P1/PEI spray rate ratios. Film growth rates decreased substantially when spray rate ratios deviated from 1:1. For example, whereas films fabricated with a P1/PEI spray rate ratio of 1:1 were ˜560 nm thick after 145 s of spraying, coatings fabricated using ratios of 1:7, 1:3, 1.9:1, and 3:1 reached thicknesses of ˜135 nm, ˜100 nm, ˜40 nm, and ˜10 nm, respectively, after 145 s of spraying. All films fabricated by simultaneously spraying P1 and PEI exhibited roughness that was visible to the naked eye under all conditions tested. FIG. 40, panel D, shows a representative top-down SEM image of a film fabricated using a 1:1 spray rate ratio. This coating appears to have a rough and granular morphology that consists of micro- and nanoscale aggregates. This granular or irregular microscale morphology was also observed for simultaneously sprayed films fabricated at other spray rate ratios (see FIG. 42). Characterization of films that were scratched prior to imaging revealed an ultrathin continuous polymer film covering the silicon substrates and surrounding the salient micro- and nanoscale features in these images (see FIG. 43 and insets in FIG. 44). Overall, the morphologies of these simultaneously sprayed films varied significantly from those observed for sequentially sprayed films described above (as shown in FIG. 40, panel D, and FIG. 29, panels E-F).

The results above are consistent with a mechanism of film growth that involves the continuous formation and deposition of polymer aggregates during simultaneous spraying. General support for this view is provided by observations of large and visible aggregates that form within several seconds when solutions of PEI and either P1 or PVDMA are mixed (data not shown) as a result of reactions between amines and azlactone groups or, in the case of P1, other ion-pairing interactions with PEI that could arise from the presence of carboxylic acid side chains. During simultaneous spraying, aggregates or complexes of these polymers are likely to form continuously and either (i) drain from the surface under forced flow or (i) deposit on the surface continuously during fabrication in ways that depend upon the ratio of the two polymers in the mixture, similar to behaviors described previously for aggregates formed during the simultaneous spraying of oppositely charged polyelectrolytes (Schaaf et al., Adv. Mater. 2012, 24: 1001-1016; Porcel et al., Langmuir 2005, 21: 800-802, Lefort et al., Langmuir 2011, 27: 4653-4660; and Lefort et al., Langmuir 2013, 29: 14536-14544).

In the case of both low and high P1/PEI ratios, where an excess of either PEI or P1 is present, the likelihood of the deposition of aggregates on the surface able believed to be smaller compared to aggregates formed when P1 and PEI are sprayed at ratios close to 1:1. At these conditions, aggregates formed in solution would be more likely to drain from the surface due to an excess of amine or azlactone functionality in the aggregate, leading to reduced film growth, consistent with results shown in FIG. 40, panels B-C. In any case, continuous spraying appears to result in the continuous formation and deposition of polymer complexes, resulting in gradual film growth over time as observed by the linear increases in the film thickness shown in FIG. 40, panel B (see also FIG. 44 for SEM images of P1/PEI coatings at different spraying times, which reveal an increase in overall film coverage and other changes in morphology as a function of spray time).

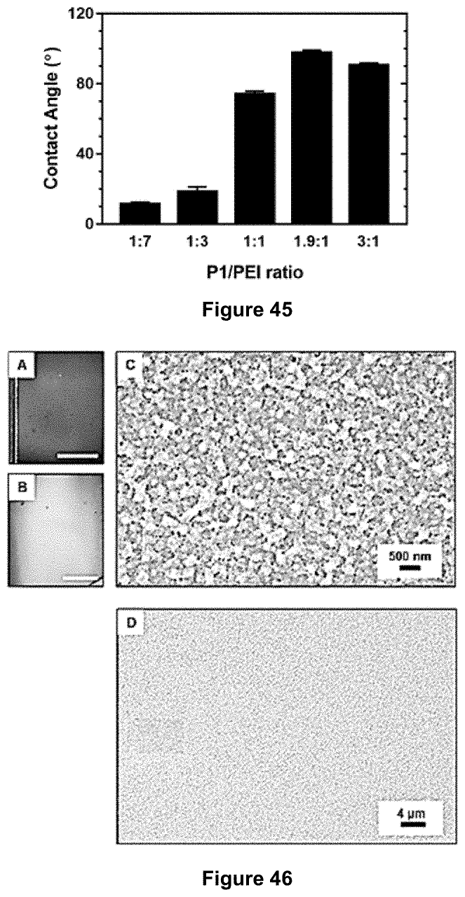

These results also suggest opportunities to manipulate process parameters in ways that permit the microscale morphologies, and thus the functional properties, of these coatings to be further tuned (e.g., such as wetting behavior; FIG. 45 shows changes in water contact angles that can be achieved by manipulation of spraying rate ratios). Finally, it is noted that structure formation in these simultaneously sprayed materials can again be influenced by side-chain azlactone hydrolysis. In general, films formed using unhydrolyzed PVDMA were visually smooth and transparent (see FIG. 46, panel A) and lacked larger micron-scale features and porosity apparent in simultaneously sprayed P1/PEI films (see FIG. 46, panels C-D).

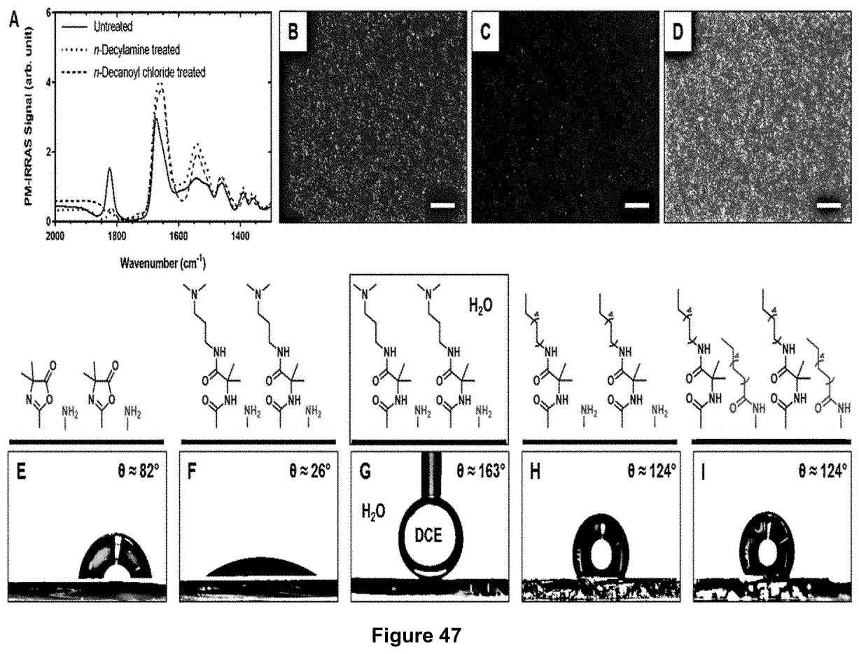

Reactive Functionalization and Characterization of Simultaneously Sprayed Coatings. A series of experiments was also conducted to characterize the reactivities and functional properties of the thicker P1/PEI films described above fabricated using simultaneous spraying and a spray rate ratio of 1:1. FIG. 47, panel A, (solid curve) shows a representative IR spectrum for a simultaneously sprayed film fabricated on a gold-coated silicon substrate and again shows (i) an absorbance peak at 1826 cm⁻¹ corresponding to the carbonyl group of the unreacted azlactone functionality and (ii) a peak at ˜1670 cm⁻¹ characteristic of amide bonds that form when PVDMA reacts with primary amines (Buck et al., Adv. Mater. 2007, 19: 3951-3955; and Carter et al., Chem. Mater. 2020, 32: 6935-6946). Exposure of these films to n-decylamine at room temperature (see the dotted curve in FIG. 47, panel A) results in a significant decrease in the peak at 1826 cm⁻¹ and increases in the amide I peak at 1670 cm⁻¹ and a distinct amide II peak at 1544 cm⁻¹. These results, when combined with the stability of these films upon extended exposure to organic solvents, are consistent with covalent crosslinking and demonstrate that simultaneous spraying leads to coatings that retain residual azlactone functionality that is available for further reaction and post-fabrication manipulation of film features.

Additional experiments demonstrated that residual amine-based chemical functionality associated with PEI can also be chemically modified, post-fabrication, with a range of amine-reactive electrophiles, including compounds containing N-succinimidyl esters and chloroformyl groups. FIG. 47, panel B, shows an image of a film (˜170 nm thick and pre-treated, in the manner described above, with n-propylamine to exhaust remaining azlactone functionality) that was treated with a solution of an amine-reactive fluorophore (7-(diethylamino)coumarin-3-carboxylic acid N-succinimidyl ester). This image clearly shows the presence of fluorescence throughout the film. FIG. 47, panel C, shows the result of an otherwise identical experiment using a P1/PEI film that was first treated with propionyl chloride to exhaust residual amine functionality prior to treatment with the N-succinimidyl fluorophore. Taken together, these results suggest that the fluorescence observed in FIG. 47, panel B, is the result of the covalent reaction of the fluorophore with the residual amine functionality in these materials (e.g., as opposed to physisorption). Additional spectroscopic characterization of the reaction of the amines in these films with acyl chlorides or other electrophiles was complicated by the existing amide I peak at ˜1650 cm⁻¹ in these materials (FIG. 47, panel A, dashed line). However, the results of these fluorescence microscopy experiments and changes in the functional properties of these coatings upon treatment with amine-reactive molecules (described below) demonstrate that these azlactone-containing P1/PEI films can also be modified, post-fabrication, by treatment with a range of amine-reactive electrophiles.

The presence of both amine and azlactone functionality in these films creates opportunities to immobilize molecules containing both nucleophilic and electrophilic functional groups on these surfaces. FIG. 47, panel D, shows a merged fluorescence image of a film treated with an amine-functionalized fluorophore (tetramethylrhodamine cadaverine) followed by treatment with the N-succinimidyl ester-functionalized fluorophore described above. It is also possible to exploit this dual functionality to tailor the physical properties (e.g., the wetting behaviors) of surfaces coated with these reactive films by treatment with combinations of reactive hydrophilic and hydrophobic molecules. For example, treatment of P1/PEI films with solutions of DMAPA resulted in significantly hydrophilic coatings (θ≈26°, compared to the untreated films (θ≈82°); FIG. 47, panels E,F) and, when submerged in water, these DMAPA-treated films exhibited underwater superoleophobicity (FIG. 47, panel G; θ≈163°). In contrast, treatment with n-decylamine resulted in a significant increase in the water contact angles of these films (θ≈124°, FIG. 47, panel H). These n-decylamine-treated films did not, however, exhibit robust slippery characteristics when infused with silicone oil (in general, these surfaces became less slippery, as determined by characterization of the sliding times of liquid droplets on these surfaces after a few minutes of immersion in, and subsequent removal from, water). However, when these decylamine-treated films were further reacted with decanoyl chloride to react with residual amine functionality (θ≈124°, FIG. 47, panel E) and then infused the films with silicone oil, the resulting slippery surfaces (θhys≈5°) remained stable under a range of conditions and upon subjection to a range of subsequent physical and chemical insults (as described below).

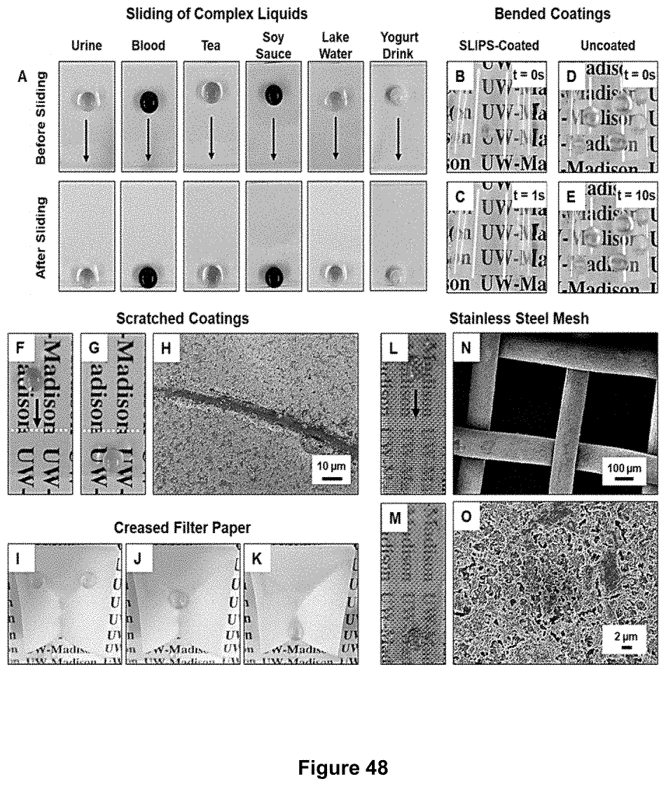

FIG. 48 reveals these oil-infused, dual-functionalized coatings to remain stable and slippery when contacted with a range of chemically complex liquids (panel A) and to retain their anti-fouling properties upon repeated bending and flexing (panels B-E), permanent creasing (panels I-K), or deep scratching (F-H) of the coatings or the underlying substrates. These features reflect the soft and flexible nature of the coatings themselves, and allow these materials to either (i) survive physical forces and manipulation associated with many potential applications of these materials or (ii) be bent, folded, or manipulated, post-fabrication, into new geometries or other designs required for specific potential applications. Finally, the simultaneous spray-based procedures reported here are appropriate for fabricating functional coatings and anti-fouling SLIPS on surfaces with topologically complex features. Panels L-O of FIG. 48 show rough and nanoporous P1/PEI coatings sprayed onto stainless-steel wire meshes and the sliding behaviors of droplets of water on the surfaces of coated meshes infused with silicon oil. These results reveal these sprayed coatings to cover the surfaces of these topologically and topographically complex substrates uniformly and conformally.

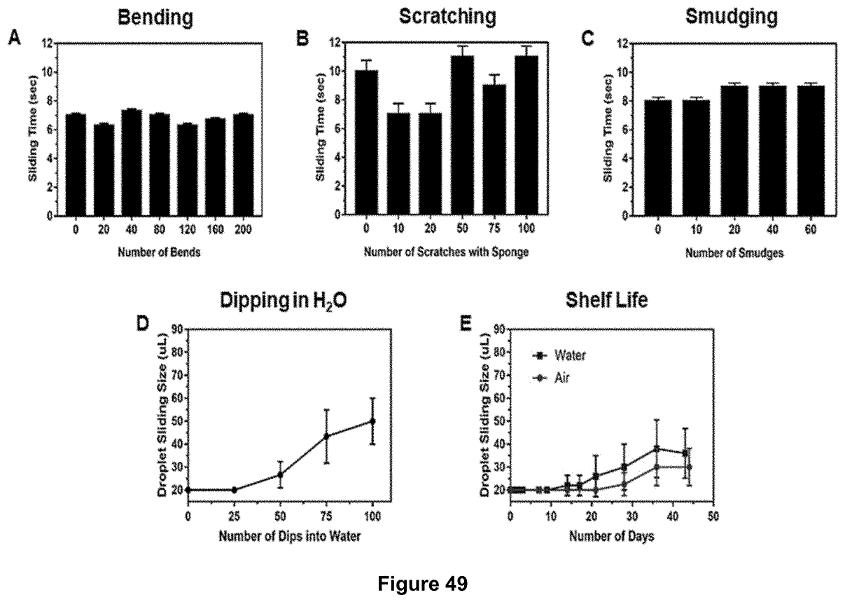

The SLIPS surfaces fabricated using spray coating also exhibited stability when exposed to varying physical or chemical environmental conditions. As shown in FIG. 49, panels A-C, the sliding time of a 40 μL water droplet at a 20° angle does not appreciably change after bending, scratching, or smudging the SLIPS coated substrate. Additionally, droplet sliding size showed limited increase after repeatedly being dipped into ultra-pure water, and after be stored in both air and water (FIG. 49, panels D and E).

Summary of example. The experiments of this example describe new alternating LbL and continuous/simultaneous spray-based approaches to the assembly of soft material coatings fabricated using azlactone-containing polymers and amine-containing building blocks.

These results reveal several important ways in which polymer structure (e.g., the presence or absence of hydrolyzed azlactone groups) and spray-process parameters (e.g., the number of spray cycles, the elimination of intermittent wash cycles, or the manipulation of polymer solution spray rates) can influence aspects of film growth and morphology that impart properties relevant to several potential applications of these materials. Judicious manipulation of these parameters—or combinations of these of these parameters—permits rapid deposition of azlactone-containing coatings that are either thin and optically transparent or thicker and optically opaque, with varying levels of nano- and microscale roughness or porosity. These spray-based coatings can be further functionalized, post-fabrication, by treatment with amine-based nucleophiles and/or electrophilic amine-reactive species to impart new chemical functionality, providing means to tune the interfacial (e.g., wetting) properties of these coatings, pattern new surface features, or create porous coatings useful for the design of new types of anti-fouling oil-infused surfaces.

These spray-based methods can be applied using automated processes that are well-suited for the coating of large objects and are faster and more amenable to scale-up and adoption in the context of continuous manufacturing than previously reported LbL methods that involve the repeated immersion of objects into bulk solutions of azlactone-functionalized polymers. Overall, the results reported here provide new methods and fundamental insight useful for tuning and tailoring the properties and behaviors of azlactone-containing materials. These spray-based methods will help guide the development of new processes for the fabrication of these reactive coatings that can be implemented at scale or as elements of commercial or industrial processes.

### Example 9—Continuous Fabrication of Simultaneously Sprayed Coatings

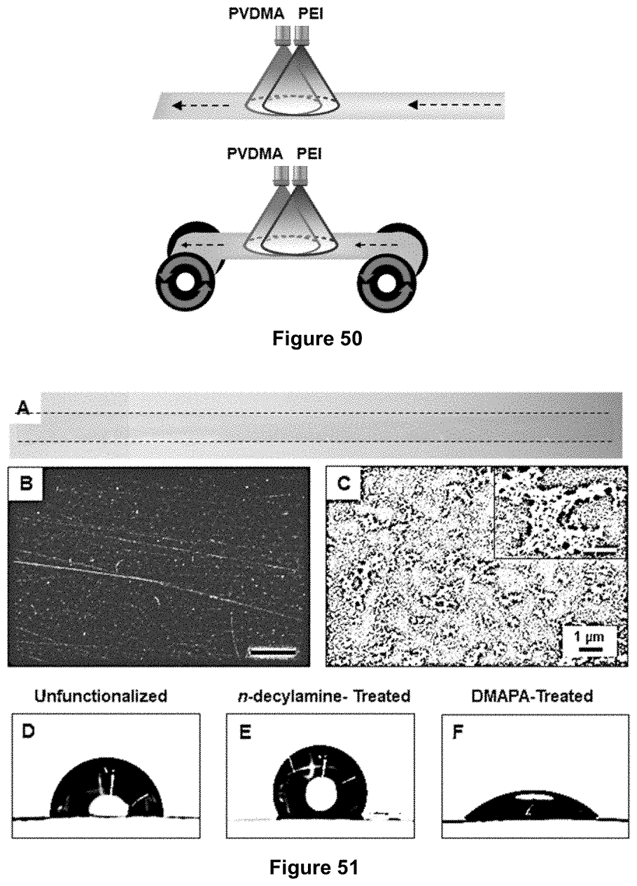

Fabrication of simultaneously sprayed P1/PEI films. As illustrated in FIG. 50, simultaneous spraying of the two polymers may be performed on a continuously moving film or other substrate to provide rapid fabrication of the desired coating. The dotted lines show the horizontal movement of the substrate in respect to the sprays, such as, for example, roll-to-roll simultaneous spraying of PVDMA and PEI on a spooled substrate (FIG. 50, panel B). 30 cm and 150 cm long substrates were coated as demonstrations.

In one experiment, thirty cm long flexible polyester films (Dur-Lar® clear) were cleaned with water, ethanol, and acetone, dried under a stream of filtered and compressed air, and oxygen plasma-treated for 600 s (Plasma Etch, Carson City, Nev.). The coatings were fabricated using an automatic SPALAS™ coatings system (AGILTRON®, Woburn, Mass.) with different nozzles for spraying PEI and P1. In-house compressed air lines supplied pressurized gas with overpressure fixed at 20 psi, and all the nozzles were calibrated to the flow rates of 3 ml/min±0.5 ml/min. The film was placed horizontally on to the spraying platform and the nozzles were aligned perpendicular to the film. The films was pulled horizontally at the rate of 0.64 cm/s. 20 mM solutions of PEI and P1 (in DMF) were sprayed through two different nozzles while the film was continuously pulled through the nozzles, until the entire 30 cm length of the polyester film was coated. After fabrication, films were cleaned with DMF and dried under a stream of filtered, compressed air.

An image of a representative simultaneously sprayed PVDMA/PEI film fabricated on a 30 cm long flexible polyester film (Dur-Lar®) before functionalization treatment is shown in FIG. 51, panel A. FIG. 51, panels B-C, show a fluorescence microscopy image of a representative section of a native (azlactone-containing) simultaneously sprayed PVDMA/PEI film after treatment with tetramethylrhodamine cadaverine, and SEM images of a representative section of simultaneously sprayed PVDMA/PEI film fabricated on a 30 cm long flexible polyester film (Dur-Lar®). Contact angles of 5 μL water droplets were measured on representative pieces of simultaneously sprayed PVDMA/PEI before functionalization with n-decylamine (θ˜86°, FIG. 51, panel D), after functionalization with n-decylamine (θ18 115°, panel E), and after functionalization with DMAPA (θ˜42°, panel F).

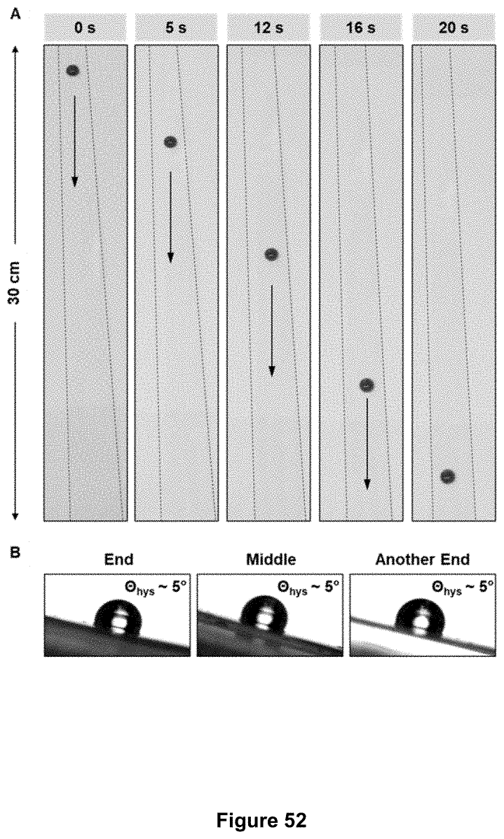

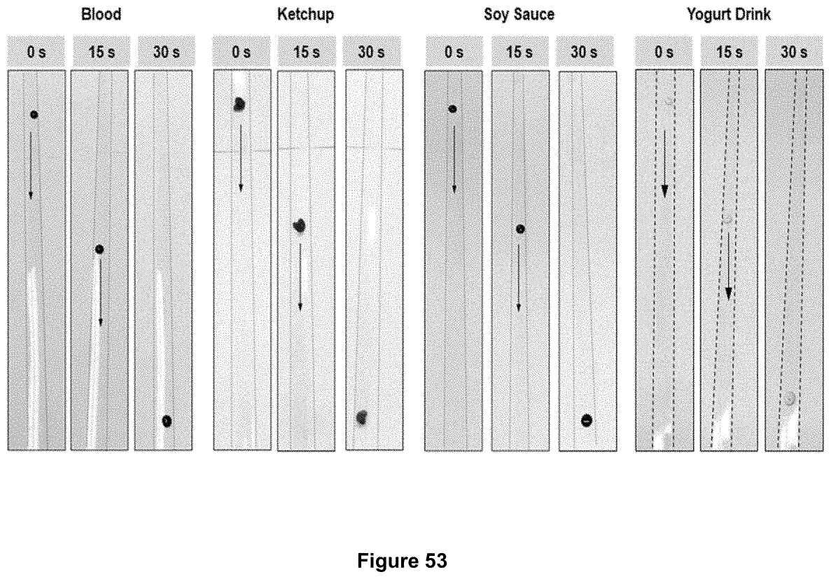

FIG. 52, panel A, shows a droplet of aqueous TMR (100 μL; tilt angle≈10°) sliding on a silicone oil-infused simultaneously sprayed PVDMA/PEI films fabricated on a 30 cm long flexible polyester film (Dur-Lar®). The films were treated with n-decylamine (10 mM in THF, for ˜4 hours) followed by treatment with n-decanoyl chloride (10 mM in heptane, for ˜1 hour) before infusion with silicone oil. 100 μL aqueous droplets do not slide on an uncoated polyester film even at 90° tilt angles. The dotted lines mark the position of the coated film. FIG. 52, panel B, shows contact angle hysteresis (Θ_{hys}) at different points (ends and middle) on the (30 cm long) SLIPS-coated polyester film (droplet size=10 μL; angle of incline≈10°). Droplets of various chemically complex fluids were similarly observed on simultaneously sprayed PVDMA/PEI films treated with n-decylamine followed by treatment with n-decanoyl chloride before infusion with silicone oil (FIG. 53) (droplet volume=100 μL; tilt angle≈10°).

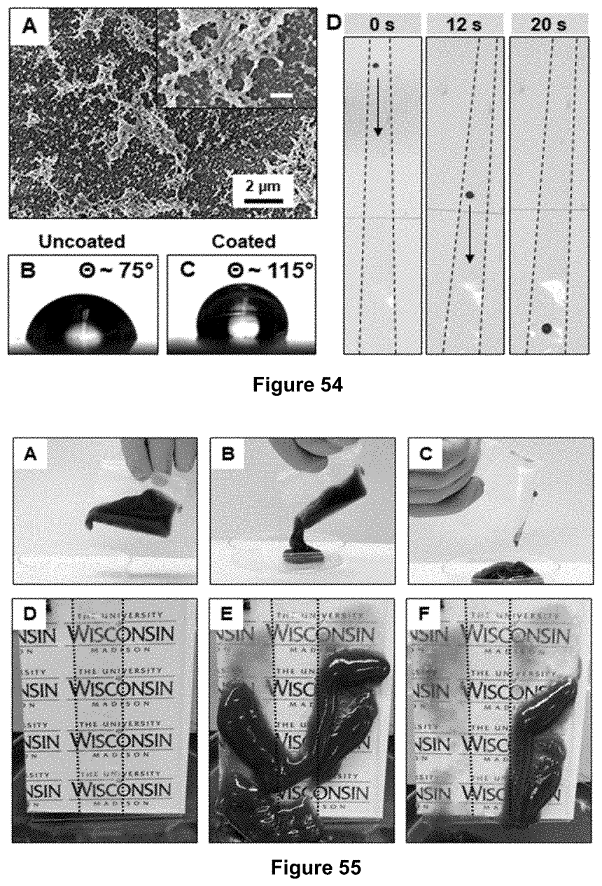

A coated film was also obtained through a roll-to-roll process pulling the film at a rate of ˜0.7 cm/s and simultaneously spraying PEI and PVDMA solutions (each 20 mM in DMF) (FIG. 54, panel A). Contact angles of 5 μL water droplets on uncoated and coated films after functionalization with n-decylamine and decanoyl chloride were ˜75° and 115°, respectively (FIG. 54, panels C, D). The functionalized films infused with silicone oil demonstrated robust slippery behaviors, showing aqueous droplets of TMR (50 μL) sliding on substrates tilted at 10° (FIG. 54, panel D).

Using these methods, a slippery bag was fabricated by simultaneously spraying a PVDMA/PEI film onto a flexible plastic substrate followed by treatment of the film with n-decylamine followed by decanoyl chloride. The film was then sealed into the shape of a bag using a Kuinensi Mini Sealer and the PVDMA/PEI was then infused with silicone oil. Ketchup was then added to the bag and was cleanly poured out without fouling the bag (FIG. 55, panels A-C). A “slippery” sticker was similarly fabricated by simultaneously spraying a PVDMA/PEI film onto a 30 cm long flexible polyester film (Dur-Lar®) followed by treatment with n-decylamine followed by decanoyl chloride. The film then had double sided tape stuck to the back of the polyester to make a sticker. The PVDMA/PEI film was then infused with silicone oil and stuck to a glass slide (the sticker is outlined in the images). Ketchup slides on the sticker but fouls the surrounding glass slide (FIG. 55, panels D-F).

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

One of ordinary skill in the art will appreciate that starting materials, reagents, purification methods, materials, substrates, device elements, analytical methods, assay methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that the use of such terms and expressions exclude any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms.

When a group of materials, compositions, components or compounds is disclosed herein, it is understood that all individual members of those groups and all subgroups thereof are disclosed separately. When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. In the disclosure and the claims, “and/or” means additionally or alternatively. Moreover, any use of a term in the singular also encompasses plural forms.

All references cited herein are hereby incorporated by reference in their entirety to the extent that there is no inconsistency with the disclosure of this specification. Some references provided herein are incorporated by reference to provide details concerning sources of starting materials, additional starting materials, additional reagents, additional methods of synthesis, additional methods of analysis, additional biological materials, and additional uses of the invention. All headings used herein are for convenience only. All patents and publications mentioned in the specification are indicative of the levels of skill of those skilled in the art to which the invention pertains, and are herein incorporated by reference to the same extent as if each individual publication, patent or patent application was specifically and individually indicated to be incorporated by reference. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

1. A method for fabricating a polymer coating on a substrate, said method comprising the steps of:
a) spraying a substrate with a first solution, suspension, or emulsion comprising a first polymer, wherein at least a portion of individual monomer units of the first polymer are substituted with a first functional group, and wherein the first polymer is deposited on at least a portion of the substrate; and
b) spraying the substrate with a second solution, suspension, or emulsion comprising a second polymer, wherein at least a portion of individual monomer units of the second polymer are substituted with a second functional group, wherein the second polymer chemically reacts with the first polymer,
thereby forming a polymer coating on the substrate, wherein a portion of the first and second functional groups are unreacted after the second polymer chemically reacts with the first polymer.

2. The method of claim 1 comprising simultaneously spraying the substrate with the first and second solution, suspension, or emulsion

3. The method of claim 1 comprising continuously spraying the first and second solution, suspension, or emulsion through one or more apertures, while moving the substrate, the one or more apertures, or both, during the spraying process so that a new portion of the substrate is continuously being sprayed.

4. The method of claim 3 wherein the substrate is a flexible material and said method comprises laterally moving the substrate relative to the one or more apertures using one or more spools or rollers.

5. The method of claim 1 comprising reacting the unreacted functional groups of the first and second polymer from step b) to impart additional chemical or structural properties to the polymer coating.

6. The method of claim 1 wherein the formed polymer coating has a nanoscale or microscale porosity.

7. The method of claim 1 wherein a porous layer of the first polymer is deposited on at least a portion of the substrate, and a porous layer of the second polymer is deposited on at least a portion of the first polymer layer, thereby forming a porous coating on the substrate having at least two polymer layers.

8. The method of claim 1 wherein steps a) and b) are repeated two or more times.

9. The method of claim 1 further comprising applying a rinse solvent or solution after step a) is performed and/or after step b) is performed, wherein the rinse solvent or solution is selected from the group consisting of: acetone, methanol, ethanol, ethyl acetate, chloroform, acetonitrile, water, tetrahydrofuran (THF), dimethylformamide (DMF), dichloroethane (DCE), dichloromethane (DCM), dimethyl sulfoxide (DMSO), and combinations thereof.

10. The method of claim 1 wherein the first polymer comprises a functionalized azlactone having the formula: 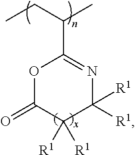
wherein x is 0 or the integers 1 or 2; and each R¹ is independently selected from the group consisting of: hydrogen, alkyl groups, alkenyl groups, alkynyl groups, carbocyclic groups, heterocyclic groups, aryl groups, heteroaryl groups, alkoxy groups, aldehyde groups, ether groups, and ester groups, any of which may be substituted or unsubstituted.

11. The method of claim 1 wherein the first polymer comprises a polymer selected from the group consisting of poly(vinyl-4,4-dimethylazlactone), poly(2-vinyl-4,4-dimethyl-2-oxazolin-5-one), poly(2-isopropenyl-4,4-dimethyl-2-oxazolin-5-one), poly(2-vinyl-4,4-diethyl-2-oxazolin-5-one), poly(2-vinyl-4-ethyl-4-methyl-2-oxazolin-5-one), poly(2-vinyl-4-dodecyl-4-methyl-2-oxazolin-5-one), poly(2-vinyl-4,4-pentamethylene-2-oxazolin-5-one), poly (2-vinyl-4-methyl-4-phenyl-2-oxazolin-5-one), poly(2-isopropenyl-4-benzyl-4-methyl-2-oxazolin-5-one), or poly(2-vinyl-4,4-dimethyl-1,3-oxazin-6-one).

12. The method of claim 1 wherein the first polymer comprises unhydrolyzed, hydrolyzed, or partially hydrolyzed poly(vinyl-4,4-dimethylazlactone) (PVDMA).

13. The method of claim 1 wherein the first polymer is partially functionalized with tri(ethylene glycol) monoethyl ether, 2-(2-(2-ethoxyethoxy)ethoxy) ethanamine, dimethylaminopropylamine (DMAPA), or ethanol amine, or is partially reacted or copolymerized with other monomers.

14. The method of claim 1 wherein the first solution, suspension, or emulsion comprises acetone, ethyl acetate, chloroform, acetonitrile, tetrahydrofuran (THF), dimethylformamide (DMF), dichloroethane (DCE), dichloromethane (DCM), dimethyl sulfoxide (DMSO), water, or combinations thereof.

15. The method of claim 1 wherein the second polymer comprises a primary amine functionalized polymer, an alcohol functionalized polymer, or a thiol functionalized polymer.

16. The method of claim 1 wherein the second polymer comprises an optionally functionalized polymer selected from the group consisting of polyolefins, poly(alkyls), poly(alkenyls), poly(ethers), poly(esters), poly(imides), polyamides, poly(aryls), poly(heterocycles), poly(ethylene imines), poly(urethanes), poly(α,β-unsaturated carboxylic acids), poly(α,β-unsaturated carboxy lie acid derivatives), poly(vinyl esters of carboxylic acids), poly(vinyl halides), poly(vinyl alkyl ethers), poly(N-vinyl compounds), poly(vinyl ketones), poly(vinyl aldehydes) and any combination thereof.

17. The method of claim 1 wherein the first polymer is PVDMA, functionalized PVDMA, or a PVDMA derivative, and the second polymer is PEI.

18. The method of claim 1 wherein the second solution, suspension, or emulsion comprises acetone, methanol, ethanol, chloroform, water, dimethylformamide (DMF), dichloroethane (DCE), dichloromethane (DCM), dimethyl sulfoxide (DMSO), water or combinations thereof.

19. The method of claim 1 wherein at least a portion of the unreacted functional groups in the first or second polymer is reacted with an amine, hydroxyl group, thiol group, or hydrazine group having the formula R—NH₂, R—OH, R—SH or R—NHNH₂, where R is a substituted or unsubstituted C₁ to C₂₀ alkyl group or a substituted or unsubstituted C₂ to C₂₀ alkenyl group.

20. The method of claim 1 wherein at least a portion of the unreacted functional groups in the first polymer, second polymer, or both is reacted with an electrophilic species, including isothiocyanates, isocyanates, acyl azides, N-hydroxysuccinimide (NHS) esters, sulfonyl chlorides, aldehydes, glyoxals, epoxides, oxiranes, carbonates, aryl halides, imidoesters, carbodiimides, anhydrides, fluorophenyl esters, or combinations thereof.

21. The method of claim 1 wherein at least a portion of unreacted functional groups in the first or second polymer is reacted with an amine selected from the group consisting of decylamine, dodecylamine, propylamine, an amino sugar, amino alcohol, amino polyol, glucamine, dimethylaminopropylamine (DMAPA), and combinations thereof.

22. The method of claim 1 further comprising the step of exposing the polymer coating to an oil, wherein said oil coats at least a portion of the polymer coating and/or at least partially fills the pores of at least a portion of the polymer coating.

23. The method of claim 22 wherein the oil is selected from the group consisting of a silicone oil, a vegetable oil, a mineral oil, a thermotropic liquid crystal, and combinations thereof.

24. The method of claim 22 wherein the polymer coating comprises one or more PVDMA/PEI polymer layers, which are further functionalized with n-decylamine and wherein the polymer coating is infused with a silicone oil or an anisotropic thermotropic liquid crystal.

25. The method of claim 22 wherein the substrate is a container for containing liquids or gels, wherein the first polymer, second polymer, and oil are selected so that said liquid or gel has reduced adhesion to the container.

26. The methods of claim 1 further comprising adding a multifunctional small molecule and/or functionalized nanoparticle, wherein the multifunctional small molecule or functionalized nanoparticle are able to form crosslinks with the first polymer, second polymer, or both.

27. The method of claim 26 wherein the multifunctional small molecule or functionalized nanoparticle comprises ethylene diamine, butylene diamine, hexamethylene diamine, cystamine, 2,2″-(ethylenedioxy)bis(ethylamine), or combinations thereof.
